(19) United States
(12) Patent Application Publication
(10) Pub. No.: US 2010/0247180 A1
(43) Pub. Date: Sep. 30, 2010

(54) HEAT GENERATION UNIT AND HEATING APPARATUS

(75) Inventors: Masanori Konishi, Kagawa (JP); Hiroaki Matsuoka, Kagawa (JP); Akira Nishio, Kagawa (JP)

Correspondence Address: HAMRE, SCHUMANN, MUELLER & LARSON P.C., P.O. BOX 2902, MINNEAPOLIS, MN, 55402-0902, US

(73) Assignee: Panasonic Corporation, Kadoma-shi, Osaka (JP)

(21) Appl. No.: 12/742,630

(22) PCT Filed: Nov. 14, 2008
(86) PCT No.: PCT/JP2008/003322

§ 371 Date: May 12, 2010

(30) Foreign Application Priority Data
Nov. 16, 2007 (JP) 2007-297581
May 9, 2008 (JP) 2008-123390
May 9, 2008 (JP) 2008-123408
May 9, 2008 (JP) 2008-123410

(51) Int. Cl. G03G 15/20; H05B 1/00

(52) U.S. Cl. 399/328; 219/385

(57) ABSTRACT

In the present invention, a stable heat generation unit which can stably absorb stress and diffuse heat even in thermal stress is constructed by providing a locking through hole 2p in an end portion of a heat generator 2 in a heat generation unit, and engaging a fixed portion 5 with through holes respectively formed in a first holding portion 3a and a second holding portion 3a constructing a holder 3 holding the end portion of the heat generator 2 so as to hold the end portion of the heat generator 2, and a heating apparatus is constructed by the heat generation unit.

### TECHNICAL FIELD

The present invention relates to a heat generation unit used as a heat source and a heating apparatus using the heat generation unit, and more particularly to a heat generation unit having a heat generator formed in a sheet shape by employing a carbon-based substance as a component, and a heating apparatus using the heat generation unit. The heating apparatus according to the present invention includes various apparatuses requiring a heat source, for example, an electronic apparatus such as a copier, a facsimile, a printer and the like, and an electric apparatus such as an electric heating apparatus, a cooking appliance, a drying machine and the like.

### BACKGROUND ART

The heat generation unit has been widely used as the heat source in the various apparatuses as mentioned above. Accordingly, various demands are generated in the heat generation unit, in such a manner as to correspond to a specification such as a function, a shape, a structure and the like of the apparatus in which the heat generation unit is used. For example, there are such demands that a high temperature is obtained as a heat source, a designated temperature can be maintained, a temperature regulating range is wide, input power can be converted into a heating energy at high efficiency, an object to be heated can be uniformly heated, a directivity is provided so as to heat only a designated direction, a rush current at the time of turning on power is small, a rising time to a set temperature is short, and the heat generation unit is structured such that it can be downsized and can be easily attached and detached.

In order to satisfy the demands as mentioned above, various heat generation units have been proposed.

In a conventional heat generation unit serving as a long shaped heat source, there has been a structure in which an elongated coil-shaped tungsten wire, or a rod-shaped or plate-shaped carbon-based sintered body is sealed as a heat generator in an inner portion of a cylindrical glass tube. Recently, in place of the heat generators mentioned above, there has been proposed a structure using a heat generator in which a carbon fiber is formed in a sheet shape by a resin, as a heat generation unit having a high general-purpose property which can heat an object to be heated more uniformly and to a further higher temperature.

In the heat generation unit, a member (a power supply member) for supplying a power source is attached to both end portions of the heat generator stored in the inner portion of the glass tube, and it is necessary that the power supply member is securely installed to the heat generator and is structured so as to supply the power efficiently. Further, since the heat generator and the power supply member in the heat generation unit are structured so as to be arranged at the predetermined positions in the inner portion of the glass tube which is narrow and easy to break so as to be sealed, it is necessary to have a structure having an excellent workability which can easily and securely incorporate the heat generator and the power supply member in the inner portion of the glass tube, in the structure of the heat generation unit. Further, it is essential that the heat generation unit used as the heat source is a highly reliable apparatus which is high in safety and can stand usage of a long period of time.

### Patent Document 1: Japanese Unexamined Patent Publication No. 2004-193130

### Patent Document 2: Japanese Unexamined Patent Publication No. 2006-040898

### Patent Document 3: Japanese Unexamined Patent Publication No. 2007-103292

### Patent Document 4: Japanese Unexamined Patent Publication No. 2005-116412

### Patent Document 5: Japanese Unexamined Patent Publication No. 2005-149809

### DISCLOSURE OF THE INVENTION

### Problems to be Solved by the Invention

In the conventional heat generation unit using the heat generator formed by weaving the carbon fiber in the sheet shape, there has been a structure in which both end portions of the heat generator are coated by a noble metal, the coated portion is covered by a metal sleeve, and the metal sleeve and the coated portion are brazed by a brazing metal (refer to Japanese Unexamined Patent Publication No. 2004-193130). A method of depositing the heat generator and the metal sleeve by the brazing metal as mentioned above has such a great problem in view of safety that, in the heat generation unit in which the heat generator comes to a high temperature (for example, 1100° C.), the brazed portion melts by heat conduction from the heat generator and in some cases the heat generator falls out.

Further, in the conventional heat generation unit, there has been a structure in which the power supply member is crimped to both end portions of the elongated sheet-shaped heat generator (refer to Japanese Unexamined Patent Publication No. 2006-040898). In the conventional heat generation unit structured as mentioned above, a structure obtained by attaching a plurality of carbon fibers like a sheet by a resin so as to be sintered is used as the heat generator. In the sheet-shaped heat generator in the conventional heat generation unit formed as mentioned above, since a surface thereof is smooth, there is a risk that the heat generator falls out from the power supply member in the case where the power supply member does not have a strong pinching force, and there is such a problem that it lacks safety and reliability.

The inventors of the present invention has worked on developing a heat generation unit serving as a new heat source, by applying a new film sheet-shaped material which is completely different in view of a material and a manufacturing method from the heat generator formed in the sheet shape by weaving the carbon fiber, and the heat generator obtained by attaching the resin to the carbon fiber so as to sinter, which have been conventionally used, as a heat generating material to the heat generator. Since the new film sheet-shaped material which is intended to be applied to the heat generator used in the heat generation unit mentioned above has a further smoother surface than the surface of the conventional heat generator, and has flexibility, the power supply member (for example, refer to Japanese Unexamined Patent Publication No. 2007-103292) used in the conventional heat generation unit cannot securely hold the new heat generator. If the structure of the conventional heat generation unit is applied as it is to the new heat generation unit, there has been a problem in terms of safety and reliability.

An object of the present invention is to provide a heat generation unit which can securely hold a heat generator, can achieve stable stress absorption and thermal diffusion even in a thermal stress, can heat an object to be heated in accordance with a desired arranged heat distribution, and can heat efficiently to a high temperature, and a heating apparatus using the heat generation unit. As a result, according to the present invention, it is possible to provide the heat generation unit and the heating apparatus which are high in safety and reliability, and can be easily manufactured.

In the present invention, the heating apparatus using the heat generation unit as the heat source includes an image fixing apparatus, and an image forming apparatus provided with the image fixing apparatus. The image forming apparatus includes apparatuses that require a heat source, such as a facsimile, a printer, a complex machine provided with these functions and the like.

In an image forming process in the image forming apparatus, there is employed such an image fixing apparatus as to heat a member to be recorded carrying an unfixed toner image thereon, for example, paper at a high temperature as well as pressurizing so as to fix the image.

A heat generation unit is used as the heat source in the image fixing apparatus. The conventional heat generation unit used in the image fixing apparatus includes a halogen heater using a heat generator formed by a tungsten material, and a carbon heater using an elongated plate-shaped heat generator formed by a mixed material of a crystallized carbon such as a black lead or the like, a resistance value regulating material and an amorphous carbon (refer to Japanese Unexamined Patent Publication No. 2005-116412, and Japanese Unexamined Patent Publication No. 2005-149809).

The present invention provides an image fixing apparatus and an image forming apparatus having a heat source which can efficiently heat an object to be heated at a high temperature in accordance with a desired arranged heat distribution in a fixing process, which can rise quickly, and can lower energy consumption.

### Means for Solving the Problems

In order to solve the above-mentioned problems and to achieve the object of the present invention, a heat generation unit according to a first aspect of the present invention includes:

a heat generator having a heat generating portion;

a holder attached to an end portion of the heat generator;

a lead wire electrically connected to the holder so as to supply power from outside to the heat generator; and

the heat generator, the holder and the lead wire being arranged within a container,

wherein the holder has a first holding portion and a second holding portion which are arranged so as to be opposed to each other, through holes are respectively formed in the first holding portion and the second holding portion, and center axes of the through holes are arranged coaxially,

wherein an end portion of the heat generator has a locking through hole, and is arranged between the first holding portion and the second holding portion, whereby the locking through hole is arranged on the same axis as the center axes,

wherein a fixed portion having an engagement portion engaging with each of the through holes of the first holding portion and the second holding portion and the locking through hole in the end portion of the heat generator is provided, and

wherein the fixed portion has a first position regulating member for regulating a position of the first holding portion in one end side of the engagement portion arranged in an outer side surface of the first holding portion in which the end portion of the heat generator is not arranged, and a second position regulating member for regulating a position of the second holding portion in the other end side of the engagement portion arranged in an outer side surface of the second holding portion in which the end portion of the heat generator is not arranged, and is structured such that the end portion of the heat generator is held by the first holding portion and the second holding portion. In the heat generation unit according to the first aspect of the present invention structured as mentioned above, since the end portion of the heat generator inserted between the first holding portion and the second holding portion is held by the first holding portion and the second holding portion in accordance with the position regulation between the first position regulating member and the second position regulating member of the fixing portion, or is locked by the engagement portion engaging with the through holes of the first holding portion and the second holding portion and the locking through hole in the end portion of the heat generator, a more stable holding strength can be obtained even in the sheet-shaped heat generator having the carbon-based substance as the main component in which the surface of the heat generator tends to slip.

A heat generation unit according to a second aspect of the present invention is the heat generation unit according to the first aspect, wherein the fixed portion connected to the lead wire bonded to the first holding portion is formed in such a manner as to engage with each of the through holes of the first holding portion and the second holding portion and the locking through hole in the end portion of the heat generator, and the second position regulating member is formed by plastically deforming a protruding end portion of the engagement portion protruding to an outer side from the through hole of the second holding portion while passing through the through hole of the first holding portion, whereby the end portion of the heat generator is held by the first holding portion and the second holding portion. In the heat generation unit according to the second aspect of the present invention structured as mentioned above, in the sheet-shaped heat generator having the carbon-based substance as the main component in which the surface tends to slip, since the end portion of the heat generator inserted between the first holding portion and the second holding portion is held in accordance with the position regulation between the second position regulating member formed by plastically deforming the protruding end portion of the engagement portion provided in the fixing portion and the first position regulating member provided in the fixed portion, a more stable holding strength can be obtained.

A heat generation unit according to a third aspect of the present invention is the heat generation unit according to the first aspect, wherein the end portion of the heat generator is held by the first holding portion and the second holding portion by reducing a distance between the first position regulating member and the second position regulating member, whereby the heat generator comes to a crimped state. In the heat generation unit according to the third aspect of the present invention structured as mentioned above, since the end portion of the heat generator inserted between the first holding portion and the second holding portion is held in the state where it is closely attached to the first holding portion and the second holding portion in accordance with the crimping by the fixed portion, a stable holding strength can be obtained, in the end portion of the sheet-shaped heat generator having the carbon-based substance as the main component.

A heat generation unit according to a fourth aspect of the present invention is the heat generation unit according to the first aspect, wherein the through hole of the second holding portion is formed so as to be larger than an outer diameter of the fixed portion and smaller than the through hole of the first holding portion and the locking through hole, in the respective through holes of the first holding portion and the second holding portion and the locking through hole of the heat generator. In the heat generation unit according to the fourth aspect of the present invention structured as mentioned above, since the end portion of the heat generator inserted between the first holding portion and the second holding portion can achieve an improvement of an easiness of inserting work at the time of inserting the fixed portion and a firm attachment at the time of crimping, it is possible to obtain a uniform fixing strength and a stable holding characteristic can be obtained, in the end portion of the sheet-shaped heat generator having the carbon-based substance as the main component.

A heat generation unit according to a fifth aspect of the present invention is the heat generation unit according to the first aspect, wherein a heat generator insertion port side edge portion of the first holding portion and the second holding portion holding the end portion of the heat generator is provided with a curved surface or an inclined surface which is open toward an outer side, or a no-burr portion from which the burr during working is deleted, as a fracture preventing portion preventing a fracture of the heat generator. In the heat generation unit according to the fifth aspect of the present invention structured as mentioned above, since the fracture preventing portion is formed in the first holding portion and the second holding portion, the fracture in the inserting portion of the heat generator is prevented, and it is possible to obtain a stable joint which can stand a thermal stress when used for a long period of time.

A heat generation unit according to a sixth aspect of the present invention is the heat generation unit according to the first aspect, wherein the heat generator is constructed by a material having pliability, flexibility and resiliency. In the heat generation unit according to the sixth aspect of the present invention structured as mentioned above, since the elasticity is provided, it is possible to enhance the holding force to the end portion of the heat generator by the first holding portion and the second holding portion, and it becomes easy to attach the heat generator. Further, it is possible to change the shape of the heat generator by the pliability and the flexibility and a degree of freedom for designing the apparatus is improved.

A heat generation unit according to a seventh aspect of the present invention is the heat generation unit according to the first aspect, wherein a conductive member having elasticity is arranged at least one of between the heat generator and the first holding portion, and between the heat generator and the second holding portion, in such a manner as to bring the heat generator into pressure contact. In the heat generation unit according to the seventh aspect of the present invention structured as mentioned above, it is possible to absorb a thermal expansion in a thickness direction in accordance with a heat cycle of the heat generator or the first holding portion and the second holding portion by the conductive member having the elasticity, and it is possible to prevent the heat generator from being damaged. Further, in the heat generation unit, even if a concavo-convex shape exists at least in one surface between the heat generator and the first holding portion interposing the conductive member therebetween, and between the heat generator and the second holding portion, it is possible to stably come into contact in accordance with an elastic deformation of the conductive member, and it is possible to reduce an electric contact resistance. Accordingly, the heat generation unit becomes a stable heat source which can stand the thermal stress generated by being used for a long time.

A heat generation unit according to an eighth aspect of the present invention is the heat generation unit according to the first aspect, wherein a member having elasticity is arranged between the first position regulating member and the second position regulating member. In the heat generation unit according to the eighth aspect of the present invention structured as mentioned above, it is possible to absorb a thermal expansion in a thickness direction in accordance with a heat cycle of the heat generator or the first holding portion and the second holding portion by the elastic deformation of the member having the elasticity, and it is possible to prevent the heat generator from being damaged. Further, in the heat generation unit, even if a concavo-convex shape exists in the surface of each of the members opposed to the member having the elasticity, it is possible to stably come into contact in accordance with an elastic deformation of the member having the elasticity, and it is possible to reduce an electric contact resistance. Accordingly, the heat generation unit becomes a stable heat source which can stand the thermal stress generated by being used for a long period of time.

A heat generation unit according to a ninth aspect of the present invention is the heat generation unit according to the first aspect, wherein the lead wire is provided with a position regulating portion regulating a distance between an inner wall of the container and the heat generator. In the heat generation unit according to the ninth aspect of the present invention structured as mentioned above, it is possible to regulate the position in the cross sectional direction which is vertical to the longitudinal direction in the long container by the position regulating portion. Accordingly, in the heat generation unit, it is possible to stabilize an inclination of the heat generator with respect to the longitudinal direction of the container, and it is possible to carry out a heat generation (a radiation) in a desired direction. Further, in the heat generation unit, since the inner wall surface of the container and the heat generator do not come into contact with each other, damage is not generated by the heat in the container.

A heat generation unit according to a tenth aspect of the present invention is the heat generation unit according to the first aspect, wherein the lead wire is provided with a spring portion for absorbing expansion and contraction of the heat generator. In the heat generation unit according to the tenth aspect of the present invention structured as mentioned above, it is possible to absorb, by expansion and contraction of the spring portion, a thermal expansion in the longitudinal direction in the heat generator at the time of a heat cycle generated by repeatedly being energized and de-energized. Accordingly, in the heat generation unit, the heat generator becomes a stable heat source which is hard to be broken and has a long service life.

A heat generation unit according to an 11th aspect of the present invention is the heat generation unit according to the first aspect, wherein an inert gas is filled within the container. In the heat generation unit according to the 11th aspect of the present invention structured as mentioned above, an oxidation of the heat generator is prevented, and a long service life of the heat generator is achieved.

A heat generation unit according to a 12th aspect of the present invention is the heat generation unit according to the first aspect, wherein the heat generator is formed in a film sheet shape in which a thickness is equal to or less than 300 μm. In the heat generation unit according to the 12th aspect of the present invention structured as mentioned above, it becomes easy to design a width, a thickness and a shape of the heat generator in correspondence to an intended purpose, and it is possible to construct a heat source having a high directivity by the heat generation from the sheet surface of the heat generator, that is, a band surface.

A heating apparatus according to a 13th aspect of the present invention includes the heat generation unit according to the first aspect, wherein a reflective portion is provided at a position opposed to a heat dissipation surface of the heat generator in the heat generation unit. In the heating apparatus according to the 13th aspect of the present invention structured as mentioned above, the heat is reflected by the reflective plate from the heat generator radiated, toward the reflective plate, is radiated in front of the heating apparatus, and is conducted to the object to be heated such as a person warming oneself or the like existing in front of the heating apparatus. Accordingly, the heating apparatus becomes an apparatus which can provide a heat source having high efficiency for the object to be heated.

A heating apparatus according to a 14th aspect of the present invention includes the heat generation unit according to the first aspect, wherein a tube body is arranged in such a manner as to surround a periphery of the heat generation unit. The heating apparatus according to the 14th aspect of the present invention structured as mentioned above can be applied to an electronic apparatus such as a copying machine or the like having a toner fixing mechanism, a cooking appliance and the like.

A heating apparatus according to a 15th aspect of the present invention is the heating apparatus according to the 13th aspect, wherein the heating apparatus has a control circuit carrying out power supply control of the heat generation unit, and the control circuit is constructed independently by each of circuits for on-off control, power supply ratio control, phase control and zero-cross control or combining at least two of the circuits. The heating apparatus according to the 15th aspect of the present invention structured as mentioned above can construct a heat source having a desired temperature distribution with high precision.

A heating apparatus according to a 16th aspect of the present invention is the heating apparatus according to the 14th aspect, wherein the heating apparatus has a control circuit carrying out power supply control of the heat generation unit, and the control circuit is constructed independently by each of circuits for on-off control, power supply ratio control, phase control and zero-cross control or combining at least two of the circuits. The heating apparatus according to the 16th aspect of the present invention structured as mentioned above can construct a heat source having a desired temperature distribution with high precision.

A heat generation unit according to a 17th aspect of the present invention includes:

a band-like heat generator formed as a film sheet by a material including a carbon-based substance, and having a two-dimensional isotropic thermal conductivity;

a power supply portion having a holder including a first holding portion and a second holding portion arranged so as to be opposed while having a contact surface holding both ends of the heat generator and formed by a conductive material, and a lead wire electrically connected to the holder, and supplying power to the both opposed ends in the heat generator; and

a container internally including the heat generator and a part of the power supply portion,

wherein a retainer receiving portion formed in the both ends of the heat generator is engaged with a retainer portion formed in the power supply portion. The heat generation unit according to the 17th aspect of the present invention structured as mentioned above becomes a heat source which can efficiently heat the object to be heated in accordance with a desired arranged heat distribution and at a high temperature, is high in safety and reliability and has high efficiency, and can be easily manufactured.

A heat generation unit according to an 18th aspect of the present invention is the heat generation unit according to the 17th aspect, wherein the retainer receiving portion of the heat generator is constructed by a through hole, through holes are formed at positions corresponding to the retainer receiving portion in the first holding portion and the second holding portion holding the both ends of the heat generator; and the retainer portion formed in the heat generator side end portion in the lead wire engages by passing through the retainer receiving portion of the heat generator, and the respective through holes of the first holding portion and the second holding portion. The heat generation unit according to the 18th aspect of the present invention structured as mentioned above becomes a heat source in which a lead wire can securely hold the heat generator and which is high in safety and reliability.

A heat generation unit according to a 19th aspect of the present invention is the heat generation unit according to the 17th aspect, wherein the retainer receiving portion of the heat generator is constructed by a through hole, a through hole is formed at a position corresponding to the retainer receiving portion in one of the first holding portion and the second holding portion holding the both ends of the heat generator, a projection is formed at a position corresponding to the retainer receiving portion in the other of the holder, and the projection in the holder engages by passing through the through hole of the holder together with the retainer receiving portion of the heat generator. The heat generation unit according to the 19th aspect of the present invention structured as mentioned above becomes a structure in which the holder can securely hold the heat generator, and which is high in safety and reliability and can be easily manufactured.

A heat generation unit according to a 20th aspect of the present invention is the heat generation unit according to the 18th aspect, wherein the retainer portion of the lead wire is formed by bending the heat generator side end portion, and one through hole in the holder in which the bent portion of the retainer portion of the lead wire is arranged is formed larger than the other hole in which the leading end portion of the retainer portion is arranged, in the through hole formed in the first holding portion and the through hole formed in the second holding portion. The heat generation unit according to the 20th aspect of the present invention structured as mentioned above becomes a structure which can securely install a lead wire to the holder, is easily manufactured and is high in reliability and safety.

A heat generation unit according to a 21st aspect of the present invention is the heat generation unit according to the 18th aspect, wherein a holding hole is formed at a position different from the through hole engaging with the retainer portion of the power supply portion, in one of the first holding portion and the second holding portion, the lead wire passes through the holding hole, and the lead wire holds the holder. The heat generation unit according to the 21st aspect of the present invention structured as mentioned above becomes a structure which can securely and easily install the lead wire to the holder, is easily manufactured and is high in reliability and safety.

A heat generation unit according to a 22nd aspect of the present invention is the heat generation unit according to the 18th aspect, wherein the retainer portion of the lead wire is formed by bending the heat generator side end portion, and dropout preventing means is provided in the leading end portion of the retainer portion, in a state where the retainer portion is inserted to the through hole of the holder. The heat generation unit according to the 22nd aspect of the present invention structured as mentioned above becomes a structure which is high in reliability and safety since the dropout preventing means is provided in the lead wire.

A heat generation unit according to a 23rd aspect of the present invention is the heat generation unit according to the 17th aspect, wherein the retainer receiving portion formed in the both ends of the heat generator is formed by a notch in an end edge of at least one of both end edges in a width direction of the heat generator, and the retainer portion of the power supply portion is formed by a side wall portion provided so as to extend in a longitudinal direction of the heat generator while being orthogonal to a surface coming into contact with the heat generator at a position corresponding to the retainer receiving portion in the holding portion. The heat generation unit according to the 23rd aspect of the present invention structured as mentioned above becomes a structure in which the heat generator can be securely and easily installed to the power supply portion, and which is easily manufactured and is high in reliability and safety.

A heat generation unit according to a 24th aspect of the present invention is the heat generation unit according to the 23rd aspect, wherein the side wall portion serving as the retainer portion of the holder is formed in one of the first holding portion and the second holding portion, and the protruding end portion of the side wall portion is attached so as to go around the other holding portion. The heat generation unit according to the 24th aspect of the present invention structured as mentioned above becomes a structure in which the heat generator can be easily and securely installed to the holder, and which is easily manufactured and is high in reliability and safety.

A heat generation unit according to a 25th aspect of the present invention is the heat generation unit according to the 17th aspect, wherein the first holding portion and the second holding portion are constructed by bending one material so as to pinch the end portion of the heat generator. The heat generation unit according to the 25th aspect of the present invention structured as mentioned above becomes a structure which can easily manufacture the holder installing the heat generator thereto, is high in reliability and safety and a manufacturing cost thereof is suppressed.

A heat generation unit according to a 26th aspect of the present invention is the heat generation unit according to the 17th aspect, wherein the heat generator has an interlayer structure formed by a material including a carbon-based substance. The heat generation unit according to the 26th aspect of the present invention structured as mentioned above becomes a heat source which can heat the object to be heated uniformly and to a high temperature, and has high efficiency.

A heat generation unit according to a 27th aspect of the present invention is the heat generation unit according to the 17th aspect, wherein the container is formed by a glass tube or a ceramics tube having a heat resistance, and is filled with an inert gas so as to be sealed in the power supply portion. The heat generation unit according to the 27th aspect of the present invention structured as mentioned above becomes a heat source which can heat to a high temperature and has high efficiency.

A heat generation unit according to a 28th aspect of the present invention includes:

a band-like heat generator formed as a film sheet by a material including a carbon-based substance, and having a two-dimensional isotropic thermal conductivity;

a power supply portion supplying power to the both opposed ends in the heat generator; and

a container internally including the heat generator and a part of the power supply portion,

wherein a position regulating portion is firmly attached to the power supply portion in an inner portion of the container and holds the heat generator at a predetermined position in the inner portion of the container, and a current path in the power supply portion is prevented from being formed in the position regulating portion. The heat generation unit according to the 28th aspect of the present invention structured as mentioned above becomes a heat source which can heat the object to be heated to a high temperature in accordance with a desired arranged heat distribution, is high in safety and reliability, and has high efficiency, and has a structure which can be easily manufactured.

A heat generation unit according to a 29th aspect of the present invention is the heat generation unit according to the 28th aspect, wherein the power supply portion has a holder holding the both ends of the heat generator, and a lead wire electrically connected to the holder,

wherein the position regulating portion is a coil-shaped support ring firmly attached to the lead wire, and

wherein at least a part of an outer peripheral portion of the position regulating portion is arranged so as to come close to an inner peripheral surface of the container. The heat generation unit according to the 29th aspect of the present invention structured as mentioned above becomes a heat source in which the position regulating portion can securely arrange the heat generator at the predetermined position within the container and which is high in safety and reliability.

A heat generation unit according to a 30th aspect of the present invention is the heat generation unit according to the 29th aspect, wherein at least a part of the portion to which the position regulating portion in the lead wire is deformed as compared to the other portions. The heat generation unit according to the 30th aspect of the present invention structured as mentioned above becomes a structure in which the position regulating portion can be easily and securely provided at the predetermined position, and can be easily manufactured.

A heat generation unit according to a 31st aspect of the present invention is the heat generation unit according to the 30th aspect, wherein the position regulating portion is constructed by a metal wire rod, and the position regulating portion is firmly attached by winding a part of the position regulating portion with respect to the lead wire. The heat generation unit according to the 31st aspect of the present invention structured as mentioned above becomes a structure in which the position regulating portion can be easily and securely provided at the predetermined position, and which can be easily manufactured.

A heat generation unit according to a 32nd aspect of the present invention is the heat generation unit according to the 30th aspect, wherein the lead wire is constructed by a wire rod, the position regulating portion is firmly attached to the deformed portion of the lead wire, and the deformed portion of the lead wire is structured such that a cross sectional area which is orthogonal to a current path flowing through the portion becomes equal to or more than 80% in comparison with a cross sectional area which is orthogonal to the current path in the other portion. The heat generation unit according to the 32nd aspect of the present invention structured as mentioned above becomes a heat source which can prevent the position to which the position regulating portion in the lead wire is firmly attached from being generated, and is high in safety and reliability.

A heat generation unit according to a 33rd aspect of the present invention is the heat generation unit according to the 30th aspect, wherein the lead wire is constructed by a wire rod, and a portion of the lead wire to which the position regulating portion is firmly attached is bent. The heat generation unit according to the 33rd aspect of the present invention structured as mentioned above becomes a structure in which the position regulating portion can be easily and securely provided at the predetermined position, and can be easily manufactured.

A heat generation unit according to a 34th aspect of the present invention is the heat generation unit according to the 30th aspect, wherein the retainer receiving portion formed in the both ends of the heat generator engages with the retainer portion formed in the lead wire, whereby the heat generator is provided in a tension manner in the inner portion of the container. The heat generation unit according to the 34th aspect of the present invention structured as mentioned above becomes a heat source which can easily and securely hold the heat generator heating the object to be heated uniformly and to a high temperature at the predetermined position within the container, and is high in safety and reliability.

A heat generation unit according to a 35th aspect of the present invention is the heat generation unit according to the 34th aspect, wherein the retainer receiving portion of the heat generator is constructed by the through hole, a through hole is formed at a position corresponding to the retainer receiving portion in the holder holding the both ends of the heat generator, and the retainer portion engages by passing through the retainer receiving portion and the through hole of the holder. The heat generation unit according to the 35th aspect of the present invention structured as mentioned above becomes a heat source in which the heat generator can be easily and securely held at the predetermined position within the container, and which does not fall out, and is high in safety and reliability.

A heat generation unit according to a 36th aspect of the present invention is the heat generation unit according to the 35th aspect, wherein the protruding end portion passing through the through hole of the holder is plastically deformed larger than a diameter of the through hole, in the retainer portion. The heat generation unit according to the 36th aspect of the present invention structured as mentioned above becomes a heat source in which the heat generator can be easily and securely held at the predetermined position within the container, and which does not fall out and is high in safety and reliability.

A heat generation unit according to a 37th aspect of the present invention is the heat generation unit according to the 28th aspect, wherein the heat generator has an interlayer structure formed by a material including a carbon-based substance. The heat generation unit according to the 37th aspect of the present invention structured as mentioned above becomes a heat source which can heat the object to be heated uniformly and to a high temperature, and has high efficiency.

A heat generation unit according to a 38th aspect of the present invention is the heat generation unit according to the 28th aspect, wherein the container is constructed by any one of a glass tube and a ceramics tube having a heat resistance, and is sealed in the power supply portion, and an inert gas is filled in an inner portion of the container. The heat generation unit according to the 38th aspect of the present invention structured as mentioned above becomes a heat source which can heat the object to be heated to a high temperature and has high efficiency.

A heating apparatus according to the 39th aspect of the present invention is equipped with the heat generation unit according to the first aspect to the 12th aspect, and the 17th aspect to the 38th aspect as the heat source, and becomes a heat source which can heat the object to be heated uniformly and to a high temperature, is high in safety and reliability and has high efficiency.

An image fixing apparatus according to a 40th aspect of the present invention includes:

a heating body heating a member to be recorded in which an unfixed toner image is carried; and

a pressurizing body arranged so as to be opposed to the heating body and pressurizing the heating body via the member to be recorded,

wherein the heating body is equipped with the heat generation unit according to any one of the first aspect to the 13th aspect and the 17th aspect to the 38th aspect having a heat generator as a heat source. The image fixing apparatus according to the 40th aspect of the present invention structured as mentioned above has a quick rising property and can reduce energy consumption.

An image fixing apparatus according to a 41st aspect of the present invention is the image fixing apparatus according to the 40th aspect, wherein the heat generator has an interlayer structure formed by a material including a carbon-based substance. The image fixing apparatus according to the second aspect of the present invention structured as mentioned above has a quick rising property, can heat the member to be recorded in accordance with a desired arranged heat distribution and with high efficiency, and can fix the image with a high reliability.

An image fixing apparatus according to a 42nd aspect of the present invention is the image fixing apparatus according to the 41st aspect, wherein the heat generator has such a positive characteristic that a value of a rate of resistance change obtained by dividing a value of a resistance at a balanced lighting state brought by energization by a value of a resistance at a non-energized state is in a range between 1.2 and 3.5, and a temperature of the heat generator and the resistance value are proportional. The image fixing apparatus according to the 42nd aspect of the present invention structured as mentioned above has a quick rising property, and can heat the member to be recorded in accordance with a desired arranged heat distribution, with high precision and high efficiency.

An image fixing apparatus according to a 43rd aspect of the present invention is the image fixing apparatus according to the 42nd aspect, wherein the heat generator is constructed by a thin membrane body having a thickness equal to or less than 300 μm. The image fixing apparatus according to the 43rd aspect of the present invention structured as mentioned above can fix an image while reducing energy consumption by using a heat source having a small heat capacity and having a quick rising property.

An image fixing apparatus according to a 44th aspect of the present invention is the image fixing apparatus according to the 42nd aspect, wherein the heat generator is constructed by a light membrane body having a density equal to or less than 1.0 g/cm³. The image fixing apparatus according to the 44th aspect of the present invention structured as mentioned above can fix an image while reducing energy consumption by using a heat source having a small heat capacity and having a quick rising property.

An image fixing apparatus according to a 45th aspect of the present invention is the image fixing apparatus according to the 42nd aspect, wherein the heat generator is formed by a material having a coefficient of thermal conductivity equal to or more than 200 W/m·K. The image fixing apparatus according to the 45th aspect of the present invention structured as mentioned above can carry out heating in accordance with a uniform arranged heat distribution since the heat generator has excellent heat conduction.

An image fixing apparatus according to a 46th aspect of the present invention is the image fixing apparatus according to the 42nd aspect, wherein the heating body has a container storing a part of a power supply portion supplying power in both opposed ends of the heat generator together with the heat generator, and the container is structured such as to be filled with an inert gas in an inner portion and be sealed in the power supply portion. The image fixing apparatus according to the 46th aspect of the present invention structured as mentioned above becomes an image fixing apparatus having a heat source having a high reliability, and can carry out heating in accordance with a desired arranged heat distribution, at a high temperature and high efficiency.

An image fixing apparatus according to a 47th aspect of the present invention is the image fixing apparatus according to the 42nd aspect, wherein the heating body is provided with a reflective portion for defining a heating region by the heat generator. The image fixing apparatus according to the 47th aspect of the present invention structured as mentioned above can heat the heating region in accordance with a desired arranged heat distribution, at a high temperature and high efficiency, and can carry out a fixing process having a high reliability.

An image fixing apparatus according to a 48th aspect of the present invention is the image fixing apparatus according to the 42nd aspect, wherein the heating body is provided with a plurality of the heat generators, and respective center axes in a longitudinal direction in the plurality of heat generators are arranged on a straight line so as to be orthogonal to a supplying direction of the member to be recorded. The image fixing apparatus according to the 48th aspect of the present invention structured as mentioned above can switch the heating region in correspondence to the member to be recorded, and can specify heating having a high temperature and high efficiency to a desired region.

An image fixing apparatus according to a 49th aspect of the present invention is the image fixing apparatus according to the 42nd aspect, wherein the membrane body is formed by a member absorbing an infrared ray in a surface opposed to the heat generator, in the heating body. In the image fixing apparatus according to the 49th aspect of the present invention structured as mentioned above, the heat generator absorbs the heat from the heat generator with high efficiency and it is possible to achieve heating having a high temperature and high efficiency with respect to the member to be recorded.

An image fixing apparatus according to a 50th aspect of the present invention is the image fixing apparatus according to the 42nd aspect, wherein a heating range of the heat generator includes a nip portion that is a pressing position of the member to be recorded by the heating body and the pressurizing body, and an upstream side position in the conveying direction of the member to be recorded by the nip portion. The image fixing apparatus according to the 50th aspect of the present invention structured as mentioned above can carry out an image fixing process securely and with high efficiency.

An image fixing apparatus according to a 51st aspect of the present invention includes the image fixing apparatus according to any of the 40th aspect to the 50th aspect. The image fixing apparatus according to the 51st aspect of the present invention structured as mentioned above can heat the member to be recorded that is an object to be heated in accordance with a desired arranged heat distribution, and to a high temperature, has a quick rising property, and can carry out heating control with high precision while reducing an energy loss.

### EFFECTS OF THE INVENTION

In accordance with the present invention, it is possible to construct a heat generation unit as a heat source which is high in safety and reliability and has high efficiency, and it is possible to provide a heat generation unit having high working efficiency and an excellent productivity. Further, in accordance with the present invention, since the heat generation unit having the effect mentioned above is embedded as the heat source in the heating apparatus, it is possible to provide various heating apparatuses which are high in safety and reliability and have high efficiency.

### BRIEF DESCRIPTION OF THE DRAWINGS

FIG. 1 is a plan view showing a structure of a heat generation unit according to embodiment 1 of the present invention.

FIG. 2 is a front view showing the structure of the heat generation unit according to embodiment 1 of the present invention.

FIG. 3 is a plan view showing a heat generator attaching device according to embodiment 1 of the present invention.

FIG. 4 is a front view showing the heat generator attaching device according to embodiment 1 of the present invention.

FIG. 5 is a cross sectional view showing the heat generator attaching device according to embodiment 1 of the present invention.

FIG. 6 is a front view showing a heat generator attaching device according to embodiment 2 of the present invention by being partly ruptured.

FIG. 7 is a front view showing another heat generator attaching device according to embodiment 2 of the present invention by being partly ruptured.

FIG. 8 is a front view showing further another heat generator attaching device according to embodiment 2 of the present invention by being partly ruptured.

FIG. 9 is a cross sectional view showing a structure of a heat radiation source in a heating apparatus according to embodiment 3 of the present invention.

FIG. 10 is a cross sectional view showing a structure of a heat source substantial part in a heating apparatus according to embodiment 4 of the present invention.

FIG. 11 is a block diagram showing a structure of a temperature control device in the heating apparatus according to embodiment 4 of the present invention.

FIG. 12 is a plan view showing a structure of a heat generation unit according to embodiment 5 of the present invention.

FIG. 13 is a front view of the heat generation unit shown in FIG. 12.

FIG. 14 is a plan view showing a holder 3 and the like attached to an end portion of a heat generator 2 in the heat generation unit according to embodiment 5.

FIG. 15 is a front view of the holder 3 and the like in the heat generation unit according to embodiment 5.

FIG. 16 is a cross sectional view along line V-V of the holder 3 and the like shown in FIG. 14.

FIG. 17 is a view showing the heat generator 2, the holder 3 and a fixed portion 5 in the heat generation unit according to embodiment 5.

FIG. 18 is a plan view showing a holder 23 and the like attached to an end portion of a heat generator 2 in a heat generation unit according to embodiment 6 of the present invention.

FIG. 19 is a cross sectional view along line VIII-VIII of the holder 23 and the like shown in FIG. 18.

FIG. 20 is an expanded view of the holder 23 in the heat generation unit according to embodiment 6.

FIG. 21 is an expanded view showing another structure of the holder 23 in the heat generation unit according to embodiment 6.

FIG. 22 is across sectional view showing another engaging method between the heat generator and the fixed portion in the heat generation unit according to embodiment 6.

FIG. 23 is a plan view showing a holder 33 and the like attached to an end portion of a heat generator 2 in a heat generation unit according to embodiment 7 of the present invention.

FIG. 24 is a front view showing the holder 33 and the like shown in FIG. 23.

FIG. 25 is a view showing the heat generator 2 and the holder 33 in the heat generation unit according to embodiment 7.

FIG. 26 is a plan view showing another engaging method between the heat generator 2 and the holder 33 in the heat generation unit according to embodiment 7.

FIG. 27 is a cross sectional view showing a holder 43 and the like attached to an end portion of a heat generator 2 in a heat generation unit according to embodiment 8 of the present invention.

FIG. 28 is a plan view showing a structure of a heat generation unit according to embodiment 9 of the present invention.

FIG. 29 is a front view of the heat generation unit shown in FIG. 28.

FIG. 30 is a plan view showing a holder 3, a support ring 4, a fixed portion 5 and the like attached to an end portion of a heat generator 2 in a heat generation unit according to embodiment 9.

FIG. 31 is a front view showing the holder 3, the support ring 4, the fixed portion 5 and the like attached to the end portion of the heat generator 2 in the heat generation unit in FIG. 30.

FIG. 32 is a plan view showing another structure of the heat generation unit according to embodiment 9 of the present invention.

FIG. 33 is a front view showing a structure of a heat generation unit according to embodiment 10 of the present invention.

FIG. 34 is a front view showing a structure of a heat generation unit according to embodiment 11 of the present invention.

FIG. 35 is a perspective view showing an example of a heating apparatus according to embodiment 12 equipped with the heat generation unit according to embodiments 5 to 11 of the present invention.

FIG. 36 is a view showing a main structure in an image fixing apparatus according to embodiment 13 of the present invention.

FIG. 37 is a plan view showing a heat generation unit in the image fixing apparatus according to embodiment 13.

FIG. 38 is a side view of the heat generation unit in FIG. 37.

FIG. 39 is a temperature characteristic diagram showing a relation between a temperature [° C.] and a resistance [Ω] in a heat generator 2 of a heat generation unit 62 according to embodiment 13.

FIG. 40 is a graph showing a rising characteristic of the heat generation unit 62 used in the image fixing apparatus according to the present invention, and a carbon heater and a halogen heater which are conventional heaters.

FIGS. 41(a) to 41(c) are views comparing a rush current in various heaters, where FIG. 41(a) is a graph showing a current waveform at a rising time of the heat generation unit 62 used in the image fixing apparatus according to the present invention, FIG. 41(b) is a graph showing a current waveform at a rising time of the conventional carbon heater, and FIG. 41(c) is a graph showing a current waveform at a rising time of the halogen heater.

FIG. 42 is a graph showing a result of measurement of a copper plate temperature at the time of heating an object to be heated by the heat generation unit 62 used in the image fixing apparatus according to the present invention, and the conventional heater.

### BEST MODE FOR CARRYING OUT THE INVENTION

A description will be given below in detail of a preferred embodiment of a heat generation unit according to the present invention, and a heating apparatus using the heat generation unit, with reference to the accompanying drawings.

The inventors of the present invention have worked on developing a heat generation unit serving as a new heat source for various apparatuses by applying to a heat generator a new film sheet-shaped material (a film sheet raw material), which is completely different in a material and a manufacturing method from the heat generator used in a conventional heat generation unit, as a heat generating material. The film sheet-shaped material (the film sheet raw material) which is to be applied to the heat generator used in the heat generation unit as the new heat source has high efficiency and comes to a high temperature as mentioned below, and further has a small heat capacity because of its light and thin structure, and has an excellent rising characteristic. A description will be given below of the heat generation unit according to the present invention using the heat generator, and a heating apparatus equipped with the heat generation unit.

### Embodiment 1

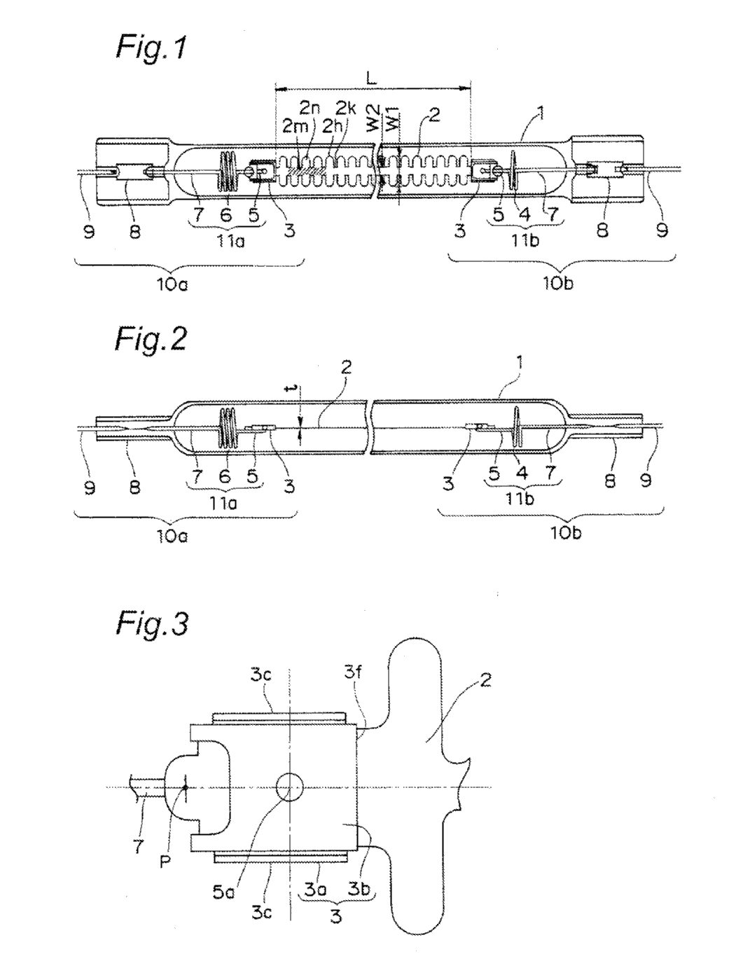

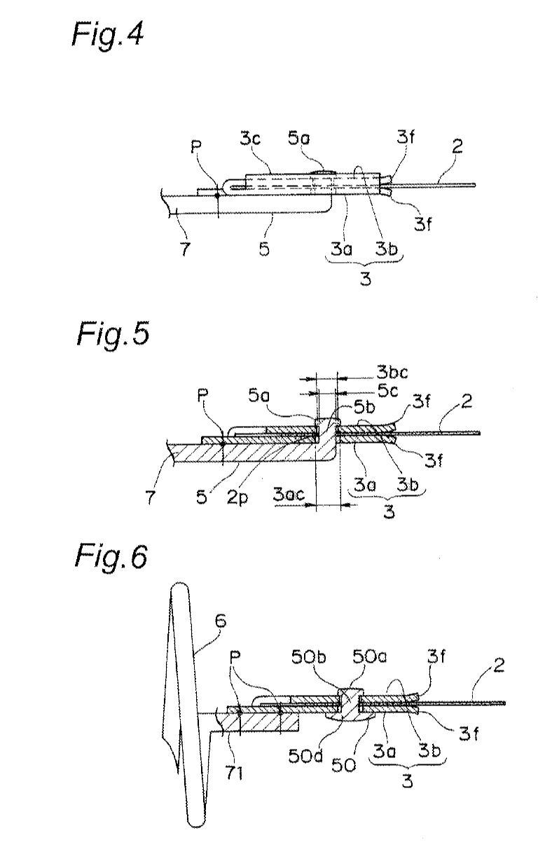

A description will be given of a heat generation unit according to embodiment 1 of the present invention with reference to FIGS. 1 to 5. FIG. 1 is a plan view showing a structure of the heat generation unit according to embodiment 1. In FIG. 1, since the heat generation unit is formed in a long shape, an intermediate portion thereof is omitted by rupturing, and portions near both end portions are shown. FIG. 2 is a front view of the heat generation unit according to embodiment 1. FIG. 3 is a plan view showing a heat generator attaching device provided in an end portion of a heat generator in the heat generation unit according to embodiment 1 in an enlarged manner. FIG. 4 is a front view showing the heat generator attaching device in FIG. 3. FIG. 5 is a cross sectional view cutting the heat generator attaching device in FIG. 4 along a longitudinal direction of the heat generator.

In the heat generation unit according to embodiment 1, an elongated band-like heat generator 2 (resistor) is arranged in an inner portion of a container 1 that is a glass tube formed by a transparent quarts glass. A longitudinal direction of the heat generator 2 is arranged in such a manner as to be in the same direction as a longitudinal direction of the container 1. Further, both end portions of the container 1 are deposited in a flat plate, and the heat generator 2 is sealed in an inner portion of the container 1 together with an inert gas such as an argon gas, a nitrogen gas or a mixed gas of the argon gas and the nitrogen gas. The argon gas, the nitrogen gas or the mixed gas of the argon gas and the nitrogen gas that are the inert gas charged in the inner portion of the container 1 is provided for preventing the heat generator 2 that is a carbon-based substance from being oxidized when being used at a high temperature.

As shown in FIG. 1, the heat generation unit according to embodiment 1 has the elongated band-shaped heat generator 2 serving as a heat radiator, and a holder 3 pinching (holding) each of both end portions of the heat generator 2. A first internal lead wire portion 11a is attached to one holder 3 (a left holder 3 in FIG. 1), and a second internal lead wire portion 11b is attached to the other holder 3 (a right holder 3 in FIG. 1). Each of the first internal lead wire portion 11a and the second internal lead wire portion 11b is electrically connected to an external lead wire 9 derived from the both ends of the container 1 via a molybdenum foil 8 embedded in a deposited portion in the both end portions of the container 1.

The first internal lead wire portion 11a is constructed by a fixed portion 5 bonded to the one holder 3 (the left holder 3 in FIG. 1), a spring portion 6 spirally formed so as to be capable of expanding and contracting along an inner wall surface of the container 1 and having elasticity, and an internal lead wire 7 connected to the molybdenum foil 8 in its one end. The fixed portion 5, the spring portion 6 and the internal lead wire 7 are formed by one wire rod.

The fixed portion 5 in the first internal lead wire portion 11a is bent in an L-shape in its end portion close to the holder 3, and a protruding end portion 5a is plastically deformed after passing through a through hole formed in the holder 3, and is fixed in such a manner as to be prevented from coming off (refer to FIGS. 4 and 5). Accordingly, the fixed portion 5 is engaged with the through hole of the holder 3 in a bent portion 5b that is a portion near the protruding end portion 5a. Further, the fixed portion 5 and the holder 3 is spot bonded (spot welded) at a position (a position of the spring portion 6 side in the holder 3) shown by a reference symbol P in FIGS. 4 and 5.

On the other hand, the second internal lead wire portion 11b is constructed by the fixed portion 5 bonded to the one holder 3 (the right holder 3 in FIG. 1), a support ring 4 regulating a distance between an inner wall of the container and the heat generator 2, and the internal lead wire 7 connected to the molybdenum foil 8 in its one end. The fixed portion 5, the support ring 6 and the internal lead wire 7 are formed by one wire rod.

The fixed portion 5 in the second internal lead wire portion 11b is bent in an L-shape in its end portion close to the holder 3 in the same manner as the fixed portion 5 in the first internal lead wire portion 11a, and a protruding end portion 5a is plastically deformed after passing through the through hole formed in the holder 3, and is fixed in such a manner as to be prevented from coming off (refer to FIGS. 4 and 5). Accordingly, even in the fixed portion 5 in the second internal lead wire portion 11b, the fixed portion 5 engages with the through hole of the holder 3 in the bent portion 5b that is the portion near the protruding end portion 5a. Further, the fixed portion and the holder 3 are spot bonded (spot welded) at a position in the support ring 4 side in the holder 3.

In this case, the first internal lead wire portion 11a and the second internal lead wire portion 11b in embodiment 1 will be described by an example formed by a molybdenum wire, however, the first internal lead wire portion 11a and the second internal lead wire portion 11b may be formed by using a metal wire (having a round rod shape or a polygonal shape such as a flat plate shape, as an end portion cross sectional shape) having elasticity and using tungsten, nickel, stainless steel or the like as a material.

In embodiment 1, a first power supply line constructed by the first internal lead wire portion 11a and the external lead wire 9 which are electrically connected via the molybdenum foil 8, and a second power supply line constructed by the second internal lead wire portion 11b and the external lead wire 9 which are electrically connected via the molybdenum foil 8, are respectively arranged as a lead wire supplying power to the heat generator 2 indirectly or directly from outside the heat generation unit, in the both end portion sides of the heat generator 2. Further, a first power supply portion 10a is constructed by the holder 3 and the first power supply line, and a second power supply portion 10b is constructed by the holder 3 and the second power supply line.

The spring portion 6 in the first internal lead wire portion 11a applies a tensile force to the heat generator 2, and is structured such that the heat generator 2 is always arranged at a desired position. In other words, the heat generator 2 is arranged approximately on a center axis of the container 1, and is arranged in such a manner as to prevent from coming into contact with the inner wall surface of the container 1. Further, it is possible to absorb a change caused by expansion and contraction in the heat generator 2 by providing the spring portion 6 in the internal lead wire 7.

In the case where a slit, a hole or the like is formed in the heat generator 2, and the heat generator is attached within the container in a state where the tensile force is previously applied to the longitudinal direction of the heat generator 2, the expansion and contraction of the heat generator 2 may be absorbed by the slit, the hole or the like formed in the heat generator 2. In this case, it is not necessary to provide the spring 6 in the first internal lead wire portion 11a or the second internal lead wire 11b existing in the both ends of the heat generator 2.

Further, even when the heat generator 2 is changed by a thermal expansion or a thermal contraction, in the case where there is no risk that the heat generator 2 comes into contact with the container 1 due to an outer shape and a length of the container 1, or a structure and a specification of the heat generation unit, it is not necessary to provide the spring 6 and the support ring 4.

A position within the container of the heat generator 2 according to embodiment 1 need not be on the center axis of the container 1, but shapes of the spring 6 and the support ring 4 may be changed in such a manner that the heat generator 2 comes to a proper position according to a heating method (a radiating direction, a distribution and a temperature).

In the heat generation unit according to embodiment 1, the first internal lead wire portion 11a and the second internal lead wire portion 11b arranged in the both ends of the heat generator 2 are described by the example in which they have different structures from each other. However, if there is no problem in quality and a service life as the heat generation unit, the structures of the internal lead wire portions arranged in the both ends of the heat generator 2 may have the same structure. Further, in the case where the same structural member as the first internal lead wire portion 11a is used in the both ends of the heat generator 2 in the heat generation unit, it is possible to expect a further effect with respect to the position regulation of the heat generator 2 and the absorption of change by the expansion and contraction.

In the internal lead wire portions, when selecting whether the spring portion 6 is provided in one of the internal lead wire portions or in both of the internal lead wire portions, it is possible to appropriately make a selection in correspondence to the structure and the specification of the heat generation unit, or the specification or the like of the heating apparatus in which the heat generation unit is used. In this selection, it is possible to select in such a manner that an effect caused by the position regulation of the heat generator 2 and absorption of change by the expansion and contraction improves the quality of the heating apparatus in which the heat generator 2 is used. In the case where the spring portion 6 is structured so as to have a function of the position regulation within the container of the heat generator, it is not necessary to provide the support ring 4.

In the heat generation unit according to embodiment 1, the description is given of the example in which the internal lead wire 7, the fixed portion 5 and the support ring 4 are constructed by one wire rod in the second internal lead wire portion 11b, however, it is not necessary that the support ring 4 is constructed by one wire rod in the same manner as the internal lead wire 7 and the fixed portion 5. The same effect can be achieved by any structure as long as a structure which can regulate a distance between the container inner wall and the heat generator 2, such as a structure winding the other wire rod in a ring shape around the internal lead wire 7 and the fixed member 5, a structure attaching a plate-like member or the like is used in place of the support ring 4.

In the heat generation unit according to embodiment 1, in the case where the longitudinal direction of the heat generation unit is structured to be in a vertical direction (that is, a direction to which a gravity is applied) in the heating apparatus, or in the case where the heat generation unit is incorporated in the heating apparatus in an up and down state (that is, a state of being arranged in such a manner that the longitudinal direction of the heat generation unit is inclined to the vertical direction), in a positional relationship between the first internal lead wire portion 11a and the second internal lead wire portion 11b, if the spring portion 6 is arranged above the heat generator 2, there is a risk that the spring portion 6 is heated by a temperature of an air current which is heated by the heat generator 2 so as to rise, and exceeds an elastic limit and cannot absorb the thermal expansion. Accordingly, in the heating apparatus structured as mentioned above, it is preferable that the spring portion 6 is arranged below the heat generator 2.

Next, a description will be given of the band-shaped heat generator 2 (resistor) used in embodiment 1. The heat generator 2 is formed by cutting a film sheet raw material, and is structured such that wide portions 2h and narrow portions 2k are continuously arranged alternately in a longitudinal direction. As shown in FIG. 1, the heat generator 2 used in the heat generation unit according to embodiment 1 has a so-called fish bone shape.

In the heat generator 2 according to embodiment 1, a band thickness (t) is 100 μm, a band width (W1) of the wide portion 2h is 6 mm, a band width (W2) of the narrow portion 2k is about 2 mm, and a length (L) is 250 mm (refer to FIG. 1). In this case, the length of the heat generator 2, the band thickness and the respective band widths are decided by an input voltage, a heat generation temperature and the like, and can be appropriately changed in correspondence to the specification of the heat source in which the heat generation unit is used.

The heat generator 2 according to embodiment 1 is structured to have an energization heat generation portion 2m (a portion of the narrow portion 2k, and a portion equivalent to the band width (W2) of the narrow portion 2k adjacent to each of the wide portions 2h) through which a current flows upon energization so as to generate heat, and a conduction heat generation portion 2n (a portion except the energization heat generation portion 2m, that is, the portion equivalent to the band width (W2) of the adjacent narrow portion 2k, in each of the wide portions 2h) generating heat by heat conduction from the energization heat generation portion 2m. The heat generator 2 according to embodiment 1 has equivalent heat conduction in all the directions on the same heat generating surface that is the band surface of the heat generator 2, and has a characteristic having a so-called two-dimensional isotropic thermal conductivity.

The two-dimensional isotropic thermal conductivity means one having a characteristic that heat conduction becomes equivalent in all the directions in any place on the same surface of the heat generator 2. Accordingly, the heat generator which does not have the two-dimensional isotropic property and does not relate to the present invention means, for example, a heat generator in which heat conduction in the same surface direction is different between one direction (a direction of an X-axis) in a carbon fiber direction in a resistor formed by arranging carbon fibers coming to the energization heat generation portion in line in the same direction and a direction of a Y-axis which is orthogonal to the X-axis direction. Alternatively, the heat generator which does not have the two-dimensional isotropic property means a heat generator in which heat conduction is different between two directions (the X-axis direction and the Y-axis direction) in the carbon fiber direction in the resistor formed by weaving the carbon fiber in cross pattern, and the same surface direction in the portion where the carbon fiber does not exist.

In the shape of the heat generator 2 according to embodiment 1, in the case where a coefficient of thermal conductivity of the heat generator 2 is less than 200 W/m·k, that is, in the case where the two-dimensional isotropic thermal conductivity is deteriorated by a lack of an amount of thermal conduction, the heat conducted from the energization heat generation portion 2m to the conduction heat generation portion 2n is reduced. In this case, a temperature difference becomes large between the energization heat generation portion 2m and the conduction heat generation portion 2n, and temperature unevenness is generated in the heat generator 2. Accordingly, the two-dimensional isotropic thermal conductivity in the heat generator 2 is deteriorated.

Accordingly, the heat generator 2 used in the heat generation unit according to embodiment 1 of the present invention is formed by using a carbon-based substance as a main component, has the two-dimensional isotropic thermal conductivity, and is formed by the film sheet raw material having the coefficient of thermal conduction equal to or more than 200 W/m·k. Accordingly, the heat generator 2 becomes a heat source uniformly generating heat with no unevenness by the heat generation and the heat conduction, in the energization heat generation portion 2m and the conduction heat generation portion 2n.

The film sheet raw material that is the material of the heat generator 2 according to the present invention is a high orientation graphite film sheet having a heat resistance formed as a graphite by heat treating a high polymer film under an ambient atmosphere at a high temperature, for example, 2400° C. and sintering, and is structured so as to have such a characteristic that a coefficient of thermal conduction in a surface direction is between 600 and 950 W/m·k. Further, the film sheet raw material manufactured as mentioned above is generally worked into a desired shape by a trimming die such as a Thomson die or the like, a laser processing or the like. In this case, in the different material from the material of the heat generator 2 according to the present invention in which a film sheet shape is formed by a rolling work by molding a powder having a natural black lead as a main component, and sintering, the coefficient of thermal conduction is generally between 200 and 400 W/m·k. As mentioned above, the heat generator 2 used in embodiment 1 according to the present invention has such an excellent two-dimensional isotropic thermal conductivity that the coefficient of thermal conduction in the surface direction is between 600 and 950 W/m·k.

The film sheet raw material that is the material of the heat generator 2 includes at least one kind of high polymer film selected from the group consisting of polyoxadiazole, polybenzothiazole, polybenzobisthiazole, polybenzooxazole; polybenzobisoxazole, polypyromellitic imide (pyromellitic imide), polyphenylene isophthalic amide (phenylene isophthalic amide), polyphenylene benzoimidazole (phenylene benzoimidazole), polythiazole and polyparaphenylenevinylene. The film sheet-like film sheet raw material is manufactured by treating at 2400° C. or higher under an inert gas and regulating a pressure of a gas treatment atmosphere generated in the process of forming graphite. Further, it is possible to obtain the film sheet-like graphite sheet having a higher quality by rolling the graphite sheet manufactured as mentioned above, as necessary. The graphite sheet manufactured as mentioned above is used as the film sheet raw material of the heat generator 2 in the heat generation unit according to the present invention.

A description will be given below of a specific structure of the heat generator attaching device in the heat generation unit according to embodiment 1 with reference to FIGS. 3, 4 and 5. The heat generator attaching device in the heat generation unit has a function of securely fixing the heat generator 2 to a predetermined position within the container. FIG. 3 is a plan view showing the heat generator attaching device provided in the end portion of the heat generator 2 in an enlarged manner, FIG. 4 is a front view showing the heat generator attaching device in FIG. 3, and FIG. 5 is a cross sectional view cutting the heat generator attaching device along the longitudinal direction of the heat generator.

The heat generator attaching device according to embodiment 1 is constructed by the holder 3 and the fixed portion 5 which are provided in the both ends of the heat generator 2. The holder 3 is constructed by bending a metal plate material. The holder 3 has a first holding portion 3a and a second holding portion 3b which are arranged in such a manner that mutual plate surfaces (hereinafter, referred to as pinching surfaces) are opposed via a gap. Band surfaces forming front and back sides of the end portion of the heat generator 2 are arranged in such a manner as to be respectively opposed to the pinching surfaces of the holder 3. In other words, the end portion of the heat generator 2 is arranged within a gap formed between the opposed surfaces of the first holding portion 3a and the second holding portion 3b.

Further, a through hole 3ac (shown by a diameter 3ac in FIG. 5) formed approximately in the center of the first holding portion 3a, a through hole 3bc (shown by a diameter 3bc in FIG. 5) formed approximately in the center of the second holding portion 3b, and a locking through hole 2p formed approximately in the center in the end portion of the heat generator 2 are arranged in such a manner that respective center axes passing through the holes are on the same axis. A portion close to the spring portion 6 of the fixed portion 5 is spot bonded (spot welded) at a position (refer to FIG. 5) denoted by reference symbol P in the first holding portion 3a. In embodiment 1, the spot bonded fixed portion 5 is constructed by one wire rod connected to the spring portion 6 and the internal lead wire 7. In the heat generation unit according to embodiment 1 constructed as mentioned above, the holder 3 and the fixed portion 5 come to a state where they are fixed by two points at the position P of the spot bonding, and an engaging position between the bent portion 5b of the fixed portion 5 and the through hole of the holder 3. Accordingly, in the heat generation unit according to embodiment 1, the holder 3 and the fixed portion 5 are structured so as to be prevented from rotating and twisting in their mutual positional relationships.

In the portion near the protruding end portion 5a of the fixed portion 5, the bent portion 5b is formed by being bent in the L-shape. The bent portion 5b is inserted in sequence the through hole 3ac of the first holding portion 3a, the locking through hole 2p of the heat generator 2, and the through hole 3bc of the second holding portion 3b thereto, and the protruding end portion 5a is plastically deformed. Accordingly, the bent portion 5b of the fixed portion 5 comes to a state of engaging with each of the through hole 3ac, the locking through hole 2p and the through hole 3bc. As a result, the heat generator 2 is pulled by the fixed portions 5 in the both sides thereof, thereby engaging with the bent portion 5b of the fixed portion 5 and the locking through hole 2p of the heat generator 2, and is provided in a tensional manner at a predetermined position within the container.

As shown in FIGS. 4 and 5, the protruding end portion 5a protruding to the upper side than the through hole 3bc of the second holding portion 3b is plastically deformed to a shape larger than the diameter of the through hole 3bc, in the fixed portion 5. The protruding end portion 5a has a position regulating function. Since the protruding end portion 5a having the position regulating function, and the spot bonded portion (the position denoted by the reference symbol P) of the other fixed portion 5 having the position regulating function are fixed in such a manner as to press the holder 3, the first holding portion 3a and the second holding portion 3b come to a state of being pressed in an opposed direction. As a result, the end portion of the heat generator 2 is pinched in a state of being crimped by the first holding portion 3a and the second holding portion 3b, and is securely locked by the bent portion of the fixed portion 5.

In this case, if a rupture resisting strength of the locking through hole 2p is sufficient in the relative relationship to the expansion and contraction of the heat generator 2, the structure may be made such that the end portion of the heat generator 2 is set to a state where it is not crimped by the first holding portion 3a and the second holding portion 3b, and the heat generator 2 is locked only by the bent portion 5b of the fixed portion 5.

With respect to a method of plastically deforming the protruding end portion 5a of the fixed portion 5 having the position regulating function, it is possible to employ a mechanical processing method such as press working and a rotational caulking process and the like, and a depositing method by a heat, a current, a plasma and the like. Further, as the other methods, it is possible to employ a screwing method by a nut, and a locking method by a retaining ring (for example, a C-shaped retaining ring, an E-shaped retaining ring or the like).

In embodiment 1, the description is given of the example structured such that the both end portions of the heat generator 2 are pinched and held by the holder 3, however, the both end portions of the heat generator 2 may be pinched by a caulking process by means of the holder 3 or by using an adhesive agent.

In the end portion of the heat generator 2 of the film sheet raw material having the carbon-based substance as the main component, the end portion of the heat generator 2 inserted between the first holding portion 3a and the second holding portion 3b is pinched by the portion centering on the through holes 3ac and 3bc in the holder 3. Accordingly, even in the case where the tensile force in the longitudinal direction of the heat generator 2 is generated and the external force is applied to the end portion of the heat generator 2, the external force applied to the portion near the through holes 3ac and 3bc of the holder 3 is dispersed, and a holding strength by the first holding portion 3a and the second holding portion 3b pinching (holding) the end portion of the heat generator 2 is increased. As a result, it is possible to prevent the end portion of the heat generator 2 from moving from the first holding portion 3a and the second holding portion 3b. Accordingly, it is possible to inhibit the external force applied to the locking through hole 2p formed in the end portion of the heat generator 2 by the bent portion 5b that is the engagement portion of the fixed portion 5 even at the time when the tensile force is generated in the longitudinal direction of the heat generator 2. Therefore, it is possible to prevent the end portion of the heat generator 2 from being damaged.

The holder 3 formed by the metal material in embodiment 1 can securely fix even in the case where the heat generator 2 is formed by a material which is soft and has no shape retaining strength or a carbon fiber.

In the heat generation unit according to embodiment 1, the description is given of the case where the through holes of the first holding portion 3a and the second holding portion 3b are respectively formed approximately in the centers thereof, however, it is not necessary to form the through holes approximately in the centers of the first holding portion 3a and the second holding portion 3b as long as the through holes are formed in the position which can securely pinch the end portion of the heat generator 2. In this case, with respect to each of the through holes 3ac and 3bc formed in the holder 3, a plurality of through holes may be provided in correspondence to the magnitude, the shape and the like of the end portion of the heat generator 2.

In the heat generation unit according to embodiment 1, the insertion of the bent portion 5b can be easily achieved by forming the through hole 3bc in the second holding portion 3b of the holder 3 larger than the outer diameter of the bent portion 5b of the fixed portion 5, and forming the through hole 3bc smaller than the through hole 3ac of the first holding portion 3a. In this case, the outer diameter of the bent portion of the fixed portion 5 is the same as the outer diameter of the protruding end 5a before plastic deformation. Further, it is possible to arrange at least a part of the round portion generated in the bending root of the bent portion 5b formed by bending the fixed portion 5 in the L-shape within the through hole 3bc, by forming the diameter of the through hole 3ac of the first holding portion 3a larger than the through hole 3bc of the second holding portion 3b. As a result, in the engagement state of the holder 3 and the fixed portion 5, it is possible to obtain a pinching state having no disadvantage that the through hole 3ac of the first holding portion 3a and the bent portion 5b unnecessarily collide with each other.

Further, in embodiment 1, the holder 3 is described by the structure example in which the first holding portion 3a and the second holding portion 3b are integrated, however, the same effect can be obtained by a structure in which the first holding portion 3a and the second holding portion 3b are separated into two sections or into a plurality of sections more than two so as to pinch the heat generator.

Further, in the first holding portion 3a and the second holding portion 3b of the holder 3, opposed surfaces of edge portions from which the heat generator 2 is derived are curved in directions which get away from each other, and derived portions 3f and 3f are formed. By forming the curved derived portions 3f and 3f as mentioned above, it is possible to prevent the derived end portion of the heat generator 2 installed to the holder 3 from being damaged by coming into contact with the holder 3. These derived portions 3f and 3f have a function serving as a fracture preventing portion. Further, it is possible to enhance the strength of the holder 3 in such a manner as to stand an oscillation, a thermal expanding and contracting cycle and a thermal stress, by curving the derived portions 3f and 3f of the holder 3. In this case, in embodiment 1, the description is given of the example in which the derived portions 3f and 3f are constructed by the curved surfaces, however, they may be constructed by inclined surfaces, and may employ any shape as long as an end portion deriving the heat generator 2 in the holder 3 is expanded and does not come into contact with the heat generator 2. An inclined surface shape of such derived portions 3f and 3f can be used by being processed so that a protruding direction of a burr generated at the time of the press working or the like comes to a direction getting away from the heat generator 2, or may be formed by a grinding work.

Further, in the first holding portion 3a, side wall portions 3c are formed in both side edge portions parallel to a longitudinal direction of the heat generator 2 so as to be opposed. The side wall portions 3c formed so as to be opposed with the heat generator 2 therebetween are provided in a rising manner by bending the edge portion of the first holding portion 3a in an L-shape. The side wall portion 3c can be utilized as a positioning at the time of carrying out a work for attaching any one of the heat generator 2, the first internal lead wire portion 11a and the second internal lead wire portion 11b to any one of the first holding portion 3a and the second holding portion 3b. Further, the side wall portion 3c is structured so as to increase a strength in the first holding portion 3a and the second holding portion 3b, particularly a strength in a longitudinal direction of the heat generator 2, and can keep a strength against the oscillation, the thermal expanding and contracting cycle and the thermal stress. Further, by providing the side wall portion 3c, it is possible to maintain a pinching state such as a contact state, a holding state and the like of the end portion of the heat generator 2 by the first holding portion 3a and the second holding portion 3b in a favorable state.

In order to further improve the pinching state, it is preferable to form a concavo-convex portion in each of the pinching surfaces of the first holding portion 3a and the second holding portion 3b opposed to the band surfaces of the end portions of the heat generator 2. By forming the concavo-convex portion in each of the pinching surfaces of the first holding portion 3a and the second holding portion 3b as mentioned above, the surface of the end portion of the heat generator 2 is pressure contacted by each of the pinching surfaces of the first holding portion 3a and the second holding portion 3b so as to be pinched. Accordingly, it is possible to enhance a pinching force (a holding force) of the holder 3.

In the heat generation unit according to embodiment 1, if power is supplied to the external lead wire 9 derived from the both ends of the container 1, a current flows through the heat generator 2, and heat is generated by a resistance of the heat generator 2. At this time, since the heat generator 2 is formed by the material having the carbon-based substance as the main component, an infrared ray or the like is radiated from the heat generator 2. The heat generator 2 can change a heat dissipation state by changing an outer shape such as a width shape, a thickness and the like. For example, even in the heat generation unit formed by the same film sheet raw material, a radiation area becomes wide without accompanying a change of a resistance value by making its thickness small and making its width large, and it is possible to enhance radiation energy.

In a dimension of the heat generator 2 (refer to FIG. 2) in the heat generation unit according to embodiment 1, the band thickness t is 100 μm, the band width W1 of the wide portion 2h is 6 mm, the band width W2 of the narrow portion 2k is about 2 mm, and the length L is 250 mm (refer to FIG. 1), as mentioned above. The band-like portion in which the band width W2 of the narrow portion 2k is successive is the energization heat generation portion 2m (partly shown by a diagonal line in FIG. 1) in which the current flows in the heat generator 2 so as to generate heat. Further, the protruding portion protruding to the outer side from the energization heat generation portion 2m is the conduction heat generation portion 2n to which the heat from the energization heat generation portion 2m is conducted, and radiates the heat conducted from the energization heat generation portion 2m.

In the band-like heat generator 2 extended in the longitudinal direction, it is desirable that a ratio of the band thickness t with respect to the band width W1 or the band width W2 is equal to or more than 5/1. An amount of heat emitted from a band width surface (a surface constructed by the band width W1 and the band width W2) becomes substantially larger than an amount of heat emitted from a band thickness surface (a surface constructed by the band thickness t) by making the band width five times or more larger than the band thickness, and the heat generator 2 can be used as a heat source having a high directivity.

The heat generator 2 in the heat generation unit according to embodiment 1 constructed by the film sheet-like material having the carbon-based substance as the main component and having the two-dimensional isotropic thermal conductivity has high heat generation efficiency and has a positive temperature coefficient (PTC) that a resistance value becomes larger as a temperature becomes higher. Accordingly, the time after starting heating until reaching a rated temperature is extremely short. Therefore, a rush current generated at the time of lighting is about twice as large as that of a balanced state depending on a temperature after balancing, and a rush current about ten times as large is not generated as in the case where the heat generator is formed by the tungsten wire. Accordingly, the heat generator 2 in the heat generation unit according to embodiment 1 has such a characteristic that a flicker is hard to be generated. Further, a service life of the heat generator 2 is about 10000 hour depending on a used temperature. This is about twice the service life of the heat generator formed by the tungsten wire.

It is possible to manufacture the heat generator 2 having heat conduction having the two-dimensional isotropic property and having the positive temperature characteristic (PTC) where the resistance value rises as the temperature rises in the temperature characteristic, by processing at least one kind of high polymer film particularly selected from the film sheet raw material mentioned above at 2400° C. or higher in the inert gas, and controlling the pressure of the gas treatment atmosphere generated in the process of forming graphite. The heat generator 2 manufactured as mentioned above becomes a reliable and stable heat source which can secure a stability of the heat generation temperature and can carry out a stable self-input control against the heat fluctuation in the case where an input voltage is a fixed voltage.

In the description in embodiment 1 mentioned above, the description is given of the case where the heat generator 2 is inserted into the transparent quartz glass container, and is used at the high temperature by charging the gas into the container, however, the heat generator 2 in the heat generation unit according to the present invention may be inserted into a container other than the glass tube. Further, the heat generator 2 described in embodiment 1 can be applied to a heat generation unit in which a gas is not charged in the glass tube and the other container, as long as the used condition of the material of the heat generator 2 matches.

### Embodiment 2

A description will be given below of a heat generation unit according to embodiment 2 of the present invention with reference to FIG. 6. FIG. 6 is a front view showing a heat generator attaching device used at the time of attaching both end portions of a heat generator in the heat generation unit according to embodiment 2 in a partly broken manner. The heat generator attaching device according to embodiment 2 is constructed by holding portions arranged in the both end portions of the heat generator, a fixed portion and an internal lead wire. In the heat generation unit according to embodiment 2, a point different from the heat generation unit according to embodiment 1 is the heat generator attaching device shown in FIG. 6. Accordingly, in embodiment 2, a description will be given of the heat generator attaching device, and the description of embodiment 1 is applied to the structures other than the heat generator attaching device.

The heat generator attaching device in the heat generation unit according to embodiment 2 shown in FIG. 6 has the holder 3 constructed by the first holding portion 3a and the second holding portion 3b arranged in such a manner that the mutual pinching surfaces are opposed to each other via the space, in the same manner as the heat generation unit according to embodiment 1. The end portion of the heat generator 2 is arranged in the space between the first holding portion 3a and the second holding portion 3b. A fixed portion 50 of the heat generator attaching device according to embodiment 2 is formed in a rivet shape, and has a head 50d and a body 50b. The fixed portion 50 in embodiment 2 is connected to the molybdenum foil 8 in its one end, and is an independent body from an internal lead wire 71 in which the spring 6 is formed, as is different from the fixed portion 5 according to embodiment 1. The head 50d of the fixed portion 50 has a diameter larger than the body 50b, and has a diameter larger than the through hole of the holder 3. Further, the body 50b has such a shape as to pass through the through hole of the holder 3 and the through hole in the end portion of the heat generator 2. In embodiment 2, the body 50b of the fixed portion 50 passes through the locking through hole in the end portion of the heat generator 2 from the through hole of the first holding portion 3a, and passes through the through hoe of the second holding portion 3b. Further, the protruding end portion 50a protruding upward from the through hole of the second holding portion 3b in the body 50b of the fixed portion 50 is plastically deformed, and is formed in such a manner as to be prevented from falling out of the through hole of the second holding portion 3b.

In the fixed portion 50 constructed as mentioned above, the head 50d is locked to the first holding portion 3a, and is inhibited from moving in a direction from the first holding portion 3a to the second holding portion 3b. The head 50d has a first position regulating function. Further, the plastically deformed protruding end portion 50a is locked to the second holding member 3b, and is inhibited from moving in a direction from the second holding portion 3b to the first holding portion 3a. The protruding end portion 50a has a second position regulating function.

The heat generator attaching device structured as mentioned above is provided in one end portion of the heat generator 2 according to embodiment 2, and the same structure is provided in the heat generator attaching device provided in the other end portion of the heat generator 2. However, the internal lead wire fixed to the other end portion is provided with at least any one of the spring portion 6 and the support ring 4. In embodiment 2, a description will be given of one heat generator attaching device, of the heat generator attaching devices provided in the both end portions of the heat generator 2.

As mentioned above, in the heat generation unit according to embodiment 2, the body 50b of the fixed portion 50 coming to an engaged portion with the holder 3 is inserted to the through hole of the first holding portion 3a, the locking through hole of the heat generator 2 and the through hole of the second holding member 3b in this order, and comes to a state capable of engaging with each of the through holes. At this time, the head 50d has the first position regulating function. Further, the protruding end portion 50a formed in the body 50b is plastically deformed to a shape larger than the through hole of the second holding portion 3b, and has the second position regulating function.

As mentioned above, with the position regulation by the head 50d in the fixed portion 50 and the plastically deformed protruding end portion 50d, the end portion of the heat generator 2 is pinched in a state of being crimped by the first holding portion 3a and the second holding portion 3b, and is locked by the body 50b that is the engaging portion of the fixed portion 5.

Even in the case where the locking through hole of the heat generator 2 is relatively moved with respect to the fixed portion 50 by the thermal expansion and contraction, if a rupture resistance is sufficient, the structure may be made such that the end portion of the heat generator 2 is not crimped by the first holding portion 3a and the second holding portion 3b, and is held being locked only by the body 50b of the fixed portion 50.

In embodiment 1, one end is connected to the molybdenum foil 8, and the portion near the end portion close to the holder of the internal lead wire 71 in which the spring portion 6 is formed is bonded (for example, spot welded) to each of two positions (denoted by reference symbol P in FIG. 6) provided on the plate surface of the first holding portion 3a in which the end portion of the heat generator 2 is not arranged. It is possible to prevent the rotation and the twisting to the heat generator 2 by the bonding of the two points. Further, it is possible to easily carry out the bonding work such as the welding or the like, and the positioning between the internal lead wire 71 and the first holding member 3a at the time of working, by forming the bonded position P in the internal lead wire 71 flat.

In embodiment 2, the spring portion formed spirally along the inner wall surface of the container 1 and having elasticity while being capable of expanding and contracting is formed in the internal lead wire 17 in the same manner as the first internal lead wire portion 11a in the heat generation unit according to embodiment 1. In other words, the internal lead wire 71 in embodiment 2 is formed in a state where the fixed portion 5 is separated from the first internal lead wire portion 11a shown in the heat generation unit according to embodiment 1.

Accordingly, in the heat generation unit according to embodiment 2, similar to the heat generation unit according to embodiment 1, in the end portion of the heat generator 2 of the film sheet raw material having the carbon-based substance as the main component, the end portion of the heat generator 2 inserted between the first holding portion 3a and the second holding portion 3b is pinched by the portion centering on the through hole in the holder 3. Accordingly, even in the case where the tensile force is generated in the longitudinal direction of the heat generator 2, and the external force is applied to the end portion of the heat generator, the external force applied to the portion close to the through hole of the holder 3 is dispersed, and the holding strength by the first holding portion 3a and the second holding portion 3b pinching (holding) the end portion of the heat generator 2 is increased. As a result, it is possible to prevent the end portion of the heat generator 2 from moving from the first holding portion 3a and the second holding portion 3b. Accordingly, the external force applied to the locking through hole formed in the end portion of the heat generator 2 by the body 50b that is the engagement portion of the fixed portion 50 is inhibited even when the tensile force is generated in the longitudinal direction of the heat generator 2, and it is possible to prevent the end portion of the heat generator 2 from being damaged.

The holder 3 formed by the metal material in embodiment 2 can securely fix the heat generator 2 even if the heat generator 2 is formed by a material which is soft and does not have a shape retaining strength or a carbon fiber.

In the heat generation unit according to embodiment 2, the description is given of the case where each of the through holes of the first holding portion 3a and the second holding portion 3b is formed approximately in the center, however, the through holes are not necessarily formed approximately in the center of the first holding portion 3a and the second holding portion 3b as long as they are formed in the position that can securely pinch the end portion of the heat generator 2. In this case, in each of the through holes formed in the holder 3, a plurality of through holes may be provided in correspondence to a magnitude, a shape and the like of the end portion of the heat generator 2.

With respect to the plastic deforming method for forming the plastically deformed protruding end portion 50a of the fixed portion 50 having the second position regulating function, it is possible to employ the same plastically deforming method as the plastically deformed protruding end portion 5a in the heat generation unit according to embodiment 1. Further, as the position regulating member having the second position regulating function, it is possible to employ the other part which is independent from the body 50b of the fixed portion 50, in place of the plastic deformation. For example, the structure is made such that the body 50b of the fixed portion 50 protrudes so as to pass through each of the through holes of the holder 3, and a male thread is formed in the protruding portion. Further, a member having a female thread engaging the male thread is set to the position regulating member 50a having the second position regulating function. The position regulation of the holder 3 may be achieved by screwing the position regulating member 50a structured as mentioned above into the protruding portion of the fixed portion 50.

Further, the body 50b serving as the engagement portion of the fixed portion 50 may be constructed by a burring shape having a hollow tubular shape and having a slightly expanded both end sides. In this case, each of the portions protruding from both sides of the holder 3 in the cylindrical body 50b is caulked so as to expand further outside, and the cylindrical body 50b is fixed in such a manner as to be prevented from falling out from the holder 3. In this case, the caulked portion in both end portions of the body 50b has the first and second position regulating functions. Accordingly, the shape of the fixed portion 50 in embodiment 2 is not limited to an illustrated shape, but may be set to any shape that can prevent the fixed portion 50 from falling out from the through hole of the holder 3 and can securely hold the end portion of the heat generator 1.

In the heat generation unit according to embodiment 2, similar to the heat generation unit according to embodiment 1, the description is given of the example in which the first holding portion 3a and the second holding portion 3b of the holder 3 are integrally constructed, however, the same effect can be obtained even by the structure in which the holder 3 is divided into a plurality of sections so as to pinch the heat generator.

In embodiment 2, since the structure is made such that the fixed portion 50 and the internal lead wire 71 are separated, a handling becomes simple and the heat generator 2 can be prevented from damages, at the time of assembling so as to pinch the soft heat generator 2 by the first holding portion 3a and the second holding portion 3b. Further, with such a structure, it is possible to easily structure so as to form the opening portion only in one side of the container 1 and derive the internal lead wires 71 in both sides of the heat generator 2 from the opening portion.

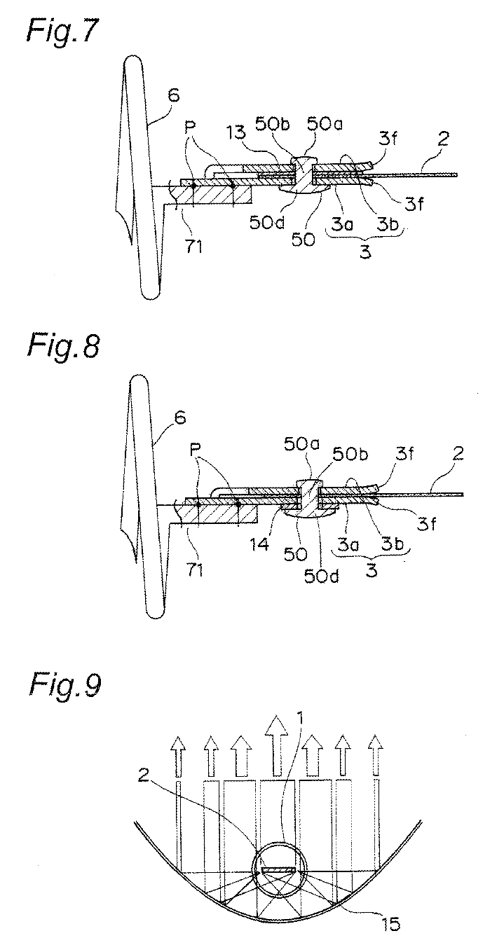

Next, a description will be given of a heat generator attaching device having another structure for improving the pinching force with respect to the heat generator 2 of the holders 3 provided in the both end portions of the heat generator 2, with reference to FIGS. 7 and 8.

FIG. 7 is a front view showing a heat generator attaching device having another structure and provided in the both end portions of the heat generator in the heat generation unit according to embodiment 2 in an enlarged manner, and shows in a partly ruptured manner. FIG. 8 is a front view showing a heat generator attaching device having further another structure and provided with the both end portions of the heat generator in the heat generation unit according to embodiment 2 in an enlarged manner, and shows in a partly ruptured manner. In embodiment 2, a description will be given by setting the heat generator attaching device shown in FIG. 6 as a first example, setting the heat generator attaching device shown in FIG. 7 as a second example, and setting the heat generator attaching device shown in FIG. 8 as a third example. In the following description, a description will be given of the heat generator attaching device provided in one end portion of the heat generator 2 shown in FIGS. 7 and 8, and since the heat generator attaching device provided in the other end portion of the heat generator 2 has the same structure, a description thereof will not be given. Further, in the heat generator attaching device shown in FIGS. 7 and 8, a description will be given of a case using the fixed portion 50 shown in FIG. 6.

First, a description will be given of the heat generator attaching device according to the second example shown in FIG. 7.

As shown in FIG. 7, in the heat generator attaching device according to the second example, the end portion of the heat generator 2 is arranged within a clearance between the first holding portion 3a and the second holding portion 3b of the holder 3, and a spacer 13 is inserted at least between the end portion of the heat generator 2 and the first holding portion 3a, and between the end portion of the heat generator 2 and the second holding portion 3b. The spacer 13 is structured so as to come into surface contact with the opposed surface of the first holding portion 3a or the second holding portion 3b. Accordingly, in the heat generator attaching device according to the second example, the spacer 13 is pinched together with the end portion of the heat generator 2 by the first holding member 3a and the second holding member 3b of the holder 3. Further, in the heat generator attaching device according to the second example, the protruding end portion 50a of the body 50b is plastically deformed after the fixed portion 50 is inserted, thereby, being locked to the second holding portion 3b. In the heat generator attaching device according to the second example, the head 50d of the fixed portion 50 has the first position regulating function, and the plastically deformed protruding end portion 50a has the second position regulating function.

In the heat generator attaching device according to the second example, since the heat generator 2 and the spacer 13 are provided in the clearance between the first holding portion 3a and the second holding portion 3b, the end portion of the heat generator 2 comes into close contact by the first holding portion 3a and the second holding portion 3b so as to be in a held state. The heat generator attaching device according to the second example structured as mentioned above comes to a state where the end portion of the heat generator 2 is securely held by the holder 3 and the fixed portion 50.

Next, a description will be given of the heat generator attaching device according to the third example shown in FIG. 8.

As shown in FIG. 8, in the heat generator attaching device according to the third example, the end portion of the heat generator 2 is arranged and held in the clearance between the first holding portion 3a and the second holding portion 3b of the holder 3. In the heat generator attaching device according to the third example, the body 50b of the fixed portion 50 passes through the through hole of the holder 3 and the locking through hole of the heat generator 2 and is locked, in a state where the end portion of the heat generator 2 is pinched by the first holding portion 3a and the second holding portion 3b of the holder 3. At this time, a ring-like washer-shaped spacer 14 is inserted between the first holding portion 3a of the holder 3 and the head 50d of the fixed portion 50. The protruding end portion 50a of the fixed portion 50 protruding outward from the through hole of the second holding portion 3b is plastically deformed, and a prevention for falling out from the holder 3 of the fixed portion 50 is formed. In the heat generator attaching device according to the third example, the head 50d of the fixed portion 50 has the first position regulating function, and the plastically deformed protruding end portion 50a has the second position regulating function.

In the heat generator attaching device according to the third example, since the spacer 14 is provided between the first holding portion 3a of the holder 3 and the head 50d of the fixed portion 50, the end portion of the heat generator 2 comes to a state where the end portion securely comes into contact with the first holding portion 3a and the second holding portion 3b so as to be held. The heat generator attaching device according to the third example structured as mentioned above comes to a state where the end portion of the heat generator 2 is securely held by the holder 3 and the fixed portion 50.

The spacers 13 and 14 according to the second example and the third example may be constructed by a material having elasticity even at a high temperature and having a conductivity, for example, any material such as a metal, a sintered metal, a ceramic, a carbon-including forming material and the like. Further, the spacers 13 and 14 are arranged between the members having the position regulating function with respect to the heat generator 2, that is, between the head 50d of the fixed portion 50 and the plastically deformed protruding end portion 50a, and is arranged at a position affecting a current path flowing through the internal lead wire 71 from the heat generator 2 via the holder 3. Accordingly, it is possible to control the amount of heat dissipation from the heat generator attaching device by changing a volumetric capacity (an area, a volume) of the spacers 13 and 14. Therefore, a temperature gradient can be provided in the heat generator 2 and the heat generator attaching device by using the spacers 13 and 14. As a result, it is possible to set the temperature in the heat generator attaching device that is an electric connecting portion to a desired value so as to achieve a long service life of the heat generation unit.

The heat generation unit shown in FIGS. 7 and 8 is structured so as to stand a contraction and expansion cycle by the heat, in a state where the tensile force is always applied to the heat generator 2, and is structured so as to be strong against a shock such as an oscillation and an impact. Further, in the heat generation unit structured as mentioned above, since it is possible to improve a contact resistance between the first holding portion 3a and the second holding portion 3b of the holder 3 pinching the end portion of the heat generator 2, a further long service life of the heat generation unit can be achieved.

### Embodiment 3

A description will be given below of a heating apparatus according to embodiment 3 of the present invention with reference to FIG. 9. The heating apparatus according to embodiment 3 is structured so as to use the heat generation unit according to embodiment 1 and embodiment 2 mentioned above as a heat radiation source. FIG. 9 is a view showing a main structure of the heating apparatus provided with a reflective portion (a reflective plate) as a reflective means, by using the heat generation unit according to the present invention as the heat radiation source, and is a cross sectional view cutting in a direction which is orthogonal to a longitudinal direction of the heat generator 2 of the heat generation unit.

The heating apparatus according to embodiment 3 shown in FIG. 9 is only one example, and the heating apparatus shown in FIG. 9 employs the heat generation unit (refer to FIG. 1) according to embodiment 1 mentioned above as the heat radiation source. The heating apparatus according to embodiment 3 is provided with a reflective plate 15 at a position to which the flat portion of the heat generator 2 in the heat generation unit is opposed. In the reflective plate 15, a cross sectional shape which is orthogonal to the longitudinal direction of the heat generator 2 has a parabolic shape. A center axis which is in parallel to the longitudinal direction of the heat generator 2 is arranged at an approximately focal point position in the parabolic curve of the reflective plate 15. In this heating apparatus, the heat radiation source is constructed by the heat generation unit and the reflective plate 15 as the reflective means.

In the heating apparatus according to embodiment 3, there are included structural elements which are generally used in the heating apparatus, such as a power supply portion supplying power to the heat generation unit, a control portion controlling the power, a casing forming an outer appearance of the apparatus and the like, in addition to the heat generation unit that is the heat radiation source shown in FIG. 9. With respect to the heating apparatus described below, a description will be given in detail of the heat generation unit that is the heat radiation source and the reflective means which are the feature of the heating apparatus according to the present invention.

In the heating apparatus according to embodiment 3, the heat generator 2 used in the heat generation unit has the carbon-based substance as the main component, has the thermal conductivity in the surface direction the same as that of the heat generator 2 described in embodiment 1, and is formed in an elongated band shape by a film sheet-like material having a so-called two-dimensional isotropic thermal conductivity. Accordingly, the amount of heat emitted from the flat portion of the heat generator 2, that is, the band width surface indicates a value which is dramatically larger than the amount of heat emitted from the band thickness surface (the surface showing the band thickness t of the heat generator shown in FIG. 2). In other words, the heat generator 2 is a heat emitting body in which a heat ray is emitted in a direction which is orthogonal to the band width surface.

In the following description, in a pair of band width surfaces serving as front and rear surfaces of the elongated band-like heat generator 2, a surface opposed to an object to be heated arranged in a forward side of the heat generation unit is set to a front surface side band width surface, and a surface in an opposite side thereto is set to a back surface side band width surface. In the heating apparatus according to embodiment 3, a reflective surface of the reflective plate 15 is provided at a position opposed to the back surface side band width surface of the heat generator 2 so as to be opposed. Accordingly, the heat ray emitted from the back surface side band width surface of the heat generator 2 is reflected by the reflective plate 15, and heats the object to be heated existing in the forward side of the reflective plate 15 with high efficiency.

In the heating apparatus shown in FIG. 9, the reflective plate 15 in which the cross section orthogonal to the longitudinal direction of the heat generator 2 is formed in a parabolic shape is provided at a position opposed to the back surface side band width surface of the heat generator 2 in the heat generation unit. A center of heat generation in the heat generator 2 as the heat radiation source is arranged at a position of a focal point of the parabolic curve showing the cross sectional shape of the reflective plate 15. As mentioned above, in the heating apparatus according to embodiment 3, since the center of heat generation in the heat generator 2 is at the position of the focal point of the reflective plate 15, the radiated heat from the back surface side band width surface of the heat generator 2 is reflected by the reflective plate 19 so as to be a parallel heat ray, and it is possible to achieve a heat radiation having high efficiency.

In this case, in the heating apparatus according to embodiment 3, the reflective surface shape of the reflective plate 15 is described by the curved surface shape having the parabolic surface in which the heat reflection becomes in parallel, however, the reflective plate in the present invention is not limited to the shape mentioned above. The cross sectional shape which is orthogonal to the longitudinal direction of the reflective plate 15 may be formed in a cross sectional shape which can reflect the radiated heat at least from the back surface side band width surface of the heat generator 2 and can heat the object to be heated positioned in the forward side of the heat generator 2.

Various shapes can be applied to the cross sectional shape which is orthogonal to the longitudinal direction of the reflective plate 15, for example, a circular arc shape, a polygonal shape and the like are included. Further, the reflective plate 15 includes a shape having a curved surface shape and a multiple staged bent surface which expand the radiated heat from the heat generator 2 and can diffuse and reflect, for example, a shape obtained by collecting polygons such as a saw-toothed cross sectional shape.

Further, the reflective plate 15 may be structured such that a convex portion protruding in a direction of the heat generator 2 is provided in the center portion in the band width direction, and the radiated heat reflected by this convex portion does not heat the back surface side band width surface of the heat generator 2.

Further, the reflective plate 15 used in the heating apparatus according to embodiment 3 may be structured such that the radiated heat incident on the reflective plate 15 comes to a desired diffused state, by combining the various shapes mentioned above.

In this case, in the heating apparatus according to embodiment 3, the heat generation unit is arranged in the inner side from both side edges along the longitudinal direction of the reflective plate 15, that is, in such a manner as to prevent the heat generation unit from protruding to the forward side that is the side of the object to be heated from the reflective plate 15. Accordingly, the heat generation unit is arranged within an inner space, surrounded by the reflective plate 15. It is possible to carry out the reflection by the reflective plate 15 with high efficiency, by arranging the heat generation unit within the inner space of the reflective plate 15. Particularly, in the case where the protruding convex portion and the concave portion by the polygonal shape are formed in the reflective plate, they are effective in diffused radiation from the convex portion and irregular radiation from the concave portion.

An aluminum, an aluminum alloy, various kinds of stainless steels and the like can be used as the material of the reflective plate 15 in embodiment 3. Further, it goes without saying that it is preferable to perform a process of enhancing a reflection factor of the reflective plate 15, by applying a coating or a surface treatment of a reflective material having a high reflection efficiency to the reflective surface of the reflective plate 15.

### Embodiment 4

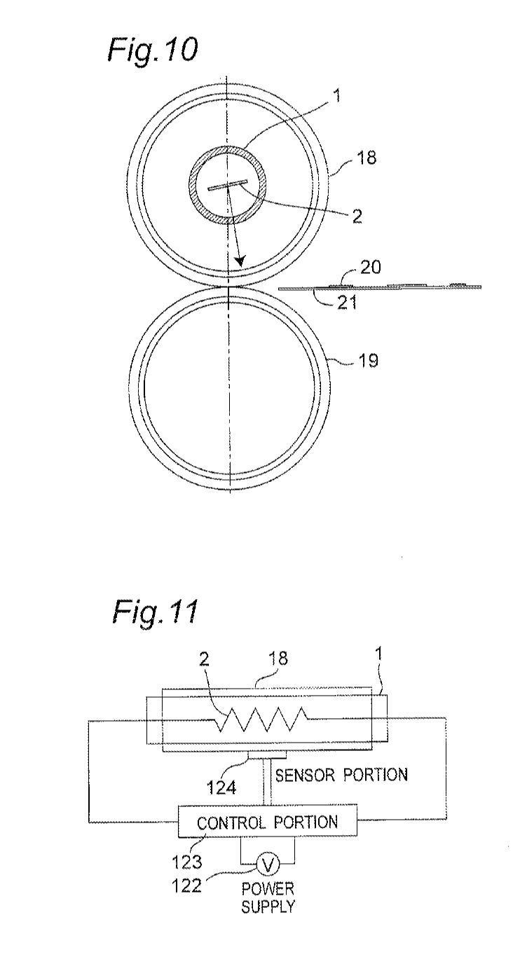

A description will be given of a heating apparatus according to embodiment 4 of the present invention with reference to FIG. 10.

The heating apparatus according to embodiment 4 is a copying machine that is an image forming apparatus serving as one example. FIG. 10 is a view showing a portion near the heat generation unit and the like serving as the heat radiation source in the copying machine that is the heating apparatus according to embodiment 4, and is a cross sectional view cutting in a direction which is orthogonal to the longitudinal direction of the heat generation unit.

The copying machine that is the heating apparatus according to embodiment 4 uses the heat generation unit (refer to FIG. 1) according to embodiment 1 mentioned above as the heat radiation source. In the copying machine according to embodiment 4, the heat generation unit has the heat generator 2 in which the cross section orthogonal to the longitudinal direction thereof is formed as a flat surface, and is surrounded by a tube body 18. The copying machine according to embodiment 4 includes structural elements which are generally used in the copying machine, such as a power supply portion supplying power, a copying mechanism, a control portion controlling the copying mechanism, a feed portion feeding paper, a discharge portion discharging the paper, a casing forming an apparatus outer appearance and the like, in addition to the heat generation unit and the like shown in FIG. 10.

The heat generation unit that is the heat source in the copying machine according to embodiment 4 is arranged in an inner portion of the tube body 18 centering on a center axis which is in parallel to the longitudinal direction of the heat generation unit. In other words, the heat generation unit is arranged in the inner portion of the concentric tube body 18 in such a manner as to surround the container 1. The tube body 18 is a toner fixing roller. The toner fixing roller 18 and a pressurizing roller 19 are arranged in such a manner that mutual thrust axial directions are in parallel to each other, and are structured such that outer tube surfaces come into contact with each other and rotate. A sheet of paper 21 fed by the paper feed portion is inserted between the toner fixing roller 18 and the pressurizing roller 19. A toner 20 in which a desired shaped image as an image data including letters, graphics and the like transferred from a photosensitive body in the process of feeding is specifically formed is carried on the paper 21 inserted between the toner fixing roller 18 and the pressurizing roller 19. The paper 21 in which the toner 20 is carried is inserted between the toner fixing roller 18 and the pressurizing roller 19, and is pressurized as well as being heated, whereby the toner 20 is fixed to the paper 21.

In the copying machine according to embodiment 4, in order to be passed between the toner fixing roller 18 and the pressurizing roller 19 and efficiently fix the toner 20 on the paper, the band width surface of the heat generator 2 is arranged in such a manner as to be directed to a region including the toner fixing roller 18, the pressurizing roller 19 and the opposed surfaces (a toner fixing region). Particularly, the direction that the band width surface of the heat generator 2 is directed is arranged in such a manner as to be directed to an upstream side than the toner fixing region, that is, a direction closer to the paper feed portion than the toner fixing region of the toner fixing roller 18. Since the heat generator 2 is arranged as mentioned above, the toner fixing region in the toner fixing roller 18 is heated while including the upstream side portion, an amount of stored heat in that portion is increased, and it is possible to effectively use the amount of heat emitted from the heat generator 2 for fixing the toner.

In the copying machine according to embodiment 4, the tube body 18 as the toner fixing roller arranged in such a manner as to surround the heat generation unit serving as the heat source is structured so as to store the heat emitted from the heat generation unit to radiate in a desired direction. In the tube body 18, a region opposed to the center in the width direction of the band width surface of the heat generator 2 becomes the center of the heat radiation.

In the copying machine according to embodiment 4, the description is given of the example in which the tube body 18 is constructed by the integral material, however, the tube body may be constructed by combining a plurality of members.

As mentioned above, in the copying machine according to embodiment 4, the heating apparatus having the highly efficient heat radiation source is achieved by effectively arranging the heat generation unit having the directivity.

Next, a description will be given of a temperature control method in the copying machine that is the heating apparatus according to embodiment 4 with reference to FIG. 11. FIG. 11 is a block diagram showing an schematic structure of a temperature control device in the copying machine according to embodiment 4.

In the copying machine according to embodiment 4, power supplied from a power supply 122 is controlled by a control portion 123 in accordance with a command from a user, and the heat generation unit serving as the heat source is energized. The heat generator 2 of the energized heat generation unit is heated to a high temperature, and raises a surface temperature of the outer tube surface of the toner fixing roller 18 that is the tube body to a predetermined temperature (a toner fixing temperature). A sensor portion 124 is provided in the toner fixing roller 18, and carries out temperature detection of the toner fixing roller 18. The sensor portion 124 feeds back a detected temperature of the toner fixing roller 18 to the control portion 123, and the control portion 123 controls the power to the heat generation unit, and carries out temperature regulation of the toner fixing roller 18.

In the copying machine according to embodiment 4, in the case of carrying out power supply control of the heat generation unit, it is possible to take into consideration the detected temperature of the toner fixing roller 18 as the control condition. Further, it is possible to realize the copying machine which can achieve a highly accurate temperature control, by carrying out the temperature control, for example, on-off control using temperature detecting means such as a thermostat or the like, input power source phase control using a temperature detecting sensor detecting an accurate temperature, power supply ratio control, zero-cross control and the like independently or combining them.

Therefore, in accordance with the copying machine structured as mentioned above, it is possible to achieve heating which is excellent in radiation characteristic and accurate temperature control, with the directivity control by the arranged position of the heat generator 2, and the power supply control by the detected temperature.

In this case, in the copying machine that is the heating apparatus according to embodiment 4, the description is given of the example in which the heat generation unit (refer to FIG. 1) according to embodiment 1 is used as the heat radiation source. However, an apparatus having high safety and reliability can be obtained by designing the heat generation unit serving as the heat radiation source in the copying machine by using the heat generation unit described in each of the following embodiments.

Further, in the heating apparatus according to embodiment 4, the description is given by exemplifying the copying machine, however, the heat generation unit according to the present invention can be used as the heat radiation source for fixing the toner even in an electronic apparatus such as a facsimile, a printer or the like, and the same effect can be achieved. In the case of a mechanism which is used for fixing the toner in the electronic apparatus such as the copying machine, the facsimile, the printer or the like, the heat generation unit used as the heat radiation source is used by being surrounded by the tube body called as the roller.

In this case, the heating apparatus according to the present invention includes an electric heating apparatus such as a heating stove or the like, a cooking appliance for cooking and heating, a drying machine for a food, and an apparatus which is necessary to be heated to a high temperature for a short time, in addition to the electronic apparatus such as the copying machine, the facsimile, the printer and the like.

In the copying machine according to embodiment 4, the toner fixing roller 18 that is the tube body surrounding the heat generation unit is structured such that an inner side is formed by a metal material, and an outer side is coated by a silicone resin. A rotationally driving gear and the like are provided in both sides of the toner fixing roller 18. Further, in order to enhance a heat absorbing characteristic in the toner fixing roller 18, a ceramic, a far infrared coating material or the like may be provided in an inner side of the toner fixing roller 18. Further, in the toner fixing roller 18, the tube body may be constructed by a plurality of metal members such as an aluminum, an iron or the like in view of the heat dissipation, the heat absorption and the strength, thereby achieving higher heating efficiency.

As the other example of the heating apparatus according to embodiment 4, there is a cooking appliance using the heat generation unit according to the present invention as the heat source. In the case of using the heat generation unit for the cooking appliance, the heat generation unit is arranged by being surrounded by the tube body. The tube body is a tubular heat resisting tube which is constructed integrally or by a plurality of members. In the case of using a heat generation unit provided with a heat generator within a quartz glass tube as is as the heat source in the cooking appliance, the quartz glass tube is devitrified by an alkaline metal ion or the like included in seasoning such as salt, soy sauce or the like so as to be broken, and the heat generation unit serving as the heat source comes to a short service life. Accordingly, it is possible to achieve a long service life of the heat generation unit by structuring the heat generation unit in such a manner as to be surrounded by the tube body that is the heat resisting tube. It is possible to expand the intended use by using crystallized glass having an excellent light transmitting characteristic, ceramic having a high far infrared ray emitting amount or the like as the tube body used in the cooking appliance.

In a positional relationship between the heat generation unit and the object to be heated, it is possible to heat the object to be heated efficiently by directing a center of heating in the heat generator 2 to the side of the object to be heated.

As mentioned above, in the heat generation unit according to the present invention, since the heat generator 2 is constructed by the film sheet raw material having the carbon-based substance as the main component, it is possible to obtain a heater which can heat more efficiently. However, since the heat generator 2 according to the present invention has a slippery surface, it is hard to fix only by the pinching by means of the conventional holder. Accordingly, as a countermeasure for preventing the slippage in a direction along the band width surface, the end portion of the heat generator 2 inserted between the first holding portion 3a and the second holding portion 3b is passed through and held by the fixed portions 5 and 50 in a state of being pressurized by the holder 3. As mentioned above, since the end portion of the heat generator 2 is pinched by the first holding portion 3a and the second holding portion 3b so as to be passed through by the fixed portions 5 and 50, a stable holding strength can be obtained with respect to the end portion of the heat generator; hence, it is possible to provide the heat generation unit which is strong in the heat cycle and has a long service life, and the heating apparatus using the heat generation unit.

In the present invention, since the position of the heat generator arranged within the glass tube can be changed by designing the heat generator attaching device in conformity to an aspect corresponding to an intended use, it is possible to structure such that the heat radiation can be carried out highly efficiently with respect to the object to be heated.

In the heat generation unit according to the present invention, it is possible to regulate the heat dissipation state in the heat generator attaching device, and it is particularly possible to design the internal lead wire short so as to set a total length of the heat generator short, by regulating the heat dissipation state in the holder. As a result, it is possible to make the apparatus using the heat generation unit according to the present invention compact.

In the heat generation unit according to the present invention, the heat generator 2 within the heat resisting tube can be used at a temperature which is equal to or less than the sintered temperature of the heat generator 2 without being oxidized, by sealing both end portions of the tubular heat resisting tube (the container 1 as the glass tube shown in FIG. 1) and charging the gas within the heat resisting tube. Therefore, according to the present invention, it is possible to expand a design margin level of the heat generator 2. Further, since the heat generator 2 used in the present invention has pliability, flexibility, and elasticity, and has a shape retaining characteristic with respect to a high temperature, it is possible to form the heat generator 2 to a desired shape, and it is possible to enhance freedom in a selection of the heat resisting tube material and a holding method of the heat generator.

As described in the heat generation unit according to embodiment 3 mentioned above, the reflective plate 15 serving as the reflective means is arranged at a position close to the back surface side of the heat generator 2 in the heat generation unit, in the heating apparatus shown in FIG. 9. The cross sectional shape which is orthogonal to the longitudinal direction of the reflective plate 15 is in the parabolic shape, and the center of heat generation in the heat generator 2 serving as the heat radiation source is arranged at the position of the focal point of the reflective plate 15. Accordingly, in the heating apparatus according to the present invention, the radiation heat from the heat generator 2 is reflected by the reflective plate 15, and the efficient heat radiation can be achieved.

As is described as one example in the heating apparatus according to embodiment 4 mentioned above, in the case where the heat generation unit according to the present invention is set to the heat source of the electronic apparatus such as the copying machine, the structure is made such that it is possible to efficiently heat the portion where the inserted paper 21 comes into contact with the toner fixing roller 18, by using the tube body covering the heat generation unit as the toner fixing roller 18.

Further, in the heating apparatus according to the present invention, it is possible to make the heat generator temperature high by structuring so as to cover at least a part of the heat generator by the heat resisting tube, and it is possible to provide the heating apparatus which can change the heating distribution.

As is described about the cooking appliance as the other example in the heating apparatus according to embodiment 4 mentioned above, by providing the heat generation unit according to the present invention as the heat source in the cooking appliance and structuring so as to cover the heat generation unit by the tube body, it is possible to prevent a foreign material, for example, meat juice, seasonings or the like generated from the object to be heated from being obstructed by the tube body so as to be prevented from directly coming into contact with the heat generation unit. Accordingly, it is possible to prevent the heat generation unit serving as the heat source from damages and disconnection due to the surface deterioration, and it is possible to provide the heating apparatus having a longer service life.

In the heat generation unit and the heating apparatus according to the present invention, there is employed the heat generator 2 constructed by the film sheet raw material which has the two-dimensional isotropic thermal conductivity while having the carbon-based substance as the main component, has the pliability, flexibility, and elasticity, and has the heat conduction equal to or more than 200 W/m·K and the thickness equal to or less than 300 μm. The heat generator 2 has a high and excellent characteristic in which radiation efficiency is equal to or more than 80%, and it is possible to achieve heating having high efficiency according to the heat generation unit using the heat generator 2 as the heat source.

According to the present invention, since the material of the heat generator is constructed in the sheet shape having the carbon-based substance as the component, it is possible to obtain a more efficient heater. However, it tends to be slippery in a band surface direction of the sheet-like heat generator and cannot be securely held only by pinching. However, the present invention solves this problem, and the locking through hole in the end portion of the heat generator inserted between the first holding portion and the second holding portion is inserted and engaged by the engagement portion of the fixed portion together with the respective through holes of the first holding portion and the second holding portion. Further, in the present invention, the positions in both end sides of the engagement portion of the fixed portion are provided with the first position regulating member having the first position regulating function and the second position regulating member having the second position regulating function. Therefore, according to the present invention, since the end portion of the heat generator is pinched by the first holding portion and the second holding portion, or is locked by the engagement portion of the fixed portion, a stable fixing strength can be obtained, and it is possible to provide the heat generation unit which is strong in the heat cycle and has a long service life, and the heating apparatus using the heat generation unit.

### Embodiment 5

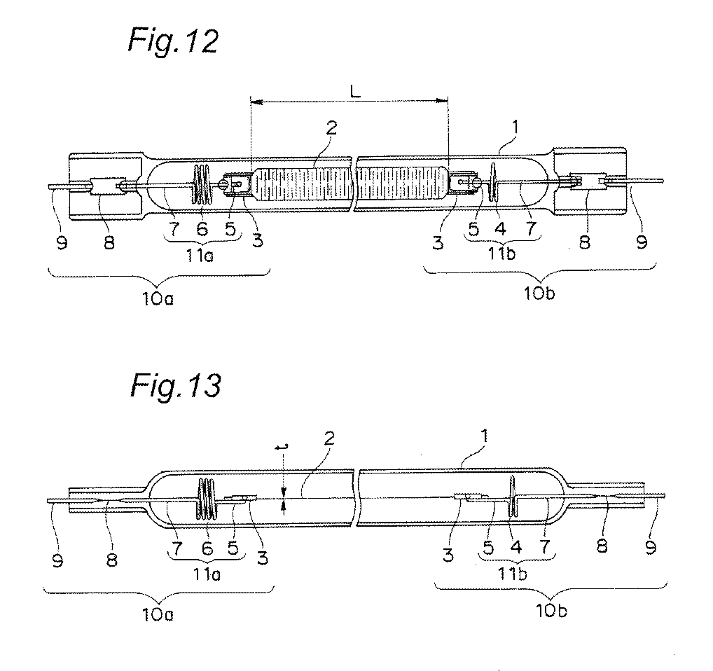

A description will be given of a heat generation unit according to embodiment 5 of the present invention with reference to FIGS. 12 to 17. FIG. 12 is a plan view showing a structure of the heat generation unit according to embodiment 5. In FIG. 12, since the heat generation unit has a long shape, an intermediate portion thereof is omitted by rupturing, and the portions near both end portions are shown. FIG. 13 is a front view of the heat generation unit shown in FIG. 12.

In the heat generation unit according to embodiment 5, the film sheet-like heat generator 2 is arranged in the inner portion of the elongated container 1 having the heat resistance. The elongated band-shaped heat generator 2 is extended along the longitudinal direction of the container 1. In the heat generation unit according to embodiment 1, the container 1 is formed by the transparent quartz glass tube, and both end portions of the quartz glass tube are deposited as a flat plate shape, whereby the container 1 is constructed. An argon gas serving as an inert gas is charged in the inner portion of the container storing the heat generator 2. The inert gas which can be charged in the inner portion of the container is not limited to the argon gas, and the same effect as the heat generation unit according to embodiment 5 can be achieved by using a nitrogen gas, or a mixed gas of the argon gas and the nitrogen gas, the argon gas and a xenon gas, the argon gas and a krypton gas, and the like, and the inert gas to be charged can be appropriately selected depending on a purpose. The inert gas is charged in the inner portion of the container 1 for preventing the heat generator 2 that is the carbon-based substance in the inner portion of the container from being oxidized when being used at a high temperature. As a material of the container 1, any material having a heat resistance, an insulating property and a heat permeability can be used, and it is possible to appropriately select from glass materials such as a soda lime glass, a borosilicate glass, a lead glass and the like, ceramic materials and the like, for example, in addition to the quartz glass.

As shown in FIGS. 12 and 13, the heat generation unit according to embodiment 5 is provided with the container 1, the elongated band-shaped heat generator 2 serving as a heat radiation membrane body, and first and second power supply portions 10a and 10b provided in both end portions in the longitudinal direction of the heat generator 2 for holding the heat generator 2 at a predetermined position within the container, and provided for supplying power to the heat generator 2.

The first and second power supply portions 10a and 10b provided in the both ends of the heat generator 2 include the holders 3 attached to the both ends of the heat generator 2. In the holder 3, a first internal lead wire portion 11a is attached to the one holder 3 (the left holder 3 in FIG. 12), and a second internal lead wire portion 11b is attached to the other holder 3 (the right holder 3 in FIG. 12). Each of the first internal lead wire portion 11a and the second internal lead wire portion 11b is electrically connected to the external lead wire 9 derived from both ends of the container 1 to the outside of the container, via the molybdenum foil 8 embedded in a sealed portion (a deposited portion) of the both end portions of the container 1.

As shown in FIGS. 12 and 13, the first power supply portion 10a is structured so as to have the holder 3, the first internal lead wire portion 11a, the molybdenum foil 8, and the external lead wire 9. On the other hand, the second power supply portion 10b is structured so as to have the holder 3, the second internal lead wire portion 11b, the molybdenum foil 8 and the external lead wire 9.

The first internal lead wire portion 11a is constructed by the fixed portion 5 connected to one end (a left end in FIG. 12) of the heat generator 2 to which the holder 3 is installed, the spring portion 6 formed spirally and having elasticity in a longitudinal direction, and the internal lead wire 7 connected to the molybdenum foil 8, and the fixed portion 5, the spring portion 6 and the internal lead wire 7 are integrally formed by one wire rod, for example, the molybdenum wire.

Further, the second internal lead wire portion 11b is constructed by the fixed portion 5 connected to the other end (a right end in FIG. 12) of the heat generator 2 to which the holder 3 is installed, the position regulating portion 4 for holding the heat generator 2 at a predetermined position within the container, and the internal lead wire 7 connected to the molybdenum foil 8, and the fixed portion 5, the position regulating portion 4 and the internal lead wire 7 are integrally formed by one wire rod, for example, the molybdenum wire.

The first internal lead wire portion 11a and the second internal lead wire portion 11b according to embodiment 5 will be described with the example formed by the molybdenum wire, however, the internal lead wire portions may be formed by using a metal wire (having a round rod shape or a flat plate shape) made of tungsten, nickel, stainless steel or the like and having elasticity. Further, the first internal lead wire portion 11a and the second internal lead wire portion 11b according to embodiment 5 will be described by the example in which each of the internal lead wire portions is constructed by an integral wire rod, however, the internal lead wire portions may be constructed by being formed respectively by independent members in a functionally different manner, and bonded to each other.

As mentioned above, in the heat generation unit according to embodiment 5, the heat generator 2 is provided in a tension manner within the container by the first power supply portion 10a constructed by the holder 3, the molybdenum foil 8, the external lead wire 9 and the first internal lead wire portion 11a, and the second power supply portion 10b constructed by the holder 3, the molybdenum foil 8, the external lead wire 9 and the second internal lead wire portion 11b.

The spring portion 6 in the first internal lead wire portion 11a is structured so as to apply a tensile force to the heat generator 2, and is structured such that the heat generator is always arranged linearly at a desired position within the container. In the heat generation unit according to embodiment 5, the spring portion 6 also has a function serving as the position regulating member for arranging the heat generator 2 at a predetermined position within the container. Since the outer peripheral portion of the spring portion 6 is at a position close to the inner peripheral surface of the container 1, by providing the spring portion 6, the heat generator 2 is securely arranged at a position where it does not come into contact with the container 1. In the heat generation unit according to embodiment 5, the heat generator 2 is arranged on an approximately center axis extending in the longitudinal direction of the container 1, and is arranged so as not to come into contact with the container 1. Further, it is possible to absorb the change caused by the expansion and contraction in the heat generator 2 by providing the spring portion 6 between the internal lead wire 7 and the fixed portion 5.

In the case where an expansion ratio which the material itself of the heat generator 2 has, or an expansion ratio caused by the shape, of the heat generator 2 is larger than the change caused by the expansion and contraction in the heat generator 2, it is not necessary that the spring portion 6 is provided in the respective internal lead wire portions 11a and 11b in the both sides of the heat generator 2.

In the heat generation unit according to embodiment 5, the description is given of the example in which the both ends of the heat generator 2 are provided with the first internal lead wire portion 11a and the second internal lead wire portion 11b having different structures, however, in the heat generation unit according to the present invention, the similar structural members to the first internal lead wire portion 11a or to the second internal lead wire portion 11b may be arranged in the both ends of the heat generator 2. Which structural member is to be used is appropriately decided in correspondence to a product specification and an intended use of the heating apparatus in which the heat generation unit is used. In the structure in which the first internal lead wire portion 11a having the spring portion 6 is arranged in either one of the end sides of the heat generator 2, it is possible to absorb the change caused by the position regulation and the expansion and contraction of the heat generator 2. However, according to the structure in which the first internal lead wire portion 11a is arranged in the both sides of the heat generator 2, there is obtained such a structure that the position regulation and the change absorption can be achieved in the both end sides of the heat generator 2, so that it is possible to expect a further effect.

In the case where the heat generation unit is embedded in the heating apparatus in such a manner that the longitudinal direction of the heat generation unit according to embodiment 5 comes to the vertical direction, if the spring portion 6 is arranged above the heat generator 2, the spring portion 6 is expanded by the temperature of the heat generator 2 and heated, and there is a risk that the thermal expansion cannot be absorbed exceeding an elastic limit. Accordingly, it is preferable to use in a state of arranging the spring portion 6 below the heat generator 2 so as to be compressed.

In the heat generation unit according to embodiment 5, the description is given of the example in which the fixed portion 5 of the first internal lead wire portion 11a, the spring portion 6 and the internal lead wire 7, and the fixed portion 5 of the second internal lead wire portion 11b, the position regulating portion 4 and the internal lead wire 7 are integrally constructed, respectively. However, it goes without saying that the same effect can be obtained by constructing the portions having the different functions by different members, and electrically connecting the members.

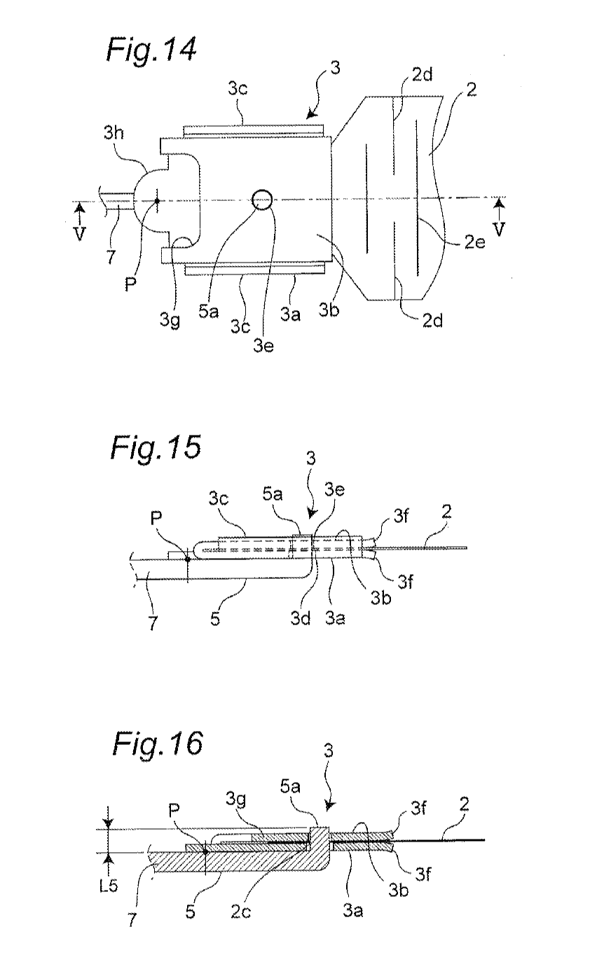

FIGS. 14 to 16 are views showing the holder 3 and the fixed portion 5 which are installed to the both end portions of the heat generator 2 in the heat generation unit according to embodiment 5. FIG. 14 is a plan view of the holder 3 and the like, FIG. 15 is a front view of the holder 3 and the like, and FIG. 16 is a cross sectional view along line V-V in FIG. 19.

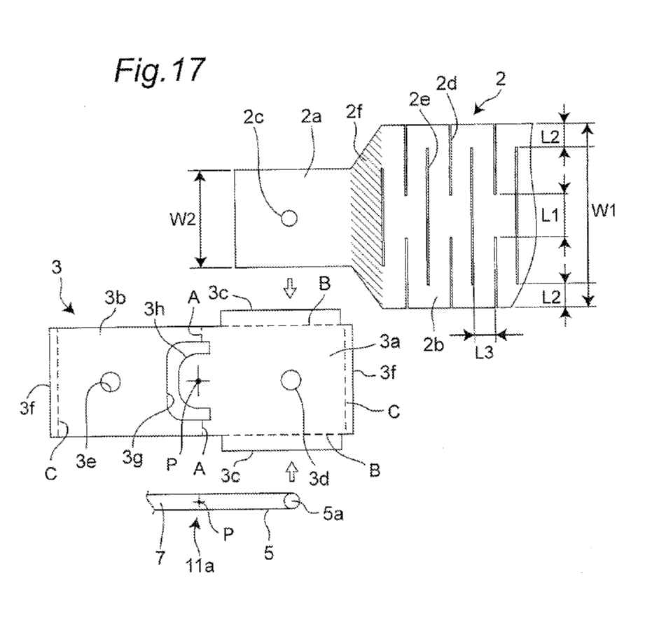

In FIG. 17, there is shown a view in which the holder 3 manufactured by being bent is expanded, in the center thereof, and there is shown the heat generator 2 (an upper side of the holder 3 in FIG. 17) installed to the holder 3, and the fixed portion 5 (a lower side of the holder 3 in FIG. 17) of the first internal lead wire portion 11a to which the heat generator 2 is retained, in addition to the expanded holder 3.

The holder 3 used in the heat generation unit according to embodiment 5 is constructed by folding a metal material having a conductivity, for example, a flat plate material formed by molybdenum. As shown in FIGS. 14 to 17, a heat generator holding portion 2a (refer to FIG. 17) that is an end portion of the heat generator 2 is arranged so as to be pinched between the folded holding portions 3, and the heat generator holding portion 2a of the heat generator 2 is structured so as to be engaged with a retainer portion 5a that is the L-shaped bent protruding end portion of the fixed portion 5. Further, the holder 3 is spot welded to the fixed portion 5 so as to be fixed. In the heat generation unit according to embodiment 5, one position on the center axis which is in parallel to the longitudinal direction of the heat generator 2 is spot welded.

A description will be given below in detail of a structure of the holder 3 with reference to the view of the expanded holder shown in the center portion of FIG. 17. The holder 3 is folded approximately at 180 degrees at a position of a broken line A (refer to FIG. 17) in the expanded holder 3. Further, an end portion side is folded approximately at 90 degrees in the same direction as the folded direction at the position of the broken line A, at two positions of a broken line B (refer to FIG. 17) of the expanded holder 3. As a result, in the holder 3, there are formed a first holding portion 3a (a lower flat portion in the holder 3 shown in FIG. 15) for pinching the heat generator holding portion 2a that is an end portion of the heat generator 2, a second holding portion 3b (an upper flat portion in the holder 3 shown in FIG. 15), and two side wall portions 3c and 3c rising up from opposed sides (upper and lower positions of the first holding portion 3a in the holder 3 shown in FIG. 14) which are in parallel to the longitudinal direction of the heat generator 2 in the first holding portion 3a.

The bent position at approximately 180 degrees of the broken line A in the expanded holder 3 shown in FIG. 17 is set to a direction which is orthogonal to a rolling direction (a so-called direction of roll marks) at the time of rolling the molybdenum plate that is the metal material of the holder 3. In accordance with the above setting, it is possible to prevent an accident such as a crack, a rupture or the like from being generated, even by bending approximately at 180 degrees at the position of the broken line A for forming the holder 3.

Further, in the expanded holder 3 shown in FIG. 17, the opposed surface in the end portion side are curved in a direction that they get away from each other at the position of the broken line C existing in a side where the heat generator 2 in the first holding portion 3a and the second holding portion 3b is derived, and derived portions 3f and 3f are formed. By forming the curved derived portions 3f and 3f as mentioned above, it is possible to prevent the derived end portion of the heat generator 2 installed to the holder 3 from being damaged by coming into contact with the holder 3. These derived portions 3f and 3f have a function serving as a fracture preventing portion. Further, it is possible to enhance the strength of the holder 3 in such a manner as to stand the oscillation, the thermal expansion and contraction cycle and the thermal stress in the heat generator 2, by curving the derived portions 3f and 3f of the holder 3. In this case, in embodiment 5, the description is given of the example in which the derived portions 3f and 3f are constructed by the curved surface, however, the derived portions 3f and 3f may be constructed by an inclined surface, and may be constructed by any shape as long as the end portion deriving the heat generator 2 in the holder 3 is expanded, and does not come into contact with the heat generator 2. The inclined surface shape of the derived portions 3f and 3f can be worked by setting a protruding direction of the burr generated at the time of the press work to a direction getting away from the heat generator 2 so as to be used, or may be formed in accordance with a grinding work.

As shown in FIG. 17, in the holder 3, a first engagement hole 3d as a through hole is formed in the first holding portion 3a, and a second engagement hole 3e as a through hole is formed in the second holding portion 3b. Further, an approximately circular arc-shaped notch 3g is formed in the bent portion shown by the broken line A in approximately the center portion of the expanded holder 3 shown in FIG. 17. A semicircular tongue portion 3h extended from the first holding portion 3a is formed by forming the notch 3g. In the holder 3 constructed by being bent as mentioned above, the first engagement hole 3d formed in the first holding portion 3a and the second engagement hole 3e formed in the second holding portion 3b come to corresponding positions, and the holder 3 is structured so as to have the through hole approximately in the center portion thereof.

The heat generator holding portion 2a that is the end portion of the heat generator 2 is pinched by the first holding portion 3a and the second holding portion 3b of the holder 3 constructed as mentioned above, and a retainer receiving portion 2c as a through hole is formed at a position corresponding to the through hole of the holder 3. As a result, in the holder 3 in a state of pinching the heat generator holding portion 2a, there is obtained a state where the through hole is formed approximately in the center portion thereof. In the state mentioned above, the retainer receiving portion 2c as the through hole formed in the heat generator holding portion 2a existing in the both ends of the heat generator 2 is retained to the retainer portion 5a that is the end portion of the fixed portion 5, and the heat generator 2 is provided in a tension manner at a predetermined position within the container.

As shown in FIG. 17, the heat generator 2 has, a heat generator holding portion 2a which is held by the holder 3, a heat generating portion 2b in which a groove pattern having a plurality of grooves orthogonal to the longitudinal direction is formed and a meandering current path is formed so as to generate heat, and a heat dissipation portion 2f that is a region between the heat generator holding portion 2a and the holding portion 2b. As mentioned above, the retainer receiving portion 2c as the through hole formed in the heat generator holding portion 2a is arranged at positions corresponding to the first engagement hole 3d of the first holding portion 3a and the second engagement hole 3e of the second holding portion 3b in a state where the heat generator holding portion 2a is pinched by the first holding portion 3a and the second holding portion 3b. As a result, the through hole is formed approximately in the center portion of the holder 3 in a state of pinching the heat generator 2, and respective diameters of the first engagement hole 3d, the second engagement hole 3e and the retainer receiving portion 2c constructing this through hole have the following relationship.

The diameter of the first engagement hole 3d is larger than the diameter of the second engagement hole 3e, and the diameter of the retainer receiving portion 2c of the heat generator 2 is formed equal or smaller than the diameter of the second engagement hole 3e (diameter of first engagement hole 3d>diameter of second engagement hole 3e≧diameter of retainer receiving portion 2c of heat generator 2).

As shown in FIGS. 15 and 16, the retainer portion 5a that is the end portion of the fixed portion 5 integrally formed with the internal lead wire 7 by the wire rod is formed so as to be bent in a direction which is approximately orthogonal to the extending direction (the longitudinal direction of the heat generator 2) connected to the fixed portion 5 from the internal lead wire 7. Accordingly, the fixed portion 5 has an L-shaped form having a bent leading end. The retainer portion 5a of the fixed portion 5 is formed in such a manner that a diameter thereof is smaller than the diameters of the first engagement hole 3d and the second engagement hole 3e formed in the holder 3 mentioned above, and is formed in such a manner that it is somewhat smaller than the diameter of the retainer receiving portion 2c of the heat generator 2. Therefore, in the heat generation unit according to embodiment 5, the structure is made such that the retainer portion 5a of the fixed portion 5 passes through the holder 3 pinching the heat generator 2 and engages with the retainer receiving portion 2c of the heat generator holding portion 2a (diameter of first engagement hole 3d>diameter of second engagement hole 3e≧diameter of retainer receiving portion 2c of heat generator 2>diameter of retainer portion 5a of fixed portion 5).

The protruding length (a length denoted by reference symbol L5 in FIG. 16) of the retainer portion 5a of the fixed portion 5 is set to be at least longer than a length obtained by adding thicknesses of the first holding portion 3a and the second holding portion 3b in the holder 3, and a thickness of the heat generator 2, and is set to a length by which the retainer portion 5a securely engages with the retainer receiving portion 2c of the heat generator holding portion 2 existing between the first holding portion 3a and the second holding portion 3b.

As mentioned above, since the diameter of the first engagement hole 3d is formed larger than the diameter of the second engagement hole 3e, in the state where the retainer portion 5a of the bent fixed portion 5 is engaged with the retainer receiving portion 2c of the heat generator 2, a part of the bent portion (a so-called round portion) close to the base end side in the retainer portion 5a is arranged in the inner portion of the first engagement hole 3d. As a result, the retainer portion 5a of the fixed portion 5 with a short protruding length (L5) securely passes through the first engagement hole 3d of the first holding portion 3a, the retainer receiving portion 2c of the heat generator 2, and the second engagement hole 3e of the second holding portion 3b, and comes to a secure contact state where the fixed portion 5 and the first holding portion 3a do not shake.

In the heat generation unit according to embodiment 5, the retainer portion 5a of the fixed portion 5 and the heat generator 2 are in the retained engagement state as mentioned above, and the retainer portion 5a and the first engagement hole 3d and the second engagement hole 3e of the holder 3 are in the locked state where they pass through. The first holding portion 3a and the second holding portion 3b of the holder 3 come into surface contact with the heat generator holding portion 2a of the heat generator 2, and the heat generator 2 and the holder 3 are in an electric connected state having a reduced resistance. Further, in order to secure an electric connecting state and a mechanical connecting state between the holder 3 and the fixed portion 5, a tongue portion 3h of the holder 3 and the fixed portion 5 are firmly attached by a spot welding at least at one position. In FIGS. 14 to 16, a position denoted by reference symbol P is a spot weld position. The spot weld position exists on a center axis which is in parallel to the longitudinal direction of the heat generator 2, in the same manner as the engagement position between the heat generator 2 and the retainer portion 5a. As mentioned above, the fixed portion 5 is fixed to the holding portion 3, and the fixed portion 5 comes to a state of being securely brought into contact with the holder 3 without floating. Further, since the holder 3 and the fixed portion 5 are fixed as mentioned above, it is possible to prevent the holder 3 from rotating, twisting and straining.

In the description mentioned above, the description is given of the fixing method between one end portion of the heat generator 2 and the first power supply portion 10a, however, the other end portion of the heat generator 2 and the second power supply portion 10b are fixed by the same fixing method in the heat generation unit according to embodiment 5. Accordingly, the description of the fixing method of the other end portion of the heat generator 2 and the second power supply portion 10b will not be given.

In the heat generation unit according to embodiment 5, the description is given of the structure in which the flat surface portion of the holder 3 pinches the heat generator holding portion 2a of the heat generator 2, however, the structure may be made such that the heat generator holding portion 2a is pinched by forming the flat surface portion of the holder 3 as a curved surface or a concavo-convex surface so as to enhance the pinching force.

Further, the holder 3 in the heat generation unit according to embodiment 5 is described by the example in which the first holding portion 3a and the second holding portion 3b are formed by one plate member, however, the first holding portion 3a and the second holding portion 3b may be structured so as to be formed by independent members and be bonded to each other, and may be structured such that they pinch the heat generator holding portion 2a of the heat generator 2 and an electric connecting state is secured.

The heat generator 2 used in the heat generation unit according to embodiment 5 of the present invention is a laminated structure firmly attached partly in such a manner that the carbon-based substance is the main component and the respective layers form an interval with each other in the thickness direction, has an excellent two-dimensional isotropic thermal conductivity, and is formed by a film sheet-like material having a coefficient of thermal conductivity equal to or more than 200 W/m·K. Accordingly, the band-like heat generator 2 becomes a heat source uniformly generating heat without any temperature unevenness.

The film sheet raw material that is the material of the heat generator 2 is a high orientation graphite film sheet formed as a graphite by heat treating a high polymer film or a high polymer film to which a filler is added under an ambient atmosphere at a high temperature, for example, 2400° C. or more so as to sinter, and having a heat resistance, has a coefficient of thermal conductivity in a surface direction equal to or more than 200 W/m·K, and has a characteristic from 600 to 950 W/m·K. As mentioned above, the heat generator 2 used in embodiment 5 has an excellent two-dimensional isotropic thermal conductivity in which the coefficient of thermal conductivity in the surface direction is between 600 and 950 W/m·K.

The two-dimensional isotropic thermal conductivity means that the coefficients of thermal conductivity in all the directions are approximately identical, in the surfaces set by the orthogonal X-axis and Y-axis, as described in embodiment 1 mentioned above. Accordingly, the two-dimensional isotropic property in the present invention does not only indicate one direction (the X-axis direction) which is a carbon fiber direction in the heat generator, for example, formed by arranging the carbon fibers in line in the same direction, or two directions (the X-axis direction and the Y-axis direction) which are the carbon fiber directions in the heat generator formed by weaving the carbon fibers in cross pattern, but also means that the same nature is provided in the surface direction in the film sheet-like heat generator 2.

The film sheet raw material that is the material of the heat generator 2 used in the present invention has the laminated structure, a layer surface in the surface direction has various surface shapes such as a flat surface, a concavo-convex surface, a wavy surface and the like, and an interval is formed between the opposed layers. In the laminated structure of the film sheet raw material, an image of a formed state of the intervals formed between the layers is similar to a cross sectional shape of a pie obtained by forming a pie sheet by folding so as to overlay a plurality of times (for example, some tens or some hundreds) and baking the pie sheet. In other words, the heat generator 2 is the film sheet raw material having an interlayer structure in which a plurality of membrane bodies formed by a material including the carbon-based substance are laminated and the laminating direction is partly firmly attached, and having flexibility in the thickness direction. Accordingly, the film sheet raw material that is the material of the heat generator 2 in the present invention is a material having an excellent two-dimensional isotropic thermal conductivity in which the coefficients of thermal conductivity in the surface direction are approximately identical.

The high polymer film used as the film sheet raw material manufactured as mentioned above may be at least one kind of high polymer film selected from the group consisting of polyoxadiazole, polybenzothiazole, polybenzobisthiazole, polybenzooxazole, polybenzobisoxazole, polypyromelliticimide (pyromellitic imide), polyphenylene isophthalic amide (phenylene isophthalic amide), polyphenylene benzoimidazole (phenylene benzoimidazole), polyphenylene benzobisimidazole (phenylene benzobisimidazole), polythiazole and polyparaphenylenevinylene, as described in embodiment 1 mentioned above. Further, the filler to be added to the high polymer film include: phosphoric acid ester-based, calcium phosphate-based, polester-based, epoxy-based, stearic acid-based, trimellitic acid-based, metal oxide-based, organic tin-based, lead-based, azo-based, nitroso-based and solfonylhydrazide-based compounds. More specifically, examples of phosphoric acid ester-based compounds include: tricresylphosphate, (trisisopropylphenyl)phosphate, tributyl phosphate, triethyl phosphate, trisdichloropropyl phosphate and trisbutoxyethyl phosphate. Examples of calcium phosphate-based compounds include: calcium dihydrogen phosphate, calcium hydrogen phosphorous and calcium triphosphate. Examples of polyester-based compounds include: adipic acid, azelaic acid, sebacic acid, phthalic acid, polymers obtained by a reaction with glycols, glycerins, and the like. Further, examples of stearic acid-based compounds include: dioctyl sebacate, dibutyl sebacate, andacetyltributyl citrate. Examples of metal oxide-based compounds include: calcium oxide, magnesium oxide and lead oxide. Examples of trimellitic acid-based compounds include: dibutyl fumarate and diethyl phthalate. Examples of lead-based compounds include: lead stearate and lead silicate. Examples of azo-based compounds include: azodicarboxylic amide and azobisisobutylonitrile. Examples of nitroso-based compounds include: nitrosopentamethylene tetramine. Examples of solfonylhydrazide-based compounds include: p-toluenesulfonyl hydrazide.

The film sheet-like heat generator is manufactured by laminating the film sheet raw material, processing at 2400° C. or higher under the inert gas and regulating the pressure of the gas treatment atmosphere generated in the process of forming graphite so as to control. Further, as necessary, it is possible to obtain a higher quality film sheet-like heat generator by rolling the film sheet-like heat generator manufactured as mentioned above. The film sheet-like heat generator manufactured as mentioned above is used as the heat generator 2 in the heat generation unit according to the present invention.

An adding amount of the filler is preferably in a range between 0.2 and 20.0% by weight, and is more preferably in a range between 1.0 and 10.0% by weight. An optimum adding amount varies in accordance with the thickness of the high polymer. In the case where the thickness of the high polymer is thin, the more adding amount is better, and in the case where the thickness of the high polymer is thick, the adding amount can be made less. A role of the filler exists in setting the heat treated film to a uniformly foamed state. In other words, the added filler generates the gas during heating, and is structured such that a cavity after the gas generation becomes a path so as to assist gentle passage of the cracked gas from the inner portion of the film. The filler serves for creating the uniform foamed state.

The film sheet raw material manufactured as mentioned above is worked into a desired shape by a trimming die such as a Thomson die and a Pinnacle die, a sharp-edged tool such as a rotary die cutter or the like, or a laser processing or the like.

In the heat generator 2 according to embodiment 5, the thickness (t) is 100 μm, the width (W1) of the heat generating portion 2b is 6.0 mm (refer to FIG. 17), the width (W2) of the heat generator holding portion 2a is about 5.0 mm (refer to FIG. 17), and the length (L) of the heat generating portion 2b is 300 mm (refer to FIG. 12). The length, the width and the thickness of the heat generator 2 are decided based on the input voltage and the heat generation temperature, and can be appropriately changed in correspondence to the product specification and the intended use as the heat source in which the heat generation unit is used.

As shown in FIG. 17, a groove pattern in which a plurality of grooves (notches) are extended in an orthogonal direction to the longitudinal direction of the heat generator 2 is formed in the heat generating portion 2b of the heat generator 2 according to embodiment 5. A plurality of grooves formed in the heat generating portion 2b are structured so as to regulate a flow direction of the current in the heat generating portion 2b and regulate a resistance value. As the groove shape formed in the heat generating portion 2b, there are a slit penetrating in correspondence to the product specification and the intended use in which the heat generation unit is used, a closed-end groove (a concave groove) and the like. Further, in the concave groove, it is possible to regulate the resistance value of the heat generating portion 2b by changing a depth in a thickness direction.

The groove pattern shown in FIG. 17 is repeatedly formed in the heat generating portion 2b of the heat generator 2 according to embodiment 5. In other words, in the heat generating portion 2b of the heat generator 2, there are formed an end groove 2d extending from opposed positions of both side edge portions which are in parallel to the longitudinal direction to the center side so as to be orthogonal to the longitudinal direction, and a center groove 2e formed in the center portion of the heat generating portion 2b so as to be orthogonal to the longitudinal direction. The opposed end portions in the center sides of the opposed end grooves 2d and 2d in the heat generating portion 2b have a first predetermined distance (a distance denoted by reference symbol L1 in FIG. 17), and a current-carrying path is formed in the center portion of the heat generating portion 2b. Further, edge side end portions corresponding to both end portions of the center groove 2e have an equal second predetermined distance (a distance shown by reference symbol L2 in FIG. 17) from an edge portion in a width direction of the heat generating portion 2b, and current carrying paths are formed near both side edge portions of the heat generating portion 2b. Further, in the heat generating portion 2b of the heat generator 2, a distance in a longitudinal direction between the end groove 2d and the center groove 2e has a third predetermined distance (a distance denoted by reference symbol L3 in FIG. 17), and a current path flowing in the direction which is orthogonal to the longitudinal direction of the heat generator 2 is formed between the end groove 2d and the center groove 2e.

In the heat generator 2 according to embodiment 5, the third predetermined distance L3 that is the distance in the longitudinal direction between the end groove 2d and the center groove 2e is set to the same distance as the second predetermined distance L2, and the first predetermined distance L1 is set to twice as large as the second predetermined distance L2 and the third predetermined distance L3. In the heat generating portion 2b of the heat generator 2 in which the groove pattern is formed as mentioned above, a meandering current path is formed, a cross sectional area which is orthogonal to the current flow is approximately equal, it is easy to calculate the resistance value, and it is possible to form a uniform temperature distribution. It should be noted that as long as the material has such a characteristic that the coefficient of thermal conductivity in the surface direction of the heat generator 2 is 600 W/m·K or more, for example, the uniform temperature distribution (the heat arrangement distribution) is not largely affected even if the second predetermined distance L2 is not ½ of the first predetermined distance L1. Preferably, it is possible to enhance a mechanical strength of the heat generator 2 with respect to the shock applied to the heat generation unit, by setting the second predetermined distance L2 equal to or more than ½ of the first predetermined distance L1.

Further, it is possible to set the temperature distribution (the heat arrangement pattern) of the heat generating portion 2b to a desired pattern, by appropriately selecting the groove-shaped slit and the concave groove formed in the heat generating portion 2b in correspondence to the product specification and the intended use in which the heat generation unit is used.

Further, it is possible to gradually change a specific resistance of the current path in the heat generating portion 2b by gradually expanding the distance L3 in the longitudinal direction between the end groove 2d and the center groove 2e in accordance with coming close to the end portion in the longitudinal direction of the heat generator 2, that is, the heat generator holding portion 2a, in the heat generating portion 2b, thereby changing the temperature distribution (the heat arrangement pattern) of the heat generating portion 2b in such a manner that the center portion is higher in heat. Needless to say, it is possible to obtain a heat source having a desired heat arrangement pattern by appropriately changing the distances L1, L2 and L3 mentioned above in correspondence to the product specification and the intended use in which the heat generation unit is used.

The heat generator 2 according to embodiment 5 is formed in such a manner that the width (W2) of the heat generator holding portion 2a is narrower than the width (W1) of the heat generating portion 2b. Further, a region connected from the heat generator holding portion 2a to the heat generating portion 2b is formed so as to be gradually expanded, and the heat dissipation portion 2f having the heat dissipation function is formed in this region. The groove as mentioned above is not formed in this heat dissipation portion 2f, and the wide current path is formed. As a result, in the heat dissipation portion 2f, the heat conducted from the heat generating portion 2b is dissipated, and a reduction of the thermal stress in the heat generator 2 and a long service life are achieved. It is preferable that an edge shape of the heat dissipation portion 2f connected from the heat generator holding portion 2a to the heat generating portion 2b is constructed by a curved shape for preventing a breakage, due to a concentrated load application.

Further, in the case where the temperature of the heat generating portion 2b is high based on the product specification, it is possible to set a temperature gradient in the heat dissipation portion 2f so as to reduce the thermal stress to the heat generator holding portion 2a, by gradually narrowing the width in the heat dissipation portion 2f from the heat generating portion 2b to the heat generator holding portion 2a.

Further, in the heat generator 2, it is possible to obtain a structure having a strong mechanical strength and having a shock resistance and a vibration proof as well as a temperature gradient can be provided in the heat generating portion 2b, by gradually making the lengths of the first predetermined distance L1 and the second predetermined distance L2 longer in accordance with coming close to the heat generator holding portions 2a in both sides.

In the heat generator 2 constructed as mentioned above, since the groove pattern having a plurality of grooves obstructing the current flow is formed in the heat generating portion 2b, it is possible to set a predetermined current path without being regulated by a whole shape of the heat generating portion 2b. As a result, in the heat generation unit according to embodiment 5, it is possible to set a desired heat generation distribution in correspondence to the product specification and the intended use, and it is possible to utilize as the heat source in various fields.

The heat generator 2 in the heat generation unit according to embodiment 5 is formed in the band shape by press molding so as to form the groove, however, may be worked into a desired shape by using laser. For example, if the coefficient of thermal conductivity in the surface direction of the heat generator 2 becomes equal to or more than 200 W/m·K, as one example of the laser processing, the heat is absorbed by the heat generator 2 in the case of using the laser processing mainly having a thermal processing operation such as CO, laser (a wavelength 10600 nm) or the like, and there is a problem that it is impossible to work. However, it is possible to work a desired shape with high precision by using a laser processing having a wavelength between 1064 and 380 nm mainly having a non-thermal processing operation, for example, a short wavelength laser processing having a nominal wavelength of 1064 nm.

Particularly, the inventors confirm that in the case of forming the heat generator 2 according to embodiment 5, it is possible to work with high precision by using a second harmonic laser processing having a nominal wavelength of 532 nm. The material of the heat generator 2 according to embodiment 5 is the film sheet raw material, which uses the high orientation graphite film sheet having the heat resistance and formed as the graphite by heat treating the high polymer film or the high polymer film adding the filler thereto under the ambient atmosphere at the high temperature, for example, 2400° C. or higher, and sintering, as the material. Further, the heat generator 2 is formed by the material having the characteristic that the coefficient of thermal conductivity in the surface direction is between 600 and 950 W/m·K. In the case where the heat generator in which the thickness (t) is 100 μm, the width (W1) is 6.0 mm, and the length (L) is 300 mm is worked from such a material, or in the case where the complicated shape such as the groove (the slit) or the like is worked in the heat generating portion 2b as mentioned above, it is desirable to use the second harmonic laser processing having the nominal wavelength of 532 nm.

It goes without saying that the preferred laser processing method can be appropriately selected from the processing method having the laser processing wavelength (1064 to 380 nm) mainly having the non-thermal processing operation mentioned above, in accordance with the material of the heat generator 2, that is, the coefficient of thermal conductivity in the surface direction and the shape. Further, the laser processing method for processing the heat generator 2 described above may be employed in the processing of the heat generator of the heat generation unit according to the other embodiments mentioned below.

As mentioned above, in the heat generation unit according to embodiment 5, both end portions of the band-like heat generator 2 are securely engaged with the power supply portions 10a and 10b having the simple structure, and the electric connection state of the heat generator 2 is kept at the predetermined position within the container. As mentioned above, in the heat generation unit according to embodiment 5, since the heat generator 2 is securely held at the predetermined position within the container by the power supply portions 10a and 10b, safety and reliability are high, and it is possible to construct a heat source having high efficiency. Further, since the heat generation unit according to embodiment 5 has a simple structure, it is possible to provide the heat source having high working efficiency and an excellent productivity.

### Embodiment 6

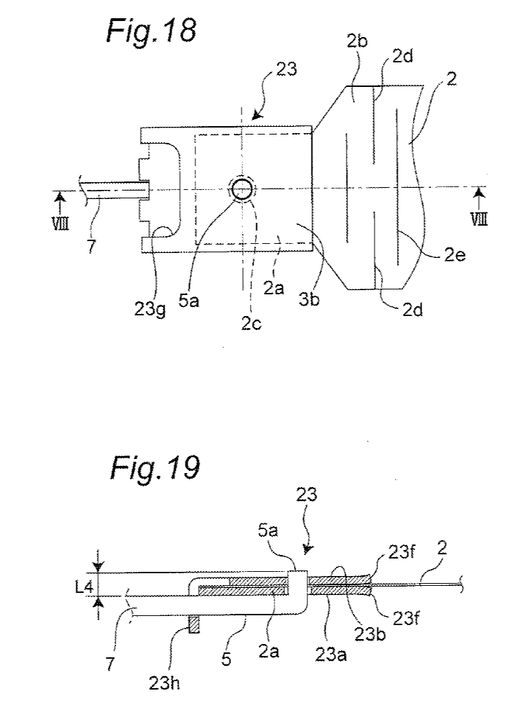

A description will be given below of a heat generation unit according to embodiment 6 of the present invention with reference to FIGS. 18 to 21. In the heat generation unit according to embodiment 6, a point different from the heat generation unit according to embodiment 5 mentioned above exists in a structure of a holder 23 attached to the both ends of the heat generator 2. Since the structures other than the holder in the heat generation unit according to embodiment 6 are the same as the heat generation unit according to embodiment 5, a description will be given below in detail of the structure of the holder 23 in the heat generation unit according to embodiment 6. In the heat generation unit according to embodiment 6, the same reference numerals are attached to the elements having the same functions and structures as the heat generation unit according to embodiment 5, and the description of embodiment 5 is applied to the description of those elements.

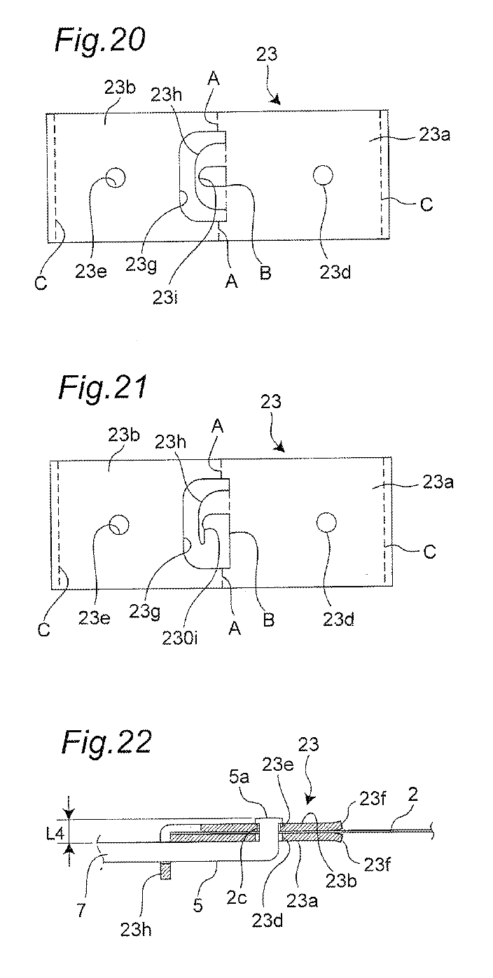

FIG. 18 is a plan view showing the heat generator 2 in the heat generation unit according to embodiment 6, the retainer portion 5a of the fixed portion 5 retained to the heat generator holding portion 2a that is the end portion of heat generator 2, the holder 23 attached in such a manner as to pinch the heat generator holding portion 2a, and the like. FIG. 19 is a cross sectional view along line VIII-VIII of the holder 23 shown in FIG. 18. FIG. 20 is an expanded view of the holder 23 according to embodiment 6.

The holder 23 used in the heat generation unit according to embodiment 6 is formed by folding a flat plate material formed by a metal material, for example, molybdenum having a conductivity in the same manner as the holder 3 according to embodiment 5. As shown in FIGS. 18 and 19, the heat generator holding portion 2a that is the end portion of the heat generator 2 is arranged in such a manner as to be pinched between a first holding portion 23a and a second holding portion 23b of the holder 23.

The holder 23 in the heat generation unit according to embodiment 6 will be described by an example in which the first holding portion 23a and the second holding portion 23b are formed by one plate member, however, the first holding portion 23a and the second holding portion 23b may be structured so as to be formed by independent members and be bonded to each other.

In the heat generation unit according to embodiment 6, the retainer receiving portion 2c as the through hole for engaging with the retainer portion 5a that is the protruding end portion bent in the L-shape of the fixed portion 5 is formed in the heat generator holding portion 2a of the heat generator 2 pinched by the first holding portion 23a and the second holding portion 23b, in the same manner as the heat generation unit according to embodiment 5.

A holding hole 23i for supporting the fixed portion 5 is formed in the holder 23 according to embodiment 6. embodiment 6 is structured such that the holding hole 23i and the fixed portion 5 are engaged, and the holder 23 is supported to the fixed portion 5. The engagement position is arranged on the center axis which is in parallel to the longitudinal direction of the heat generator 2.

A description will be given below in detail of the structure of the holder 23 with reference to an expanded view of the holder 23 shown in FIG. 20. The expanded holder 23 shown in FIG. 20 is folded approximately at 180 degrees at a position of a broken line A. Further, it is folded approximately at 90 degrees in an opposed direction to the folding direction at the position of the broken line A, at a position of a broken line B of the expanded holder 23 shown in FIG. 20. As a result, in the holder 23, there are formed a first holding portion 23a (a right flat portion of the holder 23 in FIG. 20) for pinching the heat generator holding portion 2a (refer to FIG. 17) of the heat generator 2, a second holding portion 23b (a left flat portion of the holder 23 in FIG. 20), and a tongue portion 23h folded approximately at 90 degrees (refer to FIG. 19). A first engagement hole 23d is formed in the first holding portion 23a, a second engagement hole 23e is formed in the second holding portion 23b, and a holding hole 23i is formed in the tongue portion 23h. The first engagement hole 23d and the second engagement hole 23e are formed at corresponding positions in such a manner that the retainer portion 5a of the fixed portion 5 passes through, and the retainer portion 5a can engage with the retainer receiving portion 2c of the heat generator 2, in the same manner as the first engagement hole 3d and the second engagement hole 3e in embodiment 5 mentioned above. The holding hole 23i in the tongue portion 23h is a holding hole which the fixed portion 5 passes through and supports the fixed portion 5 as mentioned below.

A bending position of the broken line A in the expanded holder 23 shown in FIG. 20 is set to a direction which is orthogonal to a rolling direction (a so-called direction of roll marks) at the time of rolling the molybdenum that is the metal material of the holder 23. According to the setting mentioned above, the holder 23 can prevent an accident such as a crack, a rupture or the like from being generated at the position of the broken line A, and can bend approximately at 180 degrees.

Further, in the holder 23 according to embodiment 6, there are formed derived portions 23f and 23f which are obtained by bending at a position of a broken line C in the first holding portion 23a and the second holding portion 23b and curving the opposed surfaces in the end portion sides in a direction getting away from each other, for the same purpose as embodiment 5. The derived portions 23f and 23f may be constructed by an inclined surface, and may be formed in such a shape that the end portion from which the heat generator 2 in the holder 23 is derived is expanded and does not come into contact with the heat generator 2.

As shown in FIG. 20, in the expanded holder 23, the first engagement hole 23d is formed in the first holder 23a, the second engagement hole 23e is formed in the second holding portion 23b, the holding hole 23i is formed in the tongue portion 23h, and the first engagement hole 23d, the second holding portion 23b and the holding hole 23i are formed on the same straight line. In the expanded holder 3 shown in FIG. 20, an opening portion 23g opened in an approximately circular arc-shape is formed in the folded portion shown by the broken line A in the approximately center portion. The semicircular tongue portion 23h extended from the first holding portion 23a is formed by forming the opening portion 23g. As mentioned above, the holding hole 23i that is the through hole is formed in the tongue portion 23h, and is folded approximately at 90 degrees at the position of the broken line C, whereby the holder 23 is formed. In the holder 23 formed by being folded as mentioned above, the first engagement hole 23d formed in the first holding portion 23a, and the second engagement hole 23e formed in the second holding portion 23b come to the corresponding positions, and the holder 23 is structured so as to have the through hole in approximately the center portion. The retainer receiving portion 2c that is the through hole of the heat generator holding portion 2a of the heat generator is arranged at the position of the through hole of the holder 23 and is pinched by the holder 23, and the retainer receiving portion 2c of the heat generator 2 is securely engaged with the retainer portion 5a of the fixed portion 5 of the internal lead wire portion 11a.

The heat generator 2 according to embodiment 6 has the same structure as the heat generator 2 according to embodiment 5, the film sheet raw material that is the material of the heat generator 2 has a laminated structure, a layer surface in the surface direction has various surface shapes such as a flat surface, a concavo-convex surface, a wavy surface and the like, and an interval is formed between the opposed layers. Accordingly, even in the heat generator 2 according to embodiment 6, there is provided an excellent two-dimensional isotropic thermal conductivity in which the coefficient of thermal conduction in the surface direction is approximately uniform.

The heat generator 2 according to embodiment 6 is structured such that the heat generator holding portions 2a (refer to FIG. 17) existing in the both ends of the heat generator 2 are pinched by the holder 23, in the same manner as the heat generator 2 according to embodiment 5. Further, a groove pattern having a plurality of grooves (notches) is formed in the heat generating portion 2b in the heat generator 2. The retainer receiving portion 2c as the through hole is formed in the heat generator holding portion 2a of the heat generator 2, the retainer receiving portion 2c comes to an engaged state by an insertion of the retainer portion 5a of the fixed portion 5, and the heat generator holding portion 2a is pinched by the holder 23, thereby achieving an electric connection state to each other. A diameter of the first engagement hole 23d is formed larger than a diameter of the second engagement hole 23e, and a diameter of the second engagement hole 23e is formed equal to or larger than a diameter of the retainer receiving portion 2c of the heat generator 2 (diameter of first engagement hole 3d>diameter of second engagement hole 3e≧diameter of retainer receiving portion 2c of heat generator 2).

FIGS. 18 and 19 are views showing a state where the fixed portion 5 of the internal lead wire portion 11a is retained to and engaged with the heat generator 2 in which the both ends are pinched by the holder 23 as mentioned above. As shown in FIGS. 18 and 19, in the retainer portion 5a of the fixed portion formed by a wire rod integrally with the internal lead wire 7, a diameter thereof is formed smaller than the diameters of the first engagement hole 23d and the second engagement hole 23e formed in the holder 23. Accordingly, the retainer portion 5a of the fixed portion 5 passes through the first engagement hole 23d and the second engagement hole 23e of the holder 23 pinching the heat generator holding portion 2a of the heat generator 2, and is securely engaged with the retainer receiving portion 2c of the heat generator 2 (diameter of first engagement hole 23d>diameter of second engagement hole 23e≧diameter of retainer receiving portion 2c of heat generator>diameter of retainer portion 5a).

A protruding length (a length denoted by reference symbol L4 in FIG. 19) of the retainer portion 5a of the fixed portion 5 is formed longer than a length obtained by adding at least the thicknesses of the first holding portion 23a and the second holding portion 23b of the holder 23, and the thickness of the heat generator 2, and is set to such a length that the retainer portion 5a passes through the first engagement hole 23d of the second holding portion 23b so as to securely engage with the retainer receiving portion 2c of the heat generator 2.

As mentioned above, the diameter of the first engagement hole 23d is formed larger than the diameter of the second engagement hole 23e, in a state where the retainer portion 5a of the bent fixed portion 5 is engaged with the retainer receiving portion 2c of the heat generator 2. Accordingly, a part of a bent portion (a so-called round portion) that is a base portion in the retainer portion 5a of the fixed portion 5 comes to a state of being arranged in an inner portion of the larger first engagement hole 23d. As a result, the fixed portion 5 securely comes into contact with the holder 23 without shaking, the protruding end portion of the retainer portion 5a of the fixed portion 5 protrudes from the second engagement hole 23e of the second holding portion 23b, and the retainer receiving portion 2c of the heat generator 2 and the retainer portion 5a come to a secure engagement state.

In the heat generation unit according to embodiment 6, the retainer portion 5a as the end portion in the fixed portion 5 is engaged with the retainer receiving portion 2c of the heat generator 2 as mentioned above, and the fixed portion 5 comes to an engaged state with the holder 23. The fixed portion 5 securely supports the holder 23, and the fixed portion 5 is structured so as to pass through the holding hole 23i formed in the tongue portion 23h of the holder 23 so as to be engaged, in such a manner as to prevent the fixed portion 5 from moving with respect to the holder 3. A diameter of the holding hole 23i is formed somewhat larger than the diameter of the wire rod of the fixed portion 5, and has such a magnitude that the fixed portion 5 does not float within the holding hole 23i. As mentioned above, the fixed portion 5 is in the engaged state with the holder 23 at two positions, however, these engagement positions exist on the center axis which is in parallel to the longitudinal direction of the heat generator 2. As mentioned above, since the fixed portion 5 is in an engaged state (a two-point fixed state) with the holder 23 in its both end portions, the fixed portion 5 comes to a state where it does not move with respect to the holder 23, but securely comes into contact with the holder 23 so as to be fixed. Since the holder 23 and the fixed portion 5 are fixed, the holder 23 is prevented from being rotated, twisted and strained. The fixed portion 5 and the holder 23 may be fixed by spot welding at least one position.

The holder 23 shown in FIG. 20 is structured so as to support the fixed portion 5 by the holding hole 23i, however, the present invention is not limited to the structure mentioned above, but includes such a structure as to form a protruding end 230i extended from a first holding portion 23a and support the fixed portion 5 by the protruding end 230i, for example, as shown in an expanded plan view of the holder 23 in FIG. 21

In the description mentioned above, the description is given of the fixing method of the holder 23 and the fixed portion 5 of the first internal lead wire portion 11a with respect to one end portion of the heat generator 2, however, since the fixing method of the holder 23 and the fixed portion 5 of the second internal lead wire portion 11b with respect to the other end portion of the heat generator 2 is fixed by the same fixing method, the fixing method will not be given here.

FIG. 22 is a cross sectional view showing another engaging method of the holder and the fixed portion with respect to the heat generator in the heat generation unit according to embodiment 6. FIG. 22 is a cross sectional view at a position corresponding to the cross sectional view in FIG. 19 mentioned above, and the structure of the holder 23 is the same. Accordingly, in the heat generation unit shown in FIG. 22, the same reference numerals are attached to the elements having the same functions and structures as the heat generation unit according to embodiment 6 shown in FIGS. 18 to 20, and the description mentioned above will be applied to a description thereof.

In the heat generation unit structured as shown in FIG. 22, fall-out preventing means (dropout preventing means) is provided in a protruding end portion of the retainer portion 5a of the fixed portion 5 passing through the through hole (the first engagement hole 23d and the second engagement hole 23e) of the holder 23 and the retainer receiving portion 2c of the heat generator 2. As shown in FIG. 22, the protruding end portion protruding from the second engagement hole 23e in the retainer portion 5a of the fixed portion 5 is in a plastically deformed state by the press working or the like. In other words, the protruding end portion from the second engagement hole 23e in the retainer portion 5a is worked into a shape larger than the diameter of the second engagement hole 23e, and the fall-out preventing means is provided. As the plastically deforming method of the protruding end portion in the retainer portion 5a, it is possible to employ a mechanical working method such as a rotational caulking work and the like, a depositing method by a heat, a current or a plasma, and the like. Further, as the other fall-out preventing means, there are a screwing method by forming a thread in the protruding end portion in the retainer portion 5a and using a nut, a locking method of installing a stop ring, for example, a C-shaped stop ring, an E-shaped stop ring or the like to the protruding end portion, and the like.

As mentioned above, in the heat generation unit according to embodiment 6, the heat generator holding portions 2a existing in the both end portions of the band-like heat generator 2 are engaged with the power supply portions 10a and 10b having the simple structure so as to be securely held at a desired position within the container, and an electric connection state is secured. Therefore, according to the heat generation unit of embodiment 6 of the present invention, it is possible to construct the heat source in which the safety and the reliability are high, and the efficiency is high, and it is possible to provide the heat generation unit having high working efficiency and an excellent productivity due to the simple structure.

### Embodiment 7

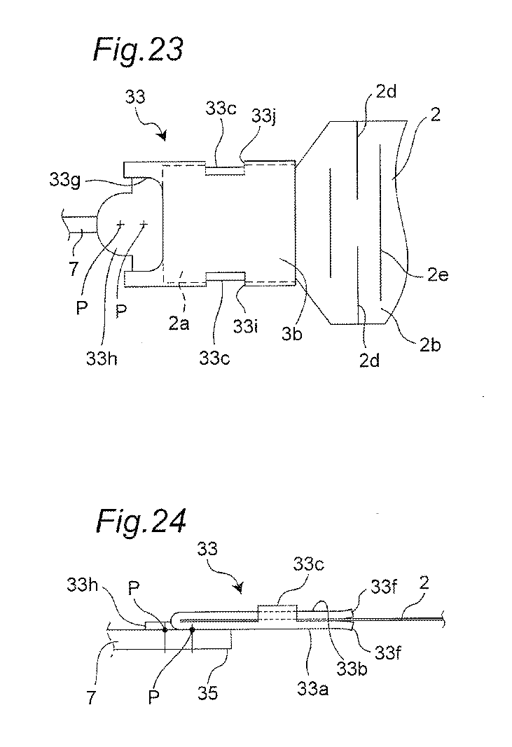

A description will be given below of a heat generation unit according to embodiment 7 of the present invention with reference to FIGS. 23 to 26. In the heat generation unit according to embodiment 7, a point different from the heat generation unit according to embodiment 5 mentioned above exists in a structure of a holder 33 and a fixed portion 35 which are attached to the both ends of the heat generator 2. Since the structures other than the holder 33 and the fixed portion 35 in the heat generation unit according to embodiment 7 are the same as the heat generation unit according to embodiment 5, a description will be given below in detail of the structures of the holder 33 and the fixed portion 35 according to embodiment 7. In the description of embodiment 7, the same reference numerals are attached to the elements having the same functions and structures as embodiment 5, and a description thereof will not be given.

FIG. 23 is a plan view showing the heat generator 2 in the heat generation unit according to embodiment 7, the holder 33 attached to the heat generator holding portion 2a that is the end portion thereof, and the like. FIG. 24 is a front view showing the holder 33 and the like attached to the heat generator 2 shown in FIG. 23.

The holder 33 used in the heat generation unit according to embodiment 7 is constructed by folding a flat plate material formed by a metal material, for example, molybdenum having a conductivity in the same manner as the holder 3 according to embodiment 5. As shown in FIGS. 23 and 24, the heat generator holding portion 2a that is the end portion of the heat generator 2 is arranged in such a manner as to be pinched between the first holding portion 33a and the second holding portion 33b of the holder 33.

The holder 33 in the heat generation unit according to embodiment 7 is described by the example in which the first holding portion 33a and the second holding portion 33b are formed by one plate material, however, the first holding portion 33a and the second holding portion 33b may be formed by independent members so as to be bonded to each other.

The fixed portion 35 formed by a wire rod integrally with the internal lead wire 7 is spot welded to the holder 33 pinching and holding the heat generator holding portion 2a of the heat generator 2. In embodiment 7, the holder 33 and the fixed portion 35 are welded at two positions near both end portions of the fixed portion 35 so as to be fixed. In FIGS. 23 and 24, a position denoted by reference symbol P is a spot welding position.

The linear fixed portion 35 formed integrally with the internal lead wire 7 is arranged on a center axis of the holder 33 so as to be fixed. In this case, the center axis of the holder 33 is an axis which is in parallel to the longitudinal direction of the heat generator 2 held by the holder 33 and passes through a gravity point of a member including the heat generator 2 and the holder 33. The holder 33 and the fixed portion 35 are spot welded, and the spot welded position is on the center axis of the holder 33.

The holder 33 according to embodiment 7 is structured, in the same manner as the holders 3 and 23 according to embodiment 5 and embodiment 6 mentioned above, such that the first holding portion 33a and the second holding portion 33b are formed by folding a flat plate member approximately at 180 degrees approximately in the center portion thereof. In the holder 33 according to embodiment 7, however, as shown in FIGS. 23 and 24, a side wall portion 33c protruding at a short width is formed in an opposed manner in a side surface portion (a side surface portion which is in parallel to the center axis in the longitudinal direction of the heat generator 2 in the first holding portion 33a) of the first holding portion 33a. The opposed side wall portions 33c and 33c are formed in such a manner as to be opposed, by being folded approximately at 90 degrees in a direction (an upward direction in FIG. 13) from the side surface portion of the first holding portion 33a to the second holding portion 33b. At this time, the side wall portion 33c of the holder 33 is structured so as to enter into a notch portion 33j formed in a corresponding side surface portion of the second holding portion 33b.

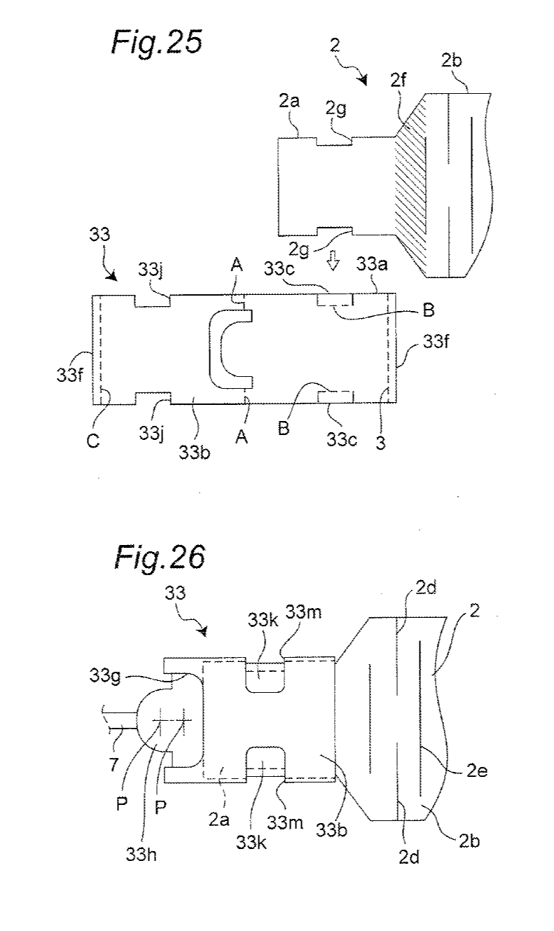

FIG. 25 shows an expanded view of the holder 33 according to embodiment 7, and shows an end portion of the heat generator 2 pinched by the holder 33. As shown in FIG. 25, in the expanded holder 33, the first holding portion 33a and the second holding portion 33b are formed by being bent approximately at 180 degrees at a position of a broken line A existing in a center portion thereof. Further, the opposed side wall portions 33c and 33c are formed by being folded approximately at 90 degrees in an end portion side thereof in the same direction as the direction folded at the position of the broken line A, at two positions of a broken line B of the first holding portion 33a, in a state where the heat generator holding portion 2a is arranged between the first holding portion 33a and the second holding portion 33b.

As shown in FIG. 25, notch portions 2g and 2g are formed in side surfaces (opposed side surfaces which are in parallel to the longitudinal direction of the heat generator 2), in the heat generator holding portion 2a held by the holder 33. Accordingly, when the side wall portions 33c and 33c of the first holding portion 33a are folded, the side wall portions 33c and 33c enter into the notch portion 33j formed in the second holding portion 33b, and are engaged with the notch portion 2g of the heat generator 2, and the holder 33 securely engages and holds the heat generator holding portion 2a. As mentioned above, since the side wall portion 33c is engaged with the notch portion 2g of the heat generator 2 when the side wall portion 33c enters into the notch portion 33j, the heat generator 2 does not come off from the holder 33, and the heat generator 2 comes to a state of being securely fixed to the holder 33.

In embodiment 7, in the same manner as embodiments 5 and 6 mentioned above, the derived portions 33f and 33f are formed by being curved in a direction in which opposed surfaces in a derived end portion side get away from each other at a position of a broken line C existing in the derived side of the heat generator 2 in the first holding portion 33a and the second holding portion 33b, in the expanded holder 33.

The holder in embodiment 7 is formed by the same material as the holders 3 and 23 according to embodiment 5 and embodiment 6 mentioned above.

As mentioned above, in the heat generation unit according to embodiment 7, in the same manner as embodiment 5 and embodiment 6 mentioned above, the first holding portion 33a, the second holding portion 33b, the side wall portion 33c and the tongue portion 33h (refer to FIG. 23) for pinching the heat generator holding portion 2a of the heat generator 2 are formed with the simple structure. The tongue portion 33h is extended in the same direction as the deriving direction of the internal lead wire 7 from the first holding portion 33a, and the fixed portion 35 connected to the internal lead wire 7 is arranged in and fixed to the tongue portion 33h. The tongue portion 33h and the fixed portion 35 are spot welded at two positions denoted by reference symbol P in FIGS. 23 and 24 so as to be securely fixed. The spot welding position may be set to one position as long as a structure has such a strength that the deposited portion of the holder 33 and the fixed portion 35 can maintain a tensile force for providing the heat generator 2 within the container in a tension manner.

FIG. 26 is a plan view showing another engaging method between the heat generator 2 and the holder 33 in the heat generation unit according to embodiment 7. In the structure shown in FIG. 26, there is formed a side wall portion 33k in which a width of a side surface portion of the holding portion 33a is short, and a protruding portion is long, and the side wall portion 33k is folded in such a manner as to grip a side portion of the second holding portion 33b. At this time, the side wall portion 33k of the holder 33 is structured so as to enter into a notch portion 33m formed in the side surface portion of the second holding portion 33b and a notch portion 2g (refer to FIG. 25) of the heat generator holding portion 2a. As mentioned above, since the side wall portion 33k is engaged with the notch portion 2g of the heat generator holding portion 2a when the side wall portion 33k enters into the notch portion 33m, the heat generator 2 does not come off from the holder 33, and the holder 33 securely holds the heat generator 2 in an electrically connected state.

In the heat generation unit according to embodiment 7, since the heat generator 2 is securely held by the holder 33 as mentioned above, and the holder 33 and the fixed portion 35 are spot welded, the heat generator 2 securely comes to the electrically connected state via the holder 33 with respect to the fixed portion 35. As a result, in the heat generation unit according to embodiment 7, since the both end portions of the band-like heat generator 2 are held by the holder 33 having the simple structure, and the holder 33 is securely fixed by the fixed portion 35 of the internal lead wire portions 11a and 11b, the electrically connected state is secured between the heat generator 2 and the internal lead wire portions 11a and 11b. As mentioned above, in the heat generation unit according to embodiment 7, since the heat generator 2 is securely connected and fixed to the internal lead wire portions 11a and 11b via the holder 33, is high in safety and reliability, becomes a heat source having high efficiency, and has a simple structure, it is possible to provide the heat generation unit having high working efficiency and an excellent productivity.

### Embodiment 8

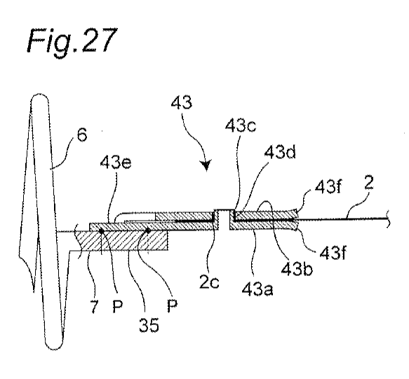

A description will be given of a heat generation unit according to embodiment 8 of the present invention with reference to FIG. 27. In the heat generation unit according to embodiment 8, a point different from the heat generation unit according to embodiment 5 mentioned above exists in structures of a holder 43 and a fixed portion 35 which are attached to the both ends of the heat generator 2. Since the structures other than the holder 43 and the fixed portion 35 in the heat generation unit according to embodiment 8 are the same as the heat generation unit according to embodiment 5, a description will be given below in detail of the structures of the holder 43 and the fixed portion 35 according to embodiment 8. In the description of embodiment 8, the same reference numerals are attached to the elements having the same functions and structures as embodiment 5 and a description thereof will not be given.

FIG. 27 shows the holder 43 attached to the end portion of the heat generator 2 in the heat generation unit according to embodiment 8, the fixed portion 35 and the like, and is a cross sectional view in a center axis which is in parallel to the longitudinal direction of the heat generator 2.

The holder 43 used in the heat generation unit according to embodiment 8 is constructed by folding working and press working of a flat plate material formed by a metal material, for example, molybdenum having a conductivity in the same manner as the holder 3 according to embodiment 5. As shown in FIG. 27, the heat generator 2 is pinched between a first holding portion 43a and a second holding portion 43b of the folded holder 43, and is held in such a manner that a retainer receiving portion 2c (refer to FIG. 17) that is a through hole of the heat generator 2 is passed through by a projection portion 43c formed in the first holding portion 43a.

The holder 43 in the heat generation unit according to embodiment 8 is formed by a flat plate material in the same manner as the holders 3 and 23 according to embodiment 5 and embodiment 6 mentioned above, however, the projection portion 43c is formed in the first holding portion 43a by press molding or the like, and a hole 43d is formed in the second holding portion 43b at a position corresponding to the projection portion 43c mentioned above. In FIG. 27, the hole 43d is shown by the through hole, however, the hole 43d may be a closed-end hole (a concave portion hole) as long as the projection portion 43c enters thereinto. In the holder 43 in an expanded plate material state, the first holding portion 43a and the second holding portion 43b are formed by being folded approximately at 180 degrees in its approximately center portion, the projection portion 43c of the first holding portion 43a enters into the hole 43d of the second holding portion 43b while passing through the retainer receiving portion 2c of the heat generator 2, and pinches the heat generator 2.

The holder 43 in the heat generation unit according to embodiment 8 is described by the example in which the first holding portion 43a and the second holding portion 43b are formed by one plate material, however, the first holding portion 43a and the second holding portion 43b may be structured so as to be formed by independent members so as to be bonded to each other.

In the heat generation unit according to embodiment 8, since the holder 43 is structured as mentioned above, the heat generator 2 is securely held without coming off from the holder 43. Further, a fixed portion 35 connected to the internal lead wire 7 is arranged in and fixed to a tongue portion 43e extended in the same direction as the deriving direction of the lead wire 7 from the first holding portion 43a. The tongue portion 43e and the fixed portion 35 are spot welded and fixed at two positions shown by reference symbol P in FIG. 27. The spot weld positions are on a center axis of the holder 43. In this case, the center axis of the holder 43 is in parallel to the longitudinal direction of the heat generator 2 held by the holder 43, and corresponds to an axis passing through a gravity point of a member including the heat generator 2 and the holder 43. It should be noted that the spot weld position may be set to one position as long as it is structured such that it is possible to maintain a tensile force for the deposited position of the holder 43 and the fixed portion being provided with the heat generator in a tension manner within the container.

In the holder 43 in the heat generation unit according to embodiment 8, deriving portions 43f and 43f are respectively formed in the first holding portion 43a and the second holding portion 43b, for the same purpose as the deriving portion 3f of the holder 3 in the heat generation unit according to embodiment 5 mentioned above.

In the heat generation unit according to embodiment 8, since the heat generator 2 is securely held by the holder 43 as mentioned above, and the holder 43 and the fixed portion 35 are spot welded (in a two-point fixed state), the heat generator 2 securely comes to an electric connected state with respect to the fixed portion 35 via the holder 43. As a result, in the heat generation unit according to embodiment 8, the both end portions of the band-like heat generator 2 are held by the holder 43 having the simple structure, the holder 43 is securely fixed by the fixed portion 35 of the internal lead wire portions 11a and 11b, and the electric connected state between the heat generator 2 and the internal lead wire portions 11a and 11b is secured. As mentioned above, the heat generation unit according to embodiment 8 is securely connected and fixed to the internal lead wire portions 11a and 11b via the holder 43, becomes the heat source having the high safety and reliability and having the high efficiency, and provides the heat generation unit having the high working efficiency and having the excellent productivity.

In embodiments 5 to 8 mentioned above, the description is given of the example in which the molybdenum is employed as the material of the holders 3, 23, 33 and 43, however, the material is not limited to the molybdenum in the present invention, but it is possible to appropriately select a material having a heat resistance, for example, tungsten, nickel, stainless steel and the like, in addition to the molybdenum, in correspondence to the product specification.

### Embodiment 9

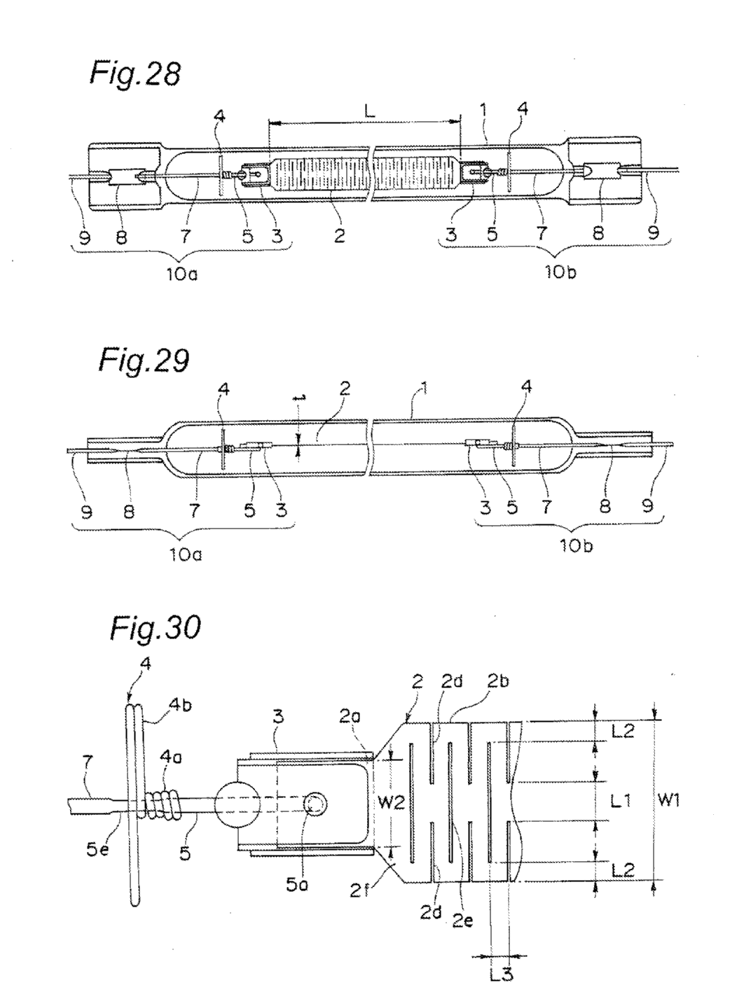

A description will be given of a heat generation unit according to embodiment 9 of the present invention with reference to FIGS. 28 to 30. FIG. 28 is a plan view showing a structure of the heat generation unit according to embodiment 9. In FIG. 28, since the heat generation unit is formed in a long shape, an intermediate portion thereof will be ruptured and omitted, and portions near both ends are shown. FIG. 29 is a front view of the heat generation unit shown in FIG. 28.

In the heat generation unit according to embodiment 9, a band-like heat generator 2 is arranged like a film sheet in an inner portion of the elongated container 1 having the heat resistance. The elongated band-like heat generator 2 is provided in an extending manner along the longitudinal direction of the container 1. In the heat generation unit according to embodiment 9, the container 1 is formed by the transparent quartz glass tube in the same manner as embodiment 1 mentioned above, both end portions of the quartz glass tube are deposited like a flat plate, and the container 1 is sealed. Further, an argon gas serving as an inert gas is charged in the inner portion of the container storing the heat generator 2 and the like. The inert gas which can be charged in the inner portion of the container is not limited to the argon gas, but it is possible to employ a nitrogen gas, mixed gases of the argon gas and the nitrogen gas, the argon gas and the xenon gas, the argon gas and the krypton gas, and the like, in addition to the argon gas, and the same effect can be achieved. As the inert gas to be charged into the container, it is possible to appropriately select according to the purpose. The inert gas is charged in the inner portion of the container 1 for the purpose of preventing the heat generator 2 that is a carbon-based substance in the inner portion of the container from being oxidized at the time of being used at a high temperature. It is possible to employ any material having a heat resistance, an insulating property and heat permeability as the material of the container 1, for example, it is possible to appropriately select from glass materials such as a soda lime glass, a borosilicate glass, a lead glass and the like, and a ceramic material, in addition to the quartz glass.

As shown in FIGS. 28 and 29, the heat generation unit according to embodiment 9 is provided with the container 1, the elongated band-like heat generator 2 serving as the heat radiation membrane body, and the first and second power supply portions 10a and 10b which are provided in the both end portions in the longitudinal direction of the heat generator 2 for holding the heat generator 2 at the predetermined position within the container, and are provided for supplying the power to the heat generator 2.

The first and second power supply portions 10a and 10b provided in the both ends of the heat generator 2 include the holder 3 attached to the both ends of the heat generator 2, the support ring 4, the fixed portion 5, the internal lead wire 7, the molybdenum foil 8, and the external lead wire 9. The fixed, portion 5 connected to the internal lead wire 7 is fixed to the holder 3, and the internal lead wire 7 is electrically connected to the external lead wire 9 derived from the both ends of the container 1 to the outer portion of the container via the molybdenum foil 8 embedded in the sealed portion (the deposited portion) in the both end portions of the container 1.

As shown in FIGS. 28 and 29, the support ring 4 serving as the position regulating portion having the position regulating function is attached to the internal lead wire 7. The internal lead wire 7 is constructed by one wire rod, for example, a molybdenum wire, and the support ring 4 is obtained, for example, by forming the molybdenum wire in a coil shape.

The internal lead wire 7 and the support ring 4 in embodiment 9 are described by the example formed by the molybdenum wire, however, may be formed by using a metal wire (a round rod shape or a flat plate shape) having tungsten, nickel, stainless steel or the like as the material.

As mentioned above, in the heat generation unit according to embodiment 9, the power supply portions 10a and 10b constructed by the holder 3, the support ring 4, the internal lead wire 7, the molybdenum foil 8 and the external lead wire 9 are provided in the both sides of the heat generator 2, supply the power to the heat generator 2, and are provided with the heat generator 2 in a tension manner at the predetermined position within the container.

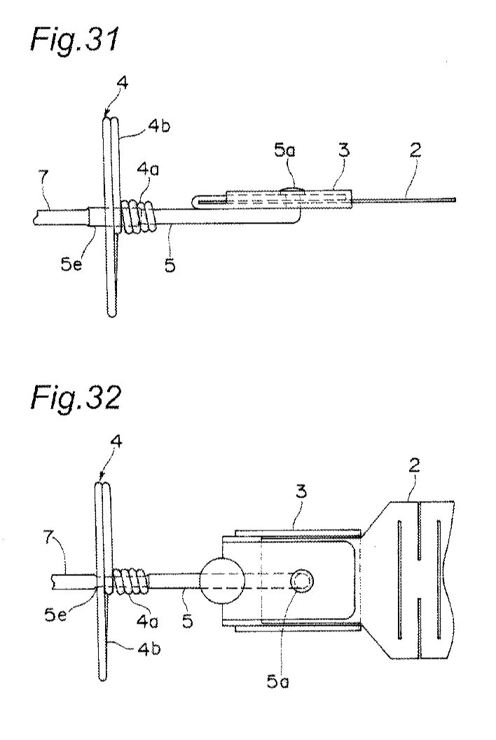

FIG. 30 is a plan view showing a portion near one end portion of the heat generator 2 in the heat generation unit according to embodiment 9. FIG. 31 is a front view of the portion near the end portion of the heat generator 2 shown in FIG. 30. In the heat generator 2 shown in FIG. 30, a surface shown in the plan views of FIGS. 28 and 30 is an opposed surface of the object to be heated.

As shown in FIGS. 30 and 31, the end portion of the heat generator 2 is pinched in a flat surface side and a back surface side by the holder 3, and the through hole formed approximately in the center of the holder 3 and the through hole formed in the end portion of the heat generator 2 are passed through by the end portion of the fixed portion 5 connected to the internal lead wire 7. In embodiment 9, the internal lead wire 7 and the fixed portion 5 are constructed by one wire rod. The heat generator side end portion of the fixed portion 5 connected to the internal lead wire 7 is bent, and is formed in a so-called L-shape. A leading end of the fixed portion 5 bent in the L-shape passes through the through hole of the holder 3 pinching the heat generator 2 so as to protrude out of the through hole of the holder 3.

Fall-out preventing means (dropout preventing means) is provided in the protruding end portion 5a of the fixed portion 5 protruding out of the through hole of the holder 3. As shown in FIG. 31, the protruding end portion 5a of the fixed portion 5 is plastically deformed by the press working or the like so as to be in a crushed state. In other words, the protruding end portion 5a in the fixed portion 5 is worked in a shape larger than the diameter of the through hole of the holder 3, and is provided with the fall-out preventing means. As a method of plastically deforming the protruding end portion 5a of the fixed portion 5, it is possible to use a mechanical working method such as a rotational caulking work and the like, or a depositing method by heat, a current, a plasma and the like, in addition to the press working. Further, as the other fall-out preventing means, there are a screwing method threading the protruding end portion 5a of the fixed portion 5 and using a nut, a locking method of installing a stop ring, for example, a C-shaped stop ring, an E-shaped stop ring or the like, to the protruding end portion 5a, and the like.

The support ring 4 in the heat generation unit according to embodiment 9 is wound around the fixed portion 5 connected to the internal lead wire 7 so as to be fixed, and is formed in a coil shape. As shown in FIGS. 30 and 31, the attaching position 5e in the fixed portion 5 with the support ring 4 wound around is crushed in an opposed direction by the press working. In embodiment 9, the internal lead wire 7 and the fixed portion are constructed by the wire rod (the molybdenum wire) having the round cross sectional shape, however, a cross section of the attaching position 5e in the fixed portion 5 is approximately in a rectangular shape. In other words, in the fixed portion 5, the cross sectional shape which is orthogonal to a direction in which the current flows is approximately in the rectangular shape in the attaching position 5e, and is different from the round cross sectional shape in the other positions.

In this case, the cross sectional area of the attaching position 5e of the fixed portion 5 according to embodiment 9 is formed so as to be equal to or more than 80% in comparison with the cross sectional area of the round cross sectional shape in the other positions. Further, in the fixed portion 5, a boundary portion between the portion having the round cross sectional shape and the portion having approximately the rectangular cross sectional shape is formed so as to form a gentle deformation, and is structured such that a rapid shape change is not generated. Accordingly, in the fixed portion 5 that is the current path from the external lead wire 9 to the heat generator 2, the resistance value does not change rapidly, and the temperature rise in the attaching position 5e is suppressed.

In the heat generation unit according to embodiment 9, the support ring 4 is wound around and attached to the boundary portion between the attaching position 5e of the fixed portion 5 and the round cross sectional shape portion in the heat generator side formed as mentioned above, as shown in FIGS. 30 and 31. The support ring 4 has a winding and attaching portion 4a winding around and attaching to the fixed portion 5, and a ring portion 4b having a coil shape.

The winding and attaching portion 4a of the support ring 4 is wound around the attaching position 5e of the fixed portion 5 by a plurality of number of turns (three to five turns) (a winding and attaching state). Accordingly, the support ring 4 is firmly attached to the fixed portion 5 without slacking. Therefore, the support ring 4 is neither detached from the fixed portion 5 nor moved on the fixed portion 5. As the other fixing and attaching method of the support ring 4 and the fixed portion 5, there can be considered a connecting method by the spot welding, however, there is a risk that the respective wire rods of the support ring 4 and the fixed portion 5 are brittle-fractured by a heat generated at the time of welding, and there is also a risk that the connection point of the fixed portion 5 is fused and the cross sectional area becomes small. Accordingly, the method of connecting the support ring 4 and the fixed portion 5 by the spot welding is not a preferred connecting method.

The ring portion 4b of the support ring 4 is formed in a coil shape having at least one turn, and a diameter thereof has such a magnitude as to come close to the inner surface of the cylindrical container 1 in which the heat generator 2 is stored.

The heat generation unit according to embodiment 9 is structured such that the width of the heat generator 2 is 6.0 mm, the inner diameter of the cylindrical portion of the container 1 storing the heat generator 2 is 8.0 mm, and the diameter of the ring portion 4b of the support ring 4 is 7.0 mm. Accordingly, in the heat generation unit according to embodiment 9, a gap between the ring portion 4b of the support ring 4 and the inner surface of the cylindrical portion of the container 1 is set to 1.0 mm in total in both end portions. A dimensional relationship among the container 1, the heat generator 2 and the support ring 4 mentioned above can be appropriately changed including a tolerance in correspondence to the product specification and the intended use as the heat source in which the heat generation unit is used. However, the support ring 4 is set to such a dimension that can regulate the position of the heat generator 2 without coming into contact with the container 1.

As mentioned above, since the support ring 4 in the heat generation unit according to embodiment 9 has the function serving as the position regulating member for arranging the heat generator 2 at the predetermined position within the container, and the outer peripheral portion of the ring portion 4b having the diameter larger than the width of the heat generator 2 is at the position coming close to the inner peripheral surface of the container 1, the heat generator 2 is arranged at the desired position (the position at which the center axis in the longitudinal direction of the container 1 becomes coaxial with the center axis in the longitudinal direction of the heat generator 2 in embodiment 9) without coming into contact with the container 1.

The support ring 4 constructed as mentioned above is structured so as to be wound around and attached to the fixed portion 5 for supplying the power to the heat generator 2, and is structured such that the current path from the external lead wire 9 to the heat generator 2 does not pass through the support ring 4. In other words, the structure is made such that the current path in the fixed portion 5 is not interposed in the support ring 4. As mentioned above, since the support ring 4 is structured such that the current to the heat generator 2 does not flow therein, the support ring 4 does not generate heat by the current to the heat generator 2. The support ring 4 according to embodiment 9 has the position regulating function of the heat generator 2, and serves as a heat dissipation function dissipating the heat conducted from the heat generator 2.

The support ring 4 according to embodiment 9 is described by the example in which it is formed by the molybdenum wire, however, it is possible to use any material as the support ring 4, as long as the material has such a rigidity as to regulate the position of the heat generator 2, has excellent heat conduction (heat dissipation function) and is easily processed, and it is possible to employ a metal material, for example, nickel, stainless steel, tungsten and the like.

Further, the ring portion 4b of the support ring 4 according to embodiment 9 is formed in a circular coil shape, however, the present invention is not limited to this shape, but can employ any shape that has the position regulating function and the heat dissipation function of the heat generator 2. For example, the ring portion 4b shown in FIGS. 30 and 31 has the number of 1.5 turns, however, it is possible to enhance the position regulating and heat dissipation functions by increasing the number of turns. Further, as the winding method, it is not always necessary to densely wind along the longitudinal direction of the heat generator 2, but a loosely wound portion may be provided. Further, the shape of the ring portion 4b is not limited to the coil shape, but may employ any shape that can be easily formed and can regulate the heat generator 2 at a desired position. The structure in which the winding and attaching portion 4a wound around and attached to the fixed portion 5 is wound around and attached to the coil portion 4b in only one end in one side is illustrated, however, it is not always necessary to form the winding and attaching portion 4a only in one end, but particularly in the case where the number of turns is increased, the winding and attaching portion 4a may be formed in both ends, and the ring portion 4b comes to have a further stable structure by being provided in an intermediate portion of the coil portion 4b.

In the heat generation unit according to embodiment 9, since the material itself of the heat generator 2 has elasticity and the shape pattern of the heat generator 2 has elasticity, a mechanism for absorbing the change by the expansion and contraction in the heat generator 2 is not necessary. Particularly, since the heat generator 2 used in embodiment 9 has a small coefficient of thermal expansion, the heat generator 2 arranged (provided in a tension manner) in a state of being applied the tensile force at the time of manufacturing can absorb the expansion at the time of generating heat by the elasticity of the heat generator itself and the shape pattern of the heat generator 2. Accordingly, it is not necessary to provide the elastic member which is provided for always providing the heat generator in the tension manner in the conventional heat generation unit, in the heat generation unit according to embodiment 9. As a result, in the heat generation unit according to embodiment 9, the spring portion which is necessary in the conventional structure is not necessary, and the heat generator 2 can be provided in the extending manner in the arranged space, and it is possible to set the shape of the heat generator 2 larger than the container 1.

The heat generator 2 used in the heat generation unit according to embodiment 9 of the present invention has a laminated structure having the carbon-based substance as the main component and firmly attached partly in such a manner that the layers form the interval in the thickness direction, has the excellent two-dimensional isotropic thermal conductivity, and is formed by the film sheet-like material having the coefficient of thermal conductivity equal to or more than 200 W/m·K. Accordingly, the band-like heat generator 2 becomes the heat source having no temperature irregularity and uniformly generating heat.

As described in embodiment 5 mentioned above, the film sheet raw material that is the material of the heat generator 2 is the graphite film sheet having a heat resistance and a high orientation obtained by thermal processing the high polymer film or the high polymer film to which the filler is added under an ambient atmosphere at a high temperature, for example, 2400° C. or more, and sintering so as to form graphite, has the coefficient of heat conductivity in the surface direction equal to or more than 200 W/m·K, and has the characteristic between 600 and 950 W/m·K. As mentioned above, the heat generator 2 used in embodiment 9 has an excellent two-dimensional isotropic thermal conductivity in which the coefficient of thermal conduction in the surface direction is between 600 and 950 W/m·K.

The definition of the two-dimensional isotropic thermal conductivity, and the specific material of the high polymer film used as the film sheet raw material are the same as those described in embodiment 5 mentioned above.

In the heat generator 2 according to embodiment 9, the thickness (t) is 100 μm (refer to FIG. 29), the width (W1) of the heat generator 2b generating heat in the heat generator 2 is 6.0 mm (refer to FIG. 30), the width (W2) of the heat generator holding portion 2a held by the holder in the heat generator 2 is about 5.0 mm (refer to FIG. 30), and the length (L) of the heat generating portion 2b is 300 mm (refer to FIG. 28). The length, the width and the thickness of the heat generator 2 are decided by the input voltage, the heat generating temperature and the like, and can be appropriately changed in correspondence to the product specification and the intended use as the heat source in which the heat generation unit is used.

As shown in FIGS. 28 and 30, a plurality of grooves (notches) are provided in the heat generating portion 2b of the heat generator 2 according to embodiment 9 so as to be extended in the direction which is orthogonal to the longitudinal direction of the heat generator 2. A plurality of grooves formed in the heat generating portion 2b are structured so as to regulate the flowing direction of the current in the heat generating portion 2b, and regulate the resistance value. As the groove shape formed in the heat generating portion 2b, there are a groove passing through in correspondence to the product specification and the intended use in which the heat generation unit is used, a closed-end groove and the like. Further, in the concave portion groove, it is possible to regulate the resistance value of the heat generating portion 2b by changing the depth in the thickness direction.

Further, by forming the groove in the heat generator 2 according to embodiment 9, the heat generator 2 has the characteristic of having large elasticity due to the elasticity obtained by the groove shape along with the elasticity of the heat generator itself.

The groove pattern shown in FIG. 30 is repeatedly formed in the heat generating portion 2b of the heat generator 2 according to embodiment 9. In other words, in the heat generating portion 2b of the heat generator 2, there are formed the end groove 2d extending to the center side so as to be orthogonal to the longitudinal direction from the opposed positions of both side edge portions which are in parallel to the longitudinal direction, and the center groove 2e formed in the center portion of the heat generating portion 2b so as to be orthogonal to the longitudinal direction. The opposed end portions in the center side of the opposed end grooves 2d and 2d in the heat generating portion 2b have a first predetermined distance (a distance denoted by reference symbol L1 in FIG. 30), and forms a current carrying path in the center portion of the heat generating portion 2b. Further, the edge side end portions that are both end portions of the center groove 2e have the same second predetermined distance (a distance denoted by reference symbol L2 in FIG. 30) from the edge portion in the width direction of the heat generating portion 2b, and current carrying paths are formed near the both side edge portions of the heat generating portion 2b. Further, in the heat generating portion 2b of the heat generator 2, a distance in the longitudinal direction between the end groove 2d and the center groove 2e has a third predetermined distance (a distance denoted by reference symbol L3 in FIG. 30), and the current path flowing in the direction which is orthogonal to the longitudinal direction of the heat generator 2 is formed between the end groove 2d and the center groove 2e.

In the heat generator 2 according to embodiment 9, the third predetermined distance L3 that is the distance in the longitudinal direction between the end groove 2d and the center groove 2e is set to the same distance as the second predetermined distance L2, and the first predetermined distance L1 is set to twice as large as the second predetermined distance L2 and the third predetermined distance L3. In the heat generating portion 2b of the heat generator 2 in which the groove pattern is formed as mentioned above, a meandering current path is formed, a cross sectional area which is orthogonal to the flow of the current is approximately the same, it is easy to calculate the resistance value, and it is possible to form the uniform temperature distribution. It should be noted that as long as the material has such a characteristic that the coefficient of thermal expansion in the surface direction of the heat generator 2 is, for example, equal to or more than 600 W/m·K, the uniform temperature distribution (heat arrangement distribution) is not greatly affected even if the second predetermined distance L2 is not one half of the first predetermined distance L1. Preferably, by setting the second predetermined distance L2 equal to or more than one half of the first predetermined distance L1, it is possible to enhance the strength of the heat generator 2 with respect to the mechanical shock applied to the heat generation unit.

Further, it is possible to set the heat generation distribution by the heat generating portion 2b to the desired heat arrangement pattern by appropriately selecting the groove pattern formed in the heat generating portion 2b in correspondence to the product specification and the intended use in which the heat generation unit is used.

Further, it is possible to change the heat generation distribution (the heat arrangement pattern) of the heat generating portion 2b in such a manner that the center portion has a higher heat, by gradually expanding the distance L3 in the longitudinal direction between the end groove 2d and the center groove 2e in accordance with coming close to the end portion in the longitudinal direction of the heat generator 2, that is, the heat generator holding portion 2a, in the heat generating portion 2b, thereby gradually changing a resistivity of the current path in the heat generating portion 2b. Needless to say, it is possible to obtain a heat source having a desired heat arrangement pattern by appropriately changing the distances L1, L2 and L3 in correspondence to the product specification and the intended use in which the heat generation unit is used.

The heat generator 2 in embodiment 9 is formed such that the width (W2) of the heat generator holding portion 2a is narrower than the width (W1) of the heat generating portion 2b. Further, a region connecting from the heat generator holding portion 2a to the heat generating portion 2b is formed so as to be gradually wider, and the heat dissipation portion 2f having the heat dissipation function is formed in this region. The groove as mentioned above is not formed in this heat dissipation portion 2f, and a wide current path is formed. As a result, in the heat dissipation portion 2f, the heat conducted from the heat generation portion 2b is dissipated, and a reduction of a thermal stress in the heat generator 2 and a long service life are achieved. It is preferable that an edge shape of the heat dissipation portion 2f connecting from the heat generator holding portion 2a to the heat generating portion 2b is constructed by a curved shape for preventing a concentrated load from being applied so as to be damaged.

Further, in the case where the temperature of the heat generating portion 2b is high in accordance with the product specification, it is possible to provide a temperature gradient in the heat dissipation portion 2f so as to reduce the thermal stress applied to the heat generator holding portion 2a, by gradually narrowing the width in the heat dissipation portion 2f from the heat generating portion 2b to the heat generator holding portion 2a.

Further, in the heat generator 2, it is possible to achieve the structure having a strong mechanical strength having a shock resistance and a vibration proof, as well as providing the temperature gradient in the heat generating portion 2b, by gradually making the lengths of the first predetermined distance L1 and the second predetermined distance L2 longer in accordance with coming close to the heat generator holding portions 2a in both sides.

In the heat generator 2 according to embodiment 9 structured as mentioned above, since the groove pattern is formed in the heat generating portion 2b, a desired current path can be set, and elasticity is provided. As a result, in the heat generation unit according to embodiment 9, it is possible to set a desired heat generation distribution in correspondence to the product specification and the intended use, it is not necessary to make the member supplying the power to the heat generator 2 have an elastic force, and it is possible to provide a larger heat source in comparison with the magnitude of the container 1.

The heat generator 2 used in embodiment 9 has such an excellent characteristic that a thermal capacity is small while being light and thin, and a rising edge at the time of generating heat by energization is fast. Accordingly, in the heat generation unit according to embodiment 9, it is possible to efficiently heat while having an excellent response. Further, since the heat generator 2 according to embodiment 9 is light and thin, a tensile force for providing the heat generator 2 in a tension manner may be small. In the heat generation unit according to embodiment 9, the heat generator 2 to which the small tensile force set at the time of manufacturing is applied can securely maintain the tension state by absorbing the thermal expansion at a desired position within the container.

The heat generator 2 in the heat generation unit according to embodiment 9 is formed in the band shape by press working so as to work the groove, however, it can be worked in a desired shape by using laser. For example, if the coefficient of thermal conduction in the surface direction of the heat generator 2 becomes equal to or more than 200 W/m·K, as one example of the laser processing, the heat is absorbed by the heat generator 2 in the case of using the laser processing mainly using a thermal working action such as CO₂ laser (a wavelength of 10600 nm) or the like, and there is a problem that it is impossible to work. However, it is possible to precisely work the desired shape by using a laser processing mainly using a nonthermal working action and having a wavelength between 1064 and 380 nm, for example, a short wavelength laser processing having a nominal wavelength of 1064 nm.

Particularly, in the case of forming the heat generator 2 according to embodiment 9, the inventors of the present invention have confirmed that it is possible to precisely work by using a second harmonic laser processing having a nominal wavelength of 532 nm. A material of the heat generator 2 according to embodiment 9 is a film sheet raw material, and uses a high orientation graphite film sheet formed as a graphite by thermally treating the high polymer film or the high polymer film to which the filler is added, in the ambient atmosphere at a high temperature, for example, 2400° C. or higher, and sintering, and having a heat resistance, as the material. Further, the heat generator 2 is formed by a material having such a characteristic that the coefficient of thermal expansion in the surface direction is between 600 and 950 W/m·K. In the case of working the heat generator 2, for example, in which the thickness (t) is 100 μm, the width (W1) is 6.0 mm, and the length (L) is 300 mm, from the material mentioned above, or in the case of working a complicated shape such as the groove (the slit) or the like in the heat generating portion 2b as mentioned above, it is desirable to use the second harmonic laser processing having the nominal wavelength of 532 nm.

It goes without saying that a preferred laser processing method can be appropriately selected from working methods having the laser processing wavelengths (between 1064 and 380 nm) mainly using the non-thermal processing action mentioned above, in accordance with the material of the heat generator 2, that is, the coefficient of thermal conductivity and the shape in the surface direction. Further, it goes without saying that the laser processing method for working the heat generator 2 described above can be employed even in the working of the heat generator of the heat generation unit according to each of the other embodiments mentioned below.

As mentioned above, in the heat generation unit according to embodiment 9, the both end portions of the band-like heat generator 2 are securely held by the power supply portions 10a and 10b having the simple structure, and the heat generator 2 is arranged at the predetermined position within the container. As mentioned above, since the heat generator 2 is securely held at the predetermined position within the container by the power supply portions 10a and 10b having the simple structure in the heat generation unit according to embodiment 9, it is possible to easily provide the heat source in which the safety and the reliability are high, and the efficiency is high.

FIG. 32 is a plan view showing a part of power supply portions (10a, 10b) having a different structure of the heat generation unit according to embodiment 9 of the present invention. In the heat generation unit shown in FIG. 30, the winding and attaching portion 4a of the support ring 4 is wound around a position giving way to a round cross section from an approximately rectangular cross section of the attaching position 5e in the fixed portion 5 connected to the internal lead wire 7. In the heat generation unit shown in FIG. 32, the winding and attaching portion 4a of the support ring 4 is wound around the position of the approximately rectangular cross section of the attaching position 5e in the fixed portion 5. As mentioned above, even if the winding and attaching portion 4a of the support ring 4 is attached to the crushed attaching position 5e, the support ring 4 is neither disconnected from the fixed portion 5, nor moved on the fixed portion 5.

### Embodiment 10

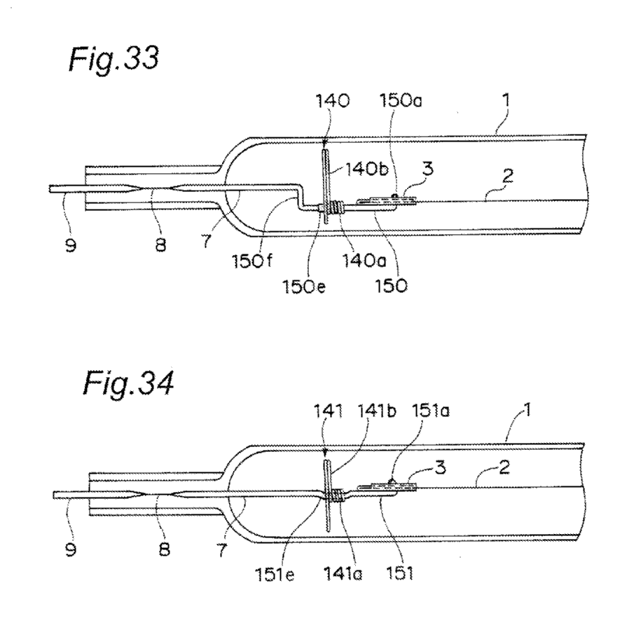

A description will be given below of a heat generation unit according to embodiment 10 of the present invention with reference to FIG. 33. In the heat generation unit according to embodiment 10, a point different from the heat generation unit according to embodiment 9 mentioned above exists in an arranged position of the heat generator 2 with respect to the container 1. Therefore, a shape of the fixed portion connected to the support ring and the internal lead wire which are attached to the both ends of the heat generator 2 is differentiated. In embodiment 10, the structures other than the support ring and the fixed portion in the heat generation unit are the same as the heat generation unit according to embodiment 9. Accordingly, a description will be given below of the support ring and the fixed portion according to embodiment 10. In the heat generation unit according to embodiment 10, the same reference numerals are attached to the elements having the same functions and structures as the heat generation unit according to embodiment 9, and the description of embodiment 9 is appropriately applied to a description thereof.

FIG. 33 is a front view showing a support ring 140 attached to the end portion of the heat generator 2 in the heat generation unit according to embodiment 10 and a fixed portion 150 connected to the internal lead wire 7.

As shown in FIG. 33, in the same manner as the heat generation unit according to embodiment 9, the end portion of the heat generator 2 is pinched by the holder 3 in the flat surface side and the back surface side, and the through hole formed approximately in the center of the holder 3 and the through hole formed in the end portion of the heat generator 2 are passed by the heat generator side end portion of the fixed portion 150. The heat generator side end portion of the fixed portion 150 is bent and is formed in a so-called L-shape. A protruding end portion 150a that is a leading end close to the heat generator side of the fixed portion 150 bent in the L-shape passes through the through hole of the holder 3 pinching the heat generator 2. Fall-out preventing means (dropout preventing means) is provided in the protruding end portion 150a protruding from the through hole of the holder 3, in the same manner as embodiment 9.

The holder 3 used in the heat generation unit according to embodiment 10 is formed by folding a flat plate material formed by a metal material having a conductivity in the same manner as the holder 3 according to embodiment 9, and is structured so as to pinch the heat generator holding portion 2a of the heat generator 2. In order to make an engagement state between the fixed portion 150 and the holder 3 firmer so as to prevent the holder 3 from moving with respect to the fixed portion 150, the holder 3 and the fixed portion 150 are spot welded.

The fixed portion 150 attached in such a manner as to be engaged with the heat generator 2 as mentioned above has a step portion 150f which is bent like a step. Accordingly, the heat generator 2 is arranged along the longitudinal direction at a position which is eccentric from the center axis in the longitudinal direction of the container 1. An attaching position 150e for winding the support ring 140 is formed in the fixed portion 150 according to embodiment 10. The attaching position 150e is formed by crushing by a press working in the same manner as the attaching position 5e of the fixed portion 5 according to embodiment 9 mentioned above. Accordingly, in embodiment 10, in the fixed portion 150, a cross sectional shape which is orthogonal to a current flowing direction is approximately a rectangular shape in the attaching position 150e, and the other portions are formed in a round cross section.

In this case, a cross sectional area of the attaching position 150e of the fixed portion 150 according to embodiment 10 is formed in such a manner as to be equal to or more than 80% in comparison with a cross sectional area of the round cross section in the other portions. Further, in the fixed portion 150, a boundary portion between the portion having the round cross section and the crushed portion having the approximately rectangular cross section is formed so as to be a gentle shape, and is structured such that a rapid shape change is not generated. Accordingly, in the fixed portion 150 that is the current path from the external lead wire 9 to the heat generator 2, the resistance value does not rapidly change in the attaching position 150e, and a temperature rise in the attaching position 150e is suppressed.

In the heat generation unit according to embodiment 10, the support ring 140 is wound around and attached to a boundary portion between the attaching position 150e of the fixed portion 150 and the portion having the round cross section close to the heat generator side, as shown in FIG. 33. The support ring 140 has a winding and attaching portion 140a wound around and attached to the fixed portion 150, and a ring portion 140b having a coil shape.

The winding and attaching portion 140a of the support ring 140 is wound around the fixed portion 150 by a plurality of turns (three to five turns) (a wound and attached state). Accordingly, the support ring 140 is firmly attached to the fixed portion 150 without slacking. Therefore, the support ring 140 is neither disconnected from the fixed portion 150, nor moved on the fixed portion 150. The ring portion 140b of the support ring 140 is formed in a coil shape having at least one turn, and a diameter thereof has such a magnitude as to come close to the inner surface of the container 1 in which the heat generator 2 is stored. Accordingly, a center of the ring portion 140b of the support ring 140 exists on a center axis which is in parallel to the longitudinal direction of the container 1.

As mentioned above, in the heat generation unit according to embodiment 10, both end portions of the heat generator 2 are securely held at a predetermined position within the container by the support ring 140 and the fixed portion 150 having the simple structure. In the heat generation unit according to embodiment 10, the heat generator 2 is formed along the longitudinal direction at a position (an eccentric position) which is deflected from the center axis in the longitudinal direction of the container 1. The heat generation unit according to embodiment 10 structured as mentioned above can construct a different radiation state from the heat generation unit according to embodiment 9 by using the heat generator 2 having the same specification as the heat generator 2 according to embodiment 9. For example, there is obtained such a structure that can increase secondary radiation by the container 1, by constructing such that the position close to the heat generator 2 in the container 1 comes to a high temperature. Further, it is possible to structure so as to reflect the heat radiated from the heat generator 2 by forming a reflective membrane in the container 1 (the inner surface or the outer surface) in a portion which is far from the heat generator 2. As mentioned above, since the reflective membrane can be formed at a position which is away from the heat generator 2, it is possible to prevent the reflective membrane from coming into contact with the heat generator 2 even if the reflective membrane exists in the inner surface of the container 1, and it is possible to use the metal membrane having a low melting point as the reflective membrane as well as securing safety. Further, in the heat generation unit according to embodiment 10, since the reflective membrane (the metal membrane) is arranged at the far position, the structure is made such that the heat generation of the reflective membrane itself can be prevented.

In the heat generation unit according to embodiment 10, the winding and attaching portion 140a of the support ring 140 is wound around the position giving way to the round cross section from the approximately rectangular cross section of the attaching position 150e in the fixed portion 150, however, the structure may be made, in the same manner as the heat generation unit shown in FIG. 32 mentioned above, such that the winding and attaching portion 140a of the support ring 140 is wound around only to the position of the approximately rectangular cross section that is the attaching position 150e in the fixed portion 150. As mentioned above, even if the winding and attaching portion 140a of the support ring 140 is attached to the crushed attaching position 150e in the fixed portion 150, the support ring 140 is neither disconnected from the fixed portion 150, nor moved on the fixed portion 150.

In the heat generation unit according to embodiment 10 structured as mentioned above, since the heat generator 2 is securely held at the predetermined position within the container by the support ring 140 and the fixed portion 150 having the simple structure, it is possible to easily provide the heat source in which the safety and the reliability are high and the efficiency is high.

### Embodiment 11

A description will be given below of a heat generation unit according to embodiment 11 of the present invention with reference to FIG. 34. In the heat generation unit according to embodiment 11, a point different from the heat generation unit according to embodiment 9 mentioned above exists in the structures of the fixed portion and the support ring which are connected to the internal lead wire for providing the heat generator 2 in the tension manner. In embodiment 11, since the structures other than the fixed portion and the support ring in the heat generation unit are the same as the heat generation unit according to embodiment 9, a description will be given below of the fixed portion and the support ring according to embodiment 11. In the heat generation unit according to embodiment 11, the same reference numerals are attached to the elements having the same functions and structures as the heat generation unit according to embodiment 9, and the description of embodiment 9 is applied to a description thereof.

FIG. 34 is a front view showing a fixed portion 151 and a support ring 141 which are connected to the internal lead wire 7 attached to the end portion of the heat generator 2 in the heat generation unit according to embodiment 11.

As shown in FIG. 34, in the same manner as the heat generation unit according to embodiment 9, the end portion of the heat generator 2 is pinched by the holder 3 in a flat surface side and a back surface side, and the through hole formed approximately in the center of the holder 3 and the through hole formed in the end portion of the heat generator 2 are passed through by a protruding end portion 151a that is an L-shaped leading end existing in the heat generator side in the fixed portion 151. Fall-out preventing means (dropout preventing means) is provided in a leading end of the protruding end portion 151a of the fixed portion 151 protruding from the through hole of the holder 3, in the same manner as embodiment 9.

The holder 3 used in the heat generation unit according to embodiment 11 is formed by folding a flat plate material formed by a metal material having a conductivity in the same manner as the holder 3 according to embodiment 9, and is structured so as to pinch the heat generator holding portion 2a of the heat generator 2. In order to make an engagement state between the fixed portion 151 and the holder 3 firmer so as to prevent the holder 3 from moving with respect to the fixed portion 151, the holder 3 and the fixed portion 151 are spot welded.

An attaching position 151b obtained by bending a wire rod in a concave shape is formed in the fixed portion 151 attached in such a manner as to be engaged with the heat generator 2 as mentioned above. Different from the attaching position 5e of the fixed portion 5 according to embodiment 9 mentioned above, the attaching position 151b is not crushed but remains in the round cross sectional shape. In embodiment 11, a description will be given of an example using a wire rod having a round cross sectional shape as the fixed portion 151, however, a wire rod having the other cross sectional shape, for example, a rectangular cross sectional shape (a polygonal cross sectional shape) may be used.

In the heat generation unit according to embodiment 11, the support ring 141 has a winding and attaching position 141a wound around and attached to the fixed portion 151, and a coil shaped ring portion 141b arranged so as to have a predetermined gap from the inner surface of the container 1, in the same manner as embodiment 9.

The wire rod of the support ring 141 is wound around for three to five turns, whereby the winding and attaching portion 141a is formed in the attaching position 151b, and the support ring 141 is securely and firmly attached to the fixed portion 151.

Accordingly, in embodiment 11, a cross sectional area which is orthogonal to a current flowing direction is not changed even in the attaching position 151b, but has the same round cross section, in the fixed portion 151. Therefore, in the fixed portion 151 that is the current path, neither the resistance value be changed in the attaching position 151b, nor the temperature rise be generated.

As mentioned above, the ring portion 141b of the support ring 141 is formed in the coil shape having at least one turn, and the diameter thereof has such a magnitude as to come close to the inner surface of the container in which the heat generator 2 is stored. Accordingly, the center of the ring portion 141b of the support ring 141 is on the center axis which is in parallel to the longitudinal direction of the container 1.

As mentioned above, in the heat generation unit according to embodiment 11, the heat generator 2 is securely held at the predetermined position within the container by the support ring 141 and the fixed portion 151 having the simple structure. In the heat generation unit according to embodiment 11, it is possible to easily provide the heat source in which the safety and the reliability are high, and the efficiency is high, in the same manner as the effect of the heat generation unit according to embodiment 9.

### Embodiment 12

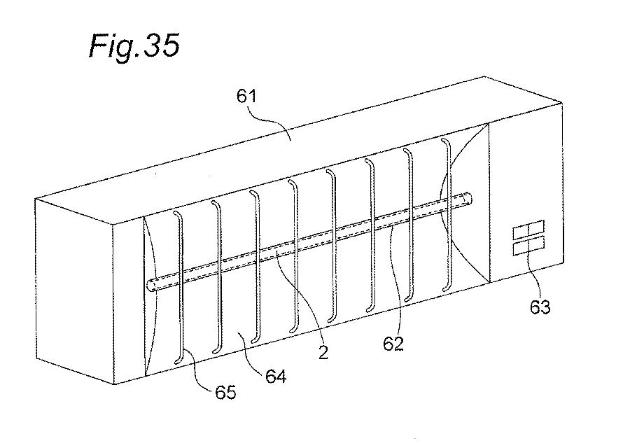

A description will be given below of a heating apparatus according to embodiment 12 of the present invention with reference to FIG. 35.

FIG. 35 is a perspective view showing an example of the heating apparatus equipped with the heat generation units which are described in embodiment 1, embodiment 2 and embodiments 5 to 11.

In FIG. 35, the heat generation unit according to the present invention described in embodiment 1, embodiment 2 and embodiments 5 to 11 is installed in an inner portion of an apparatus that is a heating apparatus 61 for heating as one example of the heating apparatus. In the heating apparatus 61 according to embodiment 12, a description will be given by attaching reference numeral 62 to the heat generation unit. The heating apparatus 61 according to embodiment 12 is provided with structural members which are used in a general heating apparatus for heating, such as a temperature controller 63, a reflective plate 64, a cover 65 for protection and the like.

In the heating apparatus 61 structured as mentioned above, a predetermined current flows in a heat generator 2 within the heat generation unit 62 so as to generate heat, by applying a rated voltage to the heat generation unit 62, and a temperature rises at a quick rising edge. The heating apparatus 61 according to embodiment 12 is securely held at a predetermined temperature desired by a user, in accordance with temperature control by the temperature controller 63. Further, since the band-like heat generator 2 having a flat surface is used as the heat source in the heat generation unit 62, heat radiated from the flat surface has a directivity. In the heating apparatus 61 according to embodiment 12, the flat surface portion of the heat generator 2 of the heat generation unit 62 is arranged so as to be directed to a front surface side and a back surface side. Accordingly, the heat radiated from the front surface side of the heat generator 2 heats a region to be heated existing in the front surface side of the heating apparatus 61, and the heat radiated from the back surface side of the heat generator 2 is reflected by the reflective plate 64 so as to heat the region to be heated. Since the heat generator 2 is formed in the band shape by the film sheet raw material, the heat quantity radiated from the side surface side of the heat generator 2 is very small, and is small to an extent that can be disregarded in comparison with the heat quantity radiated from the front surface side (the back surface side). Accordingly, in the heating apparatus 61 according to embodiment 12, it is possible to efficiently heat the region to be heated while having a high directivity.

The heat generation unit 62 installed in the heating apparatus according to the present invention has the heat generator 2 described in embodiment 1, embodiment 2 and embodiments 5 to 11, and the heat generator 2 is formed by the film sheet raw material having the excellent two-dimensional isotropic thermal conductivity in which the coefficient of thermal conductivity in the surface direction is the same, and has such a characteristic that the rising edge is fast due to the small heat quantity and the rush current is small. Therefore, the heating apparatus equipped with the heat generation unit according to the present invention as the heat source becomes a heating apparatus which has an excellent response capable of heating quickly, and has an excellent characteristic that can heat a predetermined region with high heat efficiency.

According to the present invention, it is possible to provide the heat generation unit and the heating apparatus which can efficiently heat the object to be heated according to a desired heat arrangement distribution and at a high temperature, and it is possible to easily manufacture the heat generation unit and the heating apparatus in which the safety and the reliability are high.

The heat generation unit according to the present invention can be used as a heat source of various diverse electronic and electric apparatuses in addition to the heating apparatus, and can be utilized in various apparatuses in which a heat source is necessary, for example, an OA apparatus such as a copying machine, a facsimile, a printer and the like which are equipped with a high-temperature heat generator, an electric apparatus such as a cooking apparatus, a drying machine, a humidifier and the like.

### Embodiment 13

Next, a description will be given of a preferred embodiment of an image fixing apparatus according to the present invention and an image forming apparatus using the image fixing apparatus with reference to the accompanying drawings. The image fixing apparatus and the image forming apparatus described herein are equipped with the heat generation unit described in each of the embodiments mentioned above as the heat source.

The inventors of the present invention applies a new film sheet-like material (a film sheet raw material) which is completely different in a material and a manufacturing method from the heat generator used in the conventional image fixing apparatus as the heat generating material to the heat generator, as mentioned above. The film sheet-like material (the film sheet raw material) which is to be applied to the heat generator used in the heat generation unit as the new heat source of the image fixing apparatus has high efficiency and a high temperature, has a reduced heat quantity due to a light and thin structure, and has an excellent rising characteristic, as mentioned above.

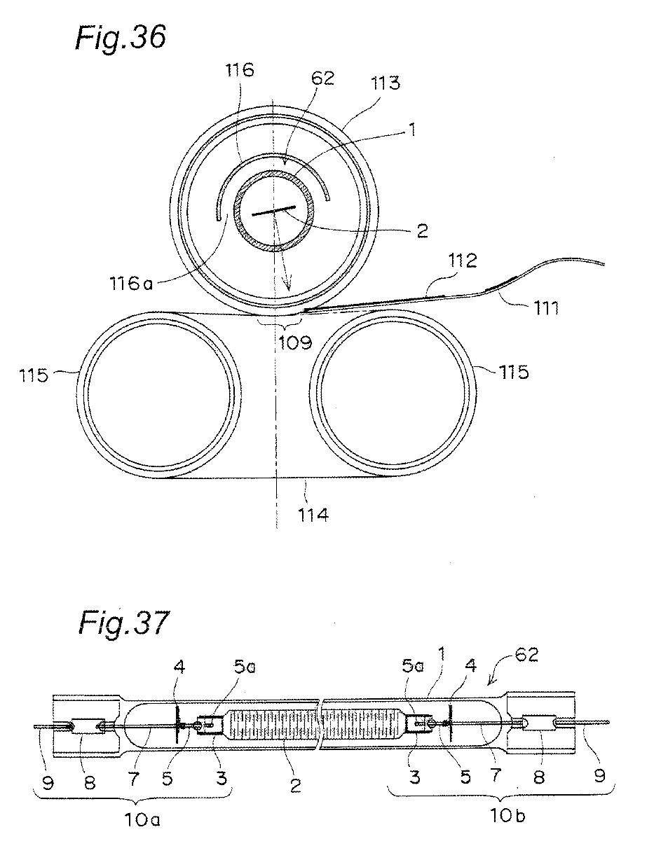

A description will be given of an image fixing apparatus according to embodiment 13 of the present invention with reference to FIGS. 36 to 38.

In an image forming process of the image forming apparatus, an electrostatic latent image designated by an exposure apparatus is formed on a surface of a photosensitive drum which is uniformly sealed by a sealing apparatus, and a toner image is formed by a developing apparatus in correspondence to the electrostatic latent image. The toner image formed on the photosensitive drum surface is transferred onto a member to be recorded such as conveyed paper or the like by a transfer apparatus. The member to be recorded, for example, the paper carrying an unfixed toner image transferred as mentioned above is conveyed to the image fixing apparatus carrying out the image fixing. The image fixing apparatus pressurizes and heats the member to be recorded carrying the unfixed toner image so as to fix the unfixed toner image on the member to be recorded.

A description will be given of an image forming process of a single color image in embodiment 13. In the case of the image forming process of the color image, four sets of the photosensitive drums mentioned above are provided in line in such a manner as to correspond to four color toners, and are structured such that the toner image of each of the colors is sequentially transferred to the transfer belt, and the color image is sequentially transferred on the member to be recorded. The color image transferred onto the member to be recorded is pressurized and heated so as to be fixed in the image fixing apparatus.

FIG. 36 is a view showing a main structure in the image fixing apparatus according to embodiment 13. As mentioned above, the image fixing apparatus heats at a high temperature a member 111 to be recorded carrying an unfixed toner image 112 as well as pressurizing, melts the unfixed toner image 112, and fixes to the member 111 to be recorded, in the image forming process.

In FIG. 36, the image fixing apparatus according to embodiment 13 is provided with a fixing roller 113 that is a heating body heating the unfixed toner image 112 carried on the member 111 to be recorded so as to melt, a pressurizing belt 114 pressing the member 111 to be recorded carrying the unfixed toner image 112 to the fixing roller 113 so as to pressurize, and pressure-fixing the unfixed toner image 112 to the member 111 to be recorded, and two pressurizing rollers 115 and 115 turning the pressurizing belt 114 so as to press to the fixing roller 113 by a desired force. In the image fixing apparatus according to embodiment 13, a pressuring body is constructed by the pressurizing belt 114 and the pressurizing roller 115.

In the image fixing apparatus according to embodiment 13, the structure is made such that the member 111 to be recorded is conveyed by the pressurizing belt 114 to a nip portion 109 that is a fixing region so as to be pressurized and fixed, however, the structure may be made such that the member 111 to be recorded is pressed to the fixing roller 113 by the pressurizing roller 115 arranged opposed to the fixing roller 113 so as to be pressurized. Further, in the image fixing apparatus according to embodiment 13, the description is given of the example in which the heating body is constructed by the fixing roller 113, however, the heating body may be constructed by a belt turned by the roller.

As shown in FIG. 36, the heat generation unit 62 having the heat generator 2 is provided in an inner portion of the fixing roller 113. In the heat generation unit 62, the heat generator 2 is a heat source for heating the fixing roller 113, and the heat generator 2 is sealed in the inner portion of the container 1. A tubular reflective portion 116 having an opening is provided around the long container 1 sealing the heat generator 2 therein. The reflective portion 116 is made of stainless steel, and an inner surface thereof is mirror-finished. An opening 116a formed in the reflective portion 116 is extended in parallel to the longitudinal direction of the heat generator 2. The opening 116a of the reflective portion 116 is an opening for radiating the heat radiated from the heat generator 2 toward the nip portion 109 in the fixing region by the fixing roller 113 and the pressurizing belt 114 together with the heat reflected in the inner surface of the reflective portion 116. In the image fixing apparatus according to embodiment 13, the opening of the reflective portion 116 is directed in such a manner that the region heated by the heat generation unit 62 comes to a most upstream side in the conveying direction of the member 111 to be recorded in the nip portion 109. Further, the band surface that is the flat surface side of the band-like heat generator 2 of the heat generation unit 62 is directed to a most upstream side in the conveying direction of the member 111 to be recorded in the nip portion 109.

A description will be given of the structure in which the reflective portion 116 is provided around the heat generation unit 62 in the image fixing apparatus according to embodiment 13, however, the image fixing apparatus according to the present invention may be structured such that the fixing roller 113 around the heat generation unit 62 is heated by the heat generation unit 62 without providing the reflective portion.

In the image fixing apparatus according to embodiment 13, the fixing roller 113 is constructed by a plurality of layers, in such a manner that the heat radiated from the heat generation unit 62 is absorbed efficiently in the fixing roller 113, and can be kept warm. An infrared absorption layer absorbing heat (an infrared ray) from the heat generation unit 62 without reflecting is provided in the inner surface of the fixing roller 113.

In the image fixing apparatus according to embodiment 13, a description will be given of an example in which a single heat generation unit 62 is provided, however, a plurality of heat generation units 62 may be provided. In the case where a plurality of heat generation units 62 are provided, each of center axes which are in parallel to the longitudinal direction in the heat generation unit 62 is arranged so as to be orthogonal to a conveying direction of the member 111 to be recorded and be on a straight line. The image fixing apparatus in which a plurality of heat generation units 62 are provided in the inner portion of the fixing roller 113 as mentioned above is structured such that the heat generation unit 62 to be supplied power can be selected in correspondence to a size of the member 111 to be recorded. Since the heat generation unit 62 using the image fixing apparatus according to the present invention is the film sheet-like band body, a heat radiation amount from the band surface that is the flat surface portion is very large in comparison with the heat radiation amount from the side surface portion, and a high directivity is provided. Accordingly, in the image fixing apparatus provided with a plurality of heat generation units 62, it is possible to set small a region which is heated in an overlapping manner by the adjacent heat generation units 62, and it is possible to heat a portion near the nip efficiently and uniformly.

Further, in the image fixing apparatus according to embodiment 13, since the film sheet-like heat generator 2 used in the heat generation unit 62 has a high directivity as mentioned above, and the excellent rising edge characteristic is provided, regardless of the single number or the plural number of the heat generation unit 62 being provided, it is possible to carry out the image fixing process in the image forming process with high efficiency and at a high speed.

In the heat generation unit 62 of the image fixing apparatus according to embodiment 13, the film sheet-like elongated band-like heat generator 2 is arranged in the inner portion of the elongated container 1 having the heat resistance. The elongated band-like heat generator 2 is arranged so as to be extended along the longitudinal direction of the container 1. In the heat generation unit 62, the container 1 is formed by the transparent quartz glass tube, and both end portions of the quartz glass tube is deposited like a flat plate and the container 1 is sealed. The argon gas serving as the inert gas is charged in the inner portion of the container storing the heat generator 2 and the like. The inert gas which can be charged in the inner portion of the container is not limited to the argon gas, and the same effect as the present invention can be achieved even by using the nitrogen gas or the mixed gas of the argon gas and the nitrogen gas, the argon gas and the xenon gas, the argon gas and the krypton gas, and the like, in addition to the argon gas, and it is possible to appropriately select the gas in correspondence to the purpose. The inert gas is charged in the inner portion of the container 1 for the purpose of preventing the heat generator 2 that is the carbon-based substance in the inner portion of the container from being oxidized, when being used at a high temperature. As the material of the container 1, it is possible to employ any material having the heat resistance, the insulating property and the heat permeability, and the material can be appropriately selected, for example, from the glass material such as the soda lime glass, the borosilicate glass, the lead glass and the like, the ceramic materials and the like, in addition to the quartz glass.

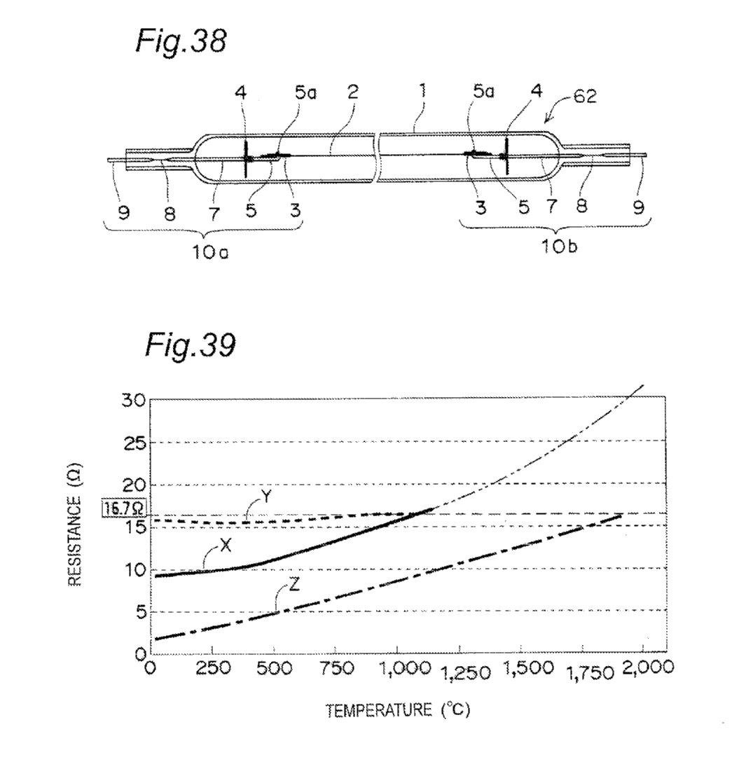

FIG. 37 is a plan view showing the heat generation unit 62 in the image fixing apparatus according to embodiment 13. FIG. 38 is a front view of the heat generation unit 62 in FIG. 37. The structure of the heat generation unit 62 shown in FIGS. 37 and 38 is one example in the heat source of the image fixing apparatus according to the present invention, and the present invention is not limited to this structure. The heat source in the image fixing apparatus according to the present invention includes the film sheet-like heat generator 2 mentioned below, and the other structures in the heat generation unit 62 can be appropriately set in accordance with the product specification and the like.

As shown in FIGS. 37 and 38, the heat generation unit 62 in the image fixing apparatus according to embodiment 13 is provided with the container 1, the elongated band-like heat generator 2 serving as the heat radiation membrane body, and the first and second power supply portions 10a and 10b which are provided in both end portions in the longitudinal direction of the heat generator 2 for holding the heat generator 2 at the predetermined position within the container and are provided for supplying the power to the heat generator 2.

The power supply portions 10a and 10b provided in the both ends of the heat generator 2 include the holders 3, the support rings 4, the fixed portions 5, the internal lead wires 7, the molybdenum foils 8 and the external lead wires 9 which are attached to the both ends of the heat generator 2. The fixed portions 5 connected to the lead wires 7 are fixed to the holders 3, and the internal lead wires 7 are electrically connected to the external lead wires 9 derived out of both ends of the container 1 to the outer portion of the container via the molybdenum foils 8 embedded in the sealed portions (the deposited portions) in the both end portions of the container 1.

As shown in FIGS. 37 and 38, the support ring 4 that is the position regulating portion having the position regulating function is attached to the fixed portion 5 connected to the internal lead wire 7. The internal lead wire 7 and the fixed portion 5 are obtained by forming one wire rod, for example, the molybdenum wire in a coil shape.

The internal lead wire 7 and the fixed portion 5 according to embodiment 13 are described by the example in which they are formed by the molybdenum wire, however, may be formed by using the metal wire (having the round shape or the flat plate shape) made of tungsten, nickel, stainless steel or the like.

As mentioned above, in the heat generation unit 62 of the image fixing apparatus according to embodiment 13, the power supply portions 10a and 10b constructed by the holders 3, the support rings 4, the fixed portions 5, the internal lead wires 7, the molybdenum foils 8 and the external lead wires 9 are provided in the both sides of the heat generator 2, and are provided with the heat generator 2 in a tension manner at a predetermined position within the container as well as supplying the power to the heat generator 2.

The end portion of the heat generator 2 is pinched in the flat surface side and the back surface side by the holder 3, and the through hole formed approximately in the center of the holder 3 and the through hole formed in the end portion of the heat generator 2 are passed through by the heat generator side end portion of the fixed portion 5. The fixed portion 5 is formed in a so-called L-shape by being bent in its heat generator side end portion. The leading end of the L-shaped bent fixed portion 5 passes through the through hole of the holder 3 pinching the heat generator 2 so as to protrude.

The fall-out preventing means (the dropout preventing means) is provided in the protruding end portion 5a of the fixed portion 5 protruding from the through hole of the holder 3. As shown in FIG. 38, the protruding end portion 5a of the fixed portion 5 is in a state of being plastically deformed by the press working, the melting or the like so as to be crushed. In other words, the protruding end portion 5a in the fixed portion 5 is worked in a shape larger than the diameter of the through hole of the holder 3, and the fall-out preventing means is provided therein.

The support ring 4 of the heat generation unit 62 is wound around the fixed portion 5 so as to be fixed, and is formed in the coil shape.

The support ring 4 is structured so as to be wound around and attached to the fixed portion 5 for supplying the power to the heat generator 2, and is structured such that the current path from the external lead wire 9 to the heat generator 2 does not pass through the support ring 4. In other words, the support ring 4 is structured such that the current path in the fixed portion 5 is not interposed. As mentioned above, since the support ring 4 is structured such that the current to the heat generator 2 does not flow, the support ring 4 does not generate heat by the current applied to the heat generator 2. The support ring 4 according to embodiment 13 has the position regulating function of the heat generator 2, and serves as the heat dissipation function dissipating the heat conducted from the heat generator 2.

The support ring 4 is described by the example in which it is formed by the molybdenum wire, however, it is possible to use any material as the support ring 4, as long as the material has such a rigidity as to regulate the position of the heat generator 2, has excellent heat conduction (heat dissipation function) and is easy to be processed, for example, the metal material such as nickel, stainless steel, tungsten and the like can be used. It should be noted that the support ring 4 is not a structural element which is always necessary in some structure and specification in the heat generation unit 62, such as a length of the heat generator 2, a dimensional difference between an inner diameter of the container 1 and the heat generator 2, and the like.

In the heat generation unit 62, since the material itself of the heat generator 2 has elasticity, and the shape pattern of the heat generator 2 has the elasticity, a mechanism for absorbing the change caused by the expansion and contraction in the heat generator 2 is not necessary. Particularly, since the heat generator 2 used in embodiment 13 has a small coefficient of thermal expansion, the heat generator 2 arranged (provided in the tension manner) in a state where the tensional force is applied at the time of manufacturing can absorb the expansion at the time of generating heat by the elasticity of the heat generator itself and the shape pattern of the heat generator 2.

The heat generator 2 used in the heat generation unit 62 of the image fixing apparatus according to embodiment 13 of the present invention is structured such that each of the layers of a plurality of film sheet raw materials is laminated with each other via an interval in a thickness direction while having the carbon-based substance as the main component, has an excellent two-dimensional isotropic thermal conductivity, and is formed by the film sheet-like material having the coefficient of thermal conductivity equal to or more than 200 W/m·K. Accordingly, the band-like heat generator 2 becomes the heat source having no temperature irregularity and uniformly generating heat.

The film sheet raw material that is the material of the heat generator 2 is a high orientation graphite film sheet formed as a graphite by heat treating the high polymer film or the high polymer film to which the filler is added, in the ambient atmosphere at a high temperature, for example, 2400° C. or higher, and sintering, and the coefficient of thermal conductivity in the surface direction is equal to or more than 200 W/m·K, and particularly the coefficient of thermal conductivity of the heat generator 2 according to the present invention shows a characteristic between 600 and 950 W/m·K.

Since the film sheet raw material that is the material of the heat generator 2 used in the present invention is described in detail in embodiment 1 mentioned above, it is described briefly herein. The heat generator 2 is structured such that a plurality of membrane bodies formed by the material including the carbon-based substance are laminated, has an interlayer structure in which a laminating direction is partly attached firmly, and is a film sheet raw material having flexibility in the thickness direction. Accordingly, the film sheet raw material that is the material of the heat generator 2 in the present invention is a material having an excellent two-dimensional isotropic thermal conductivity in which the coefficient of thermal conductivity in the surface direction is uniform.

Since the definition relating to “two-dimensional isotropic thermal conductivity” showing the characteristic of the heat generator in the present invention is described in embodiment 1 and embodiment 5 mentioned above, the description will not be given herein.

Further, since the high polymer film used as the film sheet raw material of the heat generator 2, and the filler added to the high polymer film are specifically described in embodiment 5 and the like mentioned above, the description will not be given herein.

The film sheet-like heat generator is manufactured by laminating the film sheet raw material, treating at 2400° C. or higher in the inert gas and regulating the pressure of the gas treatment atmosphere generated in the process of forming graphite. Further, it is possible to obtain a better film sheet-like heat generator by rolling the film sheet-like heat generator manufactured as mentioned above, as necessary. The film sheet-like heat generator manufactured as mentioned above is used as the heat generator 2 in the heat generation unit according to the present invention.

As an adding amount of the filler, a range between 0.2 and 20.0% by weight is preferable, and a range between 1.0 and 10.0% by weight is more preferable. An optimum adding amount is different in accordance with the thickness of the high polymer, a more adding amount is preferable in the case where the thickness of the high polymer is thin, and the adding amount can be reduced in the case where the thickness of the high polymer is thick. A role of the filler is to set the film after the heat treatment to a uniformly foamed state. In other words, the added filler generates the gas during heating, and a cavity after the gas is generated becomes a path so as to assist gentle passage of a cracked gas from the inner portion of the film. The filler serves for preparing the uniform foamed state as mentioned above.

The film sheet raw material manufactured as mentioned above is worked in a desired shape by a trimming die such as a Thomson die and a Pinnacle die, a sharp-edged tool such as a rotary die cutter, or a laser processing or the like.

As shown in FIG. 37, a plurality of cut lines that are current suppressing portions are provided in the heat generating portion of the heat generator 2 according to embodiment 13 so as to extend in a direction which is orthogonal to the longitudinal direction of the heat generator 2. A plurality of current suppressing portions formed in the heat generating portion are structured so as to control the current flowing direction in the heat generating portion and regulate the resistance value. As a shape of the current suppressing portions formed in the heat generating portion, there are a penetrating groove (slit), a closed-end groove and the like, in correspondence to the product specification and the intended use in which the heat generation unit 62 is used. Further, in the concave portion groove that is the closed-end groove, it is possible to regulate the resistance value of the heat generating portion by changing a depth in the thickness direction.

Further, by forming the cut line (the groove or the slit) that is the current suppressing portion in the heat generator 2 according to embodiment 13, the heat generator 2 has a characteristic of having great elasticity due to elasticity obtained by forming the cut line along with the elasticity of the heat generator itself.

A description will be given below of a characteristic of the heat generator 2 of the heat generation unit 62 used as the heat source in the image fixing apparatus according to embodiment 13 of the present invention in comparison with the conventional image fixing apparatus.

First, a description will be given of the heat source used in the conventional image fixing apparatus.

A halogen heater used as the heat source in the conventional image fixing apparatus has such an advantage that a rising edge at the time of supplying the power is fast. However, the halogen heater has a great rush current, requires a large-capacity control circuit for turning on and off the halogen heater, and has a problem in cost as well as an enlargement in size of the apparatus. Further, there is such a problem that a fluorescent lamp that is a nearby lighting apparatus flickers (a flicker phenomenon) by controlling the halogen heater.

Further, since the rush current is hardly generated in the carbon heater, the problem that the voltage falls at the time of supplying the power to the heat generator, and the problem that the fluorescent lamp flickers (the flicker phenomenon) are reduced. However, the carbon heater has such problems that it takes a lot of time to rise, it takes a lot of time to carry out the fixing process in the image forming process, and energy consumption at the time of the fixing process is increased.

On the other hand, in the carbon heater using the plate-like heat generator formed by the crystallized carbon such as the black lead and the like, or the mixed material of the resistance value regulating material and the amorphous carbon, since infrared radiation efficiency of the carbon-based substance is high between 78 and 84%, the infrared radiation efficiency from the carbon heater becomes higher by using the carbon-based substance as the heat generator, and it is possible to construct the heat source having high efficiency. However, the heat generator used as the carbon heater is the plate-like heat generator having a thickness (for example, some mm), has a certain degree of great heat capacity, and has such a problem that it takes a lot of time to rise at the time of supplying the power.

Further, the heat generator used as the carbon heater has such a temperature resistance characteristic that the resistance value is approximately constant regardless of the temperature of the heat generator, and the rush current is hardly generated. In the heat generator used as the conventional carbon heater as mentioned above, since the rush current is hardly generated, the problem that the voltage falls at the time of supplying the power to the heat generator, and the problem that the fluorescent lamp flickers (the flicker phenomenon) are reduced. However, in the case where the heat generator is used as the heat source, there are such problems that it takes a lot of time to rise, it takes a lot of time to carry out the fixing process in the image forming process, and the energy consumption is increased at the time of carrying out the fixing process.

The inventors of the present invention have carried out comparative experiments of a temperature characteristic showing a relationship between a temperature (° C.) and a resistance [Ω] by constructing a heater having specification of 100 V and 600 W, in connection with the heat generator 2 of the heat generation unit 62 used in the image fixing apparatus according to embodiment 13 of the present invention, the heater (hereinafter, referred to as the carbon heater for short) using the elongated plate-like heat generator using the carbon-based substance employed as the heat source in the conventional image fixing apparatus as the main component, and the heater (hereinafter, referred to as the halogen heater for short) using the halogen lamp as a reference example.

FIG. 39 is a temperature characteristic diagram showing a relation between the temperature [° C.] and the resistance [Ω] in the heat generator 2 of the heat generation unit 62, the carbon heater that is the conventional heat source, and the halogen heater. In FIG. 39, a solid line X is the temperature characteristic of the heat generator 2 of the heat generation unit 62 used in the image fixing apparatus according to the present invention. Further, in FIG. 39, a broken line Y is the temperature characteristic of the carbon heater, and a one-dot chain line Z is the temperature characteristic of the halogen heater as the reference example.

As shown in FIG. 39, the heat generator 2 of the heat generation unit 62 used in the image fixing apparatus of embodiment 13 according to the present invention has a positive characteristic that the resistance is increased as the temperature becomes higher. According to the experiments, for example, the resistance value was 9.2Ω when the temperature of the heat generator 2 was 20° C. (a non-energized state), and the resistance value was 16.7Ω when the temperature at a balanced lighting state was 1120° C. Accordingly, a rate of change of the resistance value (a rate of resistance change) between the non-energized state and the balanced lighting state of the heat generator 2 is 1.81. The balanced lighting state herein means a state where the power is supplied and the current flows in the heat generator by applying the Voltage (for example, 100 V) to the heater, so that the heat generation temperature of the heat generator becomes constant. Further, the rate of resistance change means a value obtained by dividing the value of the resistance at the balanced lighting state brought by energization in the heat generator by the value of the resistance at the non-energized state.

On the other hand, the temperature characteristic of the carbon heater shown by the broken line Y that is the conventional heat generator shows an approximately constant resistance value even if the temperature changes. In accordance with the experiments by the inventors, the resistance value was 15.9Ω when the temperature of the carbon heater was 20° C. (the non-energized state), and the resistance value was 16.7Ω when the temperature at the balanced lighting state was 1030° C. Accordingly, the rate of resistance change between the non-energized state and the balanced lighting state of the carbon heater is 1.05. Further, in the case of the halogen heater shown by the one-dot chain line Z, the resistance value was 1.8Ω when the temperature was 20° C. (the non-energized state), and the resistance value was 16.7Ω when the temperature at the balanced lighting state was 1830° C. Accordingly, the rate of resistance change between the non-energized state and the balanced lighting state of the halogen heater is 9.28.

Even in the case where the power is supplied in such a manner that the temperature at the balanced lighting state becomes 500° C. by using the heat generator 2 used in the image fixing apparatus according to embodiment 13, the rising characteristic shown by the solid line X in FIG. 39 is obtained, and the resistance value at the time of 500° C. was 11.0Ω. Accordingly, the rate of resistance change between the non-energized state and the balanced lighting state of the heat generator 2 is 1.2 (=11.0/9.2).

Further, in the case where the power is supplied in such a manner that the temperature at the balanced lighting state becomes 2000° C. by using the heat generator 2 used in the image fixing apparatus according to embodiment 13, the rising characteristic shown by a two-dot broken line continuing from the solid line X in FIG. 39 is obtained, and the resistance value at the time of 2000° C. was 32.2Ω. Accordingly, the rate of resistance change between the non-energized state and the balanced lighting state of the heat generator 2 is 3.5 (=32.2/9.2).

As mentioned above, the heat generator 2 of the heat generation unit 62 used in the image fixing apparatus according to embodiment 13 has a positive characteristic that the resistance is increased as the temperature becomes higher. For example, in the case where the temperature setting at the balanced lighting state is set to 500° C., the resistance value at the balanced lighting state became 11.0Ω and the rate of resistance change was 1.2. Further, in the case where the temperature setting at the balanced lighting state is set to 2000° C., the resistance value at the balanced lighting state became 32.2Ω and the rate of resistance change was 3.5, whereby the temperature and the resistance value show an approximately proportional characteristic.

Further, in the heat generator 2 of the heat generation unit 62 used in the image fixing apparatus according to embodiment 13, the rate of resistance change obtained by dividing the resistance value at the balanced lighting state brought by the rated energization by the resistance value at the non-energized state was 1.81. As mentioned above, the heat generator 2 of the heat generation unit 62 used in the image fixing apparatus according to the present invention has a certain degree of resistance (9.2Ω) even at the non-energized state, and the rate of resistance change between the non-energized state and the balanced lighting state is 1.81.

The heat generator 1 of the heat generation unit 62 according to the present invention can precisely generate heat at a desired temperature by setting the power or the heater temperature in such a manner that the rate of resistance change is in a range between 1.2 and 3.5, and has an effect of quickening the rising edge at the time of generating heat, without generating any great rush current when the heat generation unit 12 is turned on. When the rate of resistance change between the non-energized state and the balanced lighting state is within the range between 1.2 and 3.5, the rising edge at the time of generating heat becomes faster, and the apparatus for controlling the heat generation unit 62 does not require a great capacity as mentioned below. In the case of using the heat generator in which the rate of resistance change is less than 1.2, there is obtained the image fixing apparatus in which the temperature is low, the rush current is small and the rising edge is slow. On the other hand, in the case of using the heat generator in which the rate of resistance change exceeds 3.5, a large rush current is generated, and it is necessary to set large an allowable margin of each of the structural elements for securing reliability, so that the capacity of the structural element is increased, and there is generated such a problem that the manufacturing cost is increased and the apparatus is enlarged in size.

On the other hand, in the case of using the carbon heater as the heat source, since the resistance value is approximately constant regardless of the temperature, the rush current is not generated at the time of lighting, and an approximately constant current flows. Accordingly, in the case of using the carbon heater as the heat source, a climbing speed (a rising edge) of a heat generating temperature is slow, and there is such a problem that it takes a lot of time to reach a predetermined temperature. Accordingly, in the case of being used as the heat source of the image fixing apparatus, there are such problems that it takes a lot of time until the nip portion comes to a desired temperature, it takes a lot of time to carry out the image fixing process, and it takes a lot of time to perform a so-called quick start.

A specific resistance value of the heat generator 2 of the heat generation unit 62 is 250 μΩ·cm, a specific resistance value of the carbon of the carbon heater is 3000 to 50000 μΩ·cm, and a specific resistance value of the tungsten of the halogen heater is 5.6 μΩ·cm. As mentioned above, since the specific resistance value of the carbon is very high in comparison with the materials of the other heaters, it is possible to design such that the rush current is hard to be generated at the time of supplying the power as well as designing such that the current change is small. Further, although the specific resistance value of the heat generator 2 is smaller than the specific resistance value of the carbon, it is larger than the specific resistance value of the tungsten, designing is easy in the heat generator 2 in comparison to the heat generator of the tungsten.

Further, a density of the heat generator 2 of the heat generation unit 62 is between 0.5 and 1.0 g/m³ (which is different in accordance with the thickness), a density of the carbon of the carbon heater is 1.5 g/m³, and a density of the tungsten of the halogen heater is 19.3 g/m³. As mentioned above, it is understood that since the density of the heat generator 2 is lighter in comparison with the materials of the other heaters, and since the heat generator 2 is constructed by the elongated band-like thin membrane body, the heat capacity is very small in comparison with the other heaters, and the rising edge becomes fast.

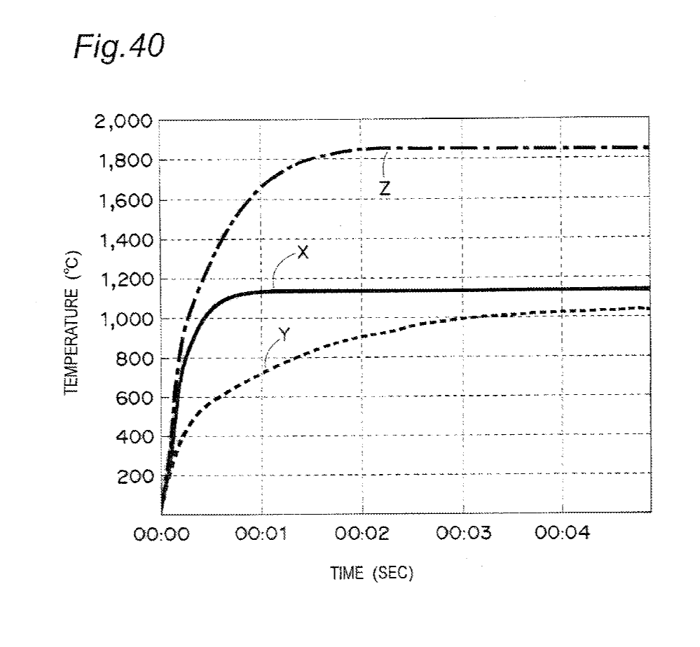

FIG. 40 is a graph showing a result obtained by searching the rising characteristics of the heat generation unit 62 used in the image fixing apparatus according to the present invention, and the carbon heater and the halogen heater which are the conventional heaters.

In FIG. 40, a solid line X is a rising characteristic of the heat generation unit 62 used in the image fixing apparatus according to the present invention. Further, in FIG. 40, a broken line Y is a rising characteristic of the carbon heater using the elongated plate-like heat generator having the carbon-based substance mentioned above as the main component, and a one-dot chain line Z is a rising characteristic of the halogen heater using the halogen lamp. In the characteristic diagrams shown in FIG. 40, there are shown the rising characteristics from the lighting to five seconds later by using the heaters having the structure of the specification of 100 V and 600 W.

As can be seen from the respective rising characteristics in FIG. 40, the rising characteristic (the solid line X in FIG. 40) of the heat generation unit 62 used in the image fixing apparatus according to the present invention shows a faster rising edge in comparison with the rising characteristic of the carbon heater (the broken line Y in FIG. 40) that is the conventional heat source. In accordance with the experiments by the inventors, a 90% arrival time of the temperature at the balanced lighting state was 0.6 seconds in the heat generation unit 62, where it was 2.7 seconds in the carbon heater. Further, a 90% arrival time in the case of the halogen heater was 1.1 seconds.

As mentioned above, since the rising time to the balanced lighting state is different in the heat generation unit 62, the carbon heater and the halogen heater, the power consumed for the rising time greatly differs. For example, on the assumption that 6 A is consumed in spite that the current changes at the starting time in each of the heaters used in the experiments mentioned above, since a time until the temperature at the balanced lighting state reaches 90% is 0.6 seconds in the heat generation unit 62, power consumption for the time is about 360 W·S. On the other hand, since a time until the temperature at the balanced lighting state reaches 90% is 2.7 seconds in the carbon heater, power consumption for the time is about 1620 W·S. Further, since a time until the temperature at the balanced lighting state reaches 90% is 1.1 seconds in the halogen heater, power consumption for the time is about 600 W·S.

As mentioned above, the power consumption until the balanced lighting state in the heat generation unit 62 is substantially smaller in comparison with the other heaters. Accordingly, since the fixing process is frequently carried out and the on and off operation is repeated in the image fixing apparatus, the difference of the power consumption becomes very large, and the energy consumption is greatly reduced.

The arrival time is comparatively short in the halogen heater because the resistance value at the non-energized state is low, and the great rush current is generated at an early state of the power supply, as shown in FIG. 39. The power consumption in the halogen heater mentioned above is calculated on the assumption that 6 A is consumed, however, since the great rush current flows actually in a stable period between 0 and 5 seconds in an early state of the power supply of the halogen heater, the power consumption for the period becomes a greater value.

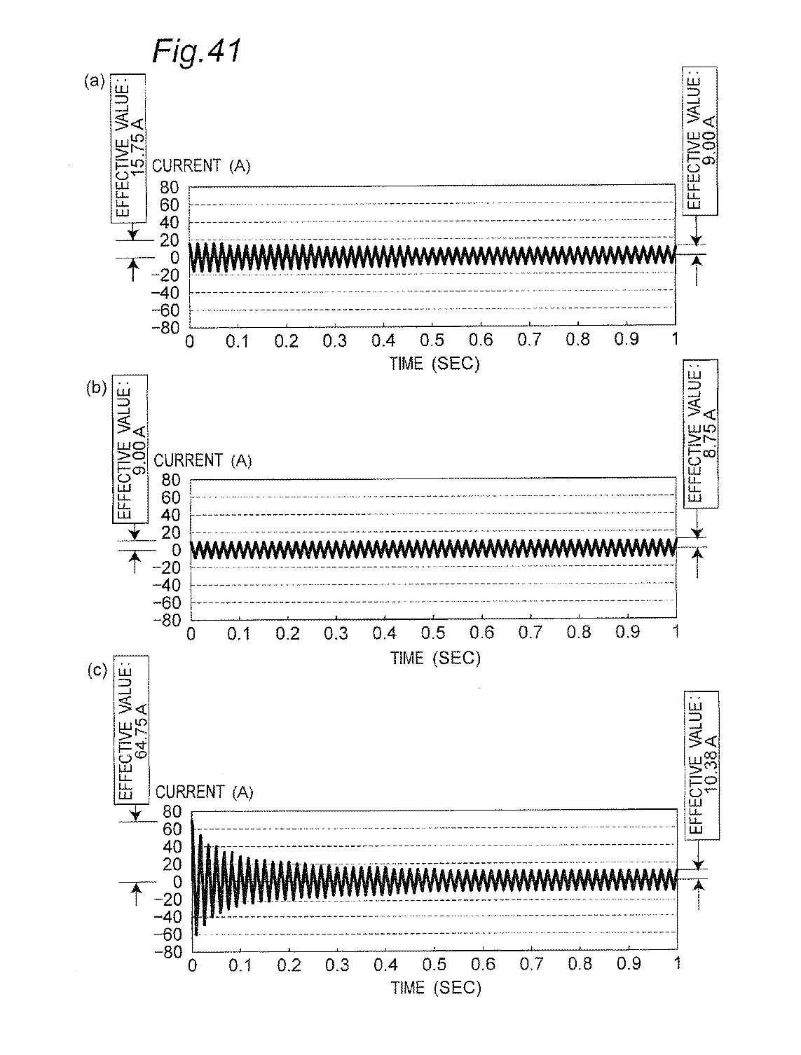

FIGS. 41(a) to 41(c) are views comparing the rush current at an early stage of the power supply in each of the heaters, and shows a current waveform from the early stage of the power supply to 1.0 second later. In FIGS. 41(a) to 41(c), FIG. 41(a) is a current waveform at the time when the heat generation unit 62 used in the image fixing apparatus according to the present invention rises, FIG. 41(b) is a current waveform when the conventional carbon heater rises, and FIG. 41(c) is a current waveform when the halogen heater rises.

As shown in FIG. 41(a), in the heat generation unit 62 used in the image fixing apparatus according to the present invention, an effective value of the current at the early stage of supplying the power was 15.75 A, and an effective value of the current 1.0 second after the early stage of supplying the power was 9.00 A. In other words, the generation of the rush current is recognized in the heat generation unit 62, however, a magnitude thereof is equal to or less than twice the magnitude of the current at the balanced lighting state.

In the case of the carbon heater shown in FIG. 41(b), the rush current was hardly generated, the effective value of the current at the early state of supplying the power was 9.00 A, and the effective value of the current 1.0 second after the early state of supplying the power was 8.75 A. On the other hand, in the case of the halogen heater shown in FIG. 41(c), a great rush current was generated, the effective value of the current at the early stage of supplying the power was 64.75 A, and the effective value of the current 1.0 second after the early stage of supplying the power was 10.38 A. Since the halogen heater has a value five times or more greater than the rate of resistance change between the non-energized state and the balanced lighting state is 9.27 as shown in FIG. 39 mentioned above, the great rush current is generated. The generation of the great rush current as mentioned above has such a characteristic that the rising edge becomes fast, and also has such a problem that it is necessary to use the large capacity element which can stand the great current in the apparatus using the halogen heater. For example, a thyristor serving as a switching element requires a great current capacity, and it is necessary to use a contact point having a great interrupting capacity in such a manner as to prevent a mechanical contact point from being deposited by a great current. Further, since it is hard to carry out the voltage control in the halogen heater in accordance with its heat generating principle (a halogen cycle), and the halogen heater only carries out on-off switching control, there is such a problem that the temperature cannot be accurately controlled.

As mentioned above, since the heat generation unit 62 used in the image fixing apparatus according to the present invention has such a characteristic that the rate of change between the non-energized state and the balanced lighting state is 1.81, and a certain degree of rush current is generated, the rising edge becomes fast, the time until the balanced lighting state becomes short, and it becomes a heat source having an excellent response. Accordingly, since the heat generation unit 62 is used as the heat source of the image fixing apparatus, it is possible to enhance the performance as the image fixing apparatus, and it is possible to provide an apparatus which can save energy while having reduced energy consumption.

Further, since the heat generation unit 62 used in the image fixing apparatus according to the present invention has such a characteristic that does not generate any great rush current as the halogen heater, it is not necessary to use a large-capacity structure which can stand a large current for the apparatus using the heat generation unit 62, and it is possible to achieve a reduction of a manufacturing cost and downsizing. The great rush current herein means that the current at an early stage of supplying the power is five times or more than the current 1.0 second after the early stage of supplying the power.

In the heat generation unit 62 used in the image fixing apparatus according to the present invention, the current at the early stage of supplying the power becomes equal to or less than 3.5 times of the current 1.0 second after the early stage of supplying the power. As mentioned above, the heat generation unit 62 becomes a heat source having an early rising edge and having an excellent response by setting such that the current at the early stage of supplying the power becomes equal to or less than 3.5 times of the current 1.0 second after the early stage of supplying the power. Further, it is not necessary to use a large capacity structure which can stand a large current for the apparatus using the heat generation unit 62, in the heat generation unit 62, and it is possible to achieve a reduction of the manufacturing cost and downsizing of the apparatus.

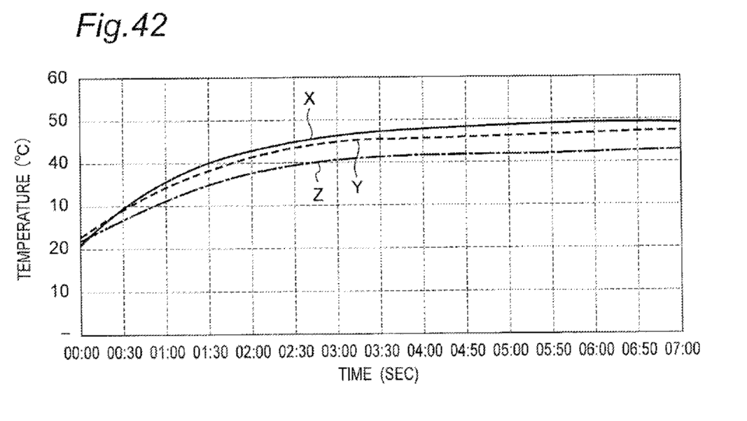

FIG. 42 shows a result of measurement of a copper plate temperature when heating a copper plate as the object to be heated by each of the heaters including the heat generation unit 62, the carbon heater and the halogen heater. In FIG. 42, a solid line X is a temperature rising curve of the copper plate by the heat generation unit 62, a broken line Y is a temperature rising curve of the copper plate by the carbon heater, and a one-dot chain line Z is a temperature rising curve of the copper plate by the halogen heater.

In the copper plate temperature measuring experiments shown in FIG. 42, the copper plate piece as the object to be heated having a dimension of 65 mm (L)×65 mm (W)×0.5 mm (t) was used, and black paint was applied to a heating surface opposed to the heater that is the heating body. Each of the heaters is a long heater having a length of 300 mm, and a structure having the specification of 100 V and 600 W was used. An opposed distance between the copper plate and the heater was 300 mm, and a thermo couple was attached to a back surface that is the opposed side to the heating surface of the copper plate piece so as to measure the copper plate temperature.

As shown in FIG. 42, the heat generation unit used in the image fixing apparatus according to the present invention raises the temperature of the copper plate as the object to be heated in a quickest manner and heats to a high temperature, in spite of the same specification in comparison with the other heaters. The tungsten wire as the heat generating body comes to a high temperature in the halogen heater, however, radiation efficiency of the tungsten is low (about 0.18), and the temperature rise of the object to be heated is slow. The temperature rise of the carbon heater is quicker than the temperature rise of the halogen heater, however, it is slower than the temperature rise of the heat generation unit 62, and a balancing temperature is low. This is because the radiation efficiency of the heat generator 2 of the heat generation unit 62 is as high as 0.9 in comparison with the radiation efficiency 0.85 of the carbon. Accordingly, it can be understood that the heat generation unit 62 used in the image fixing apparatus according to the present invention can heat the object to be heated efficiently and quickly.

As mentioned above, the heat generator 2 used in the image fixing apparatus according to embodiment 13 has such an excellent characteristic that the heat capacity is small while being light and thin, and the rising edge to the balanced lighting state by energization is early. Accordingly, in the image fixing apparatus according to embodiment 13, since there is employed the heat generation unit 62 having the heat generator which has an excellent response and heats highly efficiently, it is possible to quickly heat the fixing region, it is possible to achieve energy saving, and it is possible to realize a quick start. Further, in the image fixing apparatus according to embodiment 13, since the great rush current is not generated at the lighting state in the early stage of heating, it is possible to solve such a problem that a voltage drop is generated, and a flicker of the fluorescent lamp is generated.

According to the present invention, it is possible to provide the image fixing apparatus and the image forming apparatus having the heat source having the high efficiency which can heat the member to be recorded that is the object to be heated in accordance with a desired heat arrangement distribution and to the high temperature. Particularly, according to the present invention, it is possible to provide the image fixing apparatus and the image forming apparatus which can carry out the fixing process in which the energy consumption is reduced, while the rising edge is fast.

### INDUSTRIAL APPLICABILITY

The present invention can provide a heat generation unit and a heating apparatus which can construct a heat source being high in safety and reliability and having high efficiency, and has high working efficiency and an excellent productivity, whereby the present invention is useful in various electronic and electric apparatus fields in which the heat source is necessary.

1. A heat generation unit comprising:
a heat generator having a heat generating portion;
a holder attached to an end portion of the heat generator;
a lead wire electrically connected to the holder so as to supply power from outside to the heat generator; and
the heat generator, the holder and the lead wire being arranged within a container,
wherein the holder has a first holding portion and a second holding portion which are arranged so as to be opposed to each other, through holes are respectively formed in the first holding portion and the second holding portion, and center axes of the through holes are arranged coaxially,
wherein an end portion of the heat generator has a locking through hole, and is arranged between the first holding portion and the second holding portion, whereby the locking through hole is arranged on the same axis as the center axes,
wherein a fixed portion having an engagement portion engaging with each of the through holes of the first holding portion and the second holding portion and the locking through hole in the end portion of the heat generator is provided, and
wherein the fixed portion has a first position regulating member for regulating a position of the first holding portion in one end side of the engagement portion arranged in an outer side surface of the first holding portion in which the end portion of the heat generator is not arranged, and a second position regulating member for regulating a position of the second holding portion in the other end side of the engagement portion arranged in an outer side surface of the second holding portion in which the end portion of the heat generator is not arranged, and is structured such that the end portion of the heat generator is held by the first holding portion and the second holding portion.

2. The heat generation unit according to claim 1, wherein the fixed portion connected to the lead wire bonded to the first holding portion is formed in such a manner as to engage with each of the through holes of the first holding portion and the second holding portion and the locking through hole in the end portion of the heat generator, and the second position regulating member is formed by plastically deforming a protruding end portion of the engagement portion protruding to an outer side from the through hole of the second holding portion while passing through the through hole of the first holding portion, whereby the end portion of the heat generator is held by the first holding portion and the second holding portion.

3. The heat generation unit according to claim 1, wherein the end portion of the heat generator is held by the first holding portion and the second holding portion by reducing a distance between the first position regulating member and the second position regulating member, whereby the heat generator comes to a crimped state.

4. The heat generation unit according to claim 1, wherein the through hole of the second holding portion is formed so as to be larger than an outer diameter of the fixed portion and smaller than the through hole of the first holding portion and the locking through hole, in the respective through holes of the first holding portion and the second holding portion and the locking through hole of the heat generator.

5. The heat generation unit according to claim 1, wherein a heat generator insertion port side edge portion of the first holding portion and the second holding portion holding the end portion of the heat generator is provided with a curved surface or an inclined surface which is open toward an outer side, or a no-burr portion from which the burr during working is deleted, as a fracture preventing portion preventing a fracture of the heat generator.

6. The heat generation unit according to claim 1, wherein the heat generator is constructed by a material having pliability, flexibility and resiliency.

7. The heat generation unit according to claim 1, wherein a conductive member having elasticity is arranged at least one of between the heat generator and the first holding portion, and between the heat generator and the second holding portion, in such a manner as to bring the heat generator into pressure contact.

8. The heat generation unit according to claim 1, wherein a member having elasticity is arranged between the first position regulating member and the second position regulating member.

9. The heat generation unit according to claim 1, wherein the lead wire is provided with a position regulating portion regulating a distance between an inner wall of the container and the heat generator.

10. The heat generation unit according to claim 1, wherein the lead wire is provided with a spring portion for absorbing expansion and contraction of the heat generator.

11. The heat generation unit according to claim 1, wherein an inert gas is filled within the container.

12. The heat generation unit according to claim 1, wherein the heat generator is formed in a film sheet shape in which a thickness is equal to or less than 300 μm.

13. A heating apparatus comprising the heat generation unit according to claim 1, wherein a reflective portion is provided at a position opposed to a heat dissipation surface of the heat generator in the heat generation unit.

14. A heating apparatus comprising the heat generation unit according to claim 1, wherein a tube body is arranged in such a manner as to surround a periphery of the heat generation unit.

15. The heating apparatus according to claim 13, wherein the heating apparatus has a control circuit carrying out power supply control of the heat generation unit, and the control circuit is constructed independently by each of circuits for on-off control, power supply ratio control, phase control and zero-cross control or combining at least two of the circuits.

16. The heating apparatus according to claim 14, wherein the heating apparatus has a control circuit carrying out power supply control of the heat generation unit, and the control circuit is constructed independently by each of circuits for on-off control, power supply ratio control, phase control and zero-cross control or combining at least two of the circuits.

17. A heat generation unit comprising:
a band-like heat generator formed as a film sheet by a material including a carbon-based substance, and having a two-dimensional isotropic thermal conductivity;
a power supply portion having a holder including a first holding portion and a second holding portion arranged so as to be opposed while having a contact surface holding both ends of the heat generator and formed by a conductive material, and a lead wire electrically connected to the holder, the lead wire having a retainer portion formed in the power supply portion, and supplying power to the both opposed ends in the heat generator; and
a container internally including the heat generator and a part of the power supply portion,
wherein the end portion of the heat generator is disposed between the first holding portion and the second holding portion, and a retainer receiving portion formed in the end of the heat generator is engaged with the retainer portion together with the first holding portion and the second holding portion.

18. The heat generation unit according to claim 17, wherein the retainer receiving portion of the heat generator is constructed by a through hole, through holes are formed at positions corresponding to the retainer receiving portion in the first holding portion and the second holding portion holding the both ends of the heat generator, and the retainer portion formed in the heat generator side end portion in the lead wire engages by passing through the retainer receiving portion of the heat generator, and the respective through holes of the first holding portion and the second holding portion.

19. The heat generation unit according to claim 17, wherein the retainer receiving portion of the heat generator is constructed by a through hole, a through hole is formed at a position corresponding to the retainer receiving portion in one of the first holding portion and the second holding portion holding the both ends of the heat generator, a projection is formed at a position corresponding to the retainer receiving portion in the other of the holder, and the projection in the holder engages by passing through the through hole of the holder together with the retainer receiving portion of the heat generator.

20. The heat generation unit according to claim 18, wherein the retainer portion of the lead wire is formed by bending the heat generator side end portion, and one through hole in the holder in which the bent portion of the retainer portion of the lead wire is arranged is formed larger than the other hole in which the leading end portion of the retainer portion is arranged, in the through hole formed in the first holding portion and the through hole formed in the second holding portion.

21. The heat generation unit according to claim 18, wherein a holding hole is formed at a position different from the through hole engaging with the retainer portion of the power supply portion, in one of the first holding portion and the second holding portion, the lead wire passes through the holding hole, and the lead wire holds the holder.

22. The heat generation unit according to claim 18, wherein the retainer portion of the lead wire is formed by bending the heat generator side end portion, and dropout preventing means is provided in the leading end portion of the retainer portion, in a state where the retainer portion is inserted to the through hole of the holder.

23. The heat generation unit according to claim 17, wherein the retainer receiving portion formed in the both ends of the heat generator is formed by a notch in an end edge of at least one of both end edges in a width direction of the heat generator, and the retainer portion of the power supply portion is formed by a side wall portion provided so as to extend in a longitudinal direction of the heat generator while being orthogonal to a surface coming into contact with the heat generator at a position corresponding to the retainer receiving portion in the holding portion.

24. The heat generation unit according to claim 23, wherein the side wall portion serving as the retainer portion of the holder is formed in one of the first holding portion and the second holding portion, and the protruding end portion of the side wall portion is attached so as to go around the other holding portion.

25. The heat generation unit according to claim 17, wherein the first holding portion and the second holding portion are constructed by bending one material so as to pinch the end portion of the heat generator.

26. The heat generation unit according to claim 17, wherein the heat generator has an interlayer structure formed by a material including a carbon-based substance.

27. The heat generation unit according to claim 17, wherein the container is formed by a glass tube or a ceramics tube having a heat resistance, and is filled with an inert gas so as to be sealed in the power supply portion.

28. A heat generation unit comprising:
a band-like heat generator formed in a film sheet shape in which a thickness is equal to or less than 300 μm, as a film sheet by a material including a carbon-based substance, and having a two-dimensional isotropic thermal conductivity;
a power supply portion supplying power to the both opposed ends in the heat generator; and
a container internally including the heat generator and a part of the power supply portion, and being filled with an inert gas so as to be sealed in the power supply portion,
wherein a position regulating portion is firmly attached to the power supply portion in an inner portion of the container and holds the heat generator at a predetermined position in the inner portion of the container, and a current path in the power supply portion is prevented from being formed in the position regulating portion.

29. The heat generation unit according to claim 28, wherein the power supply portion has a holder holding the both ends of the heat generator, and a lead wire electrically connected to the holder,
wherein the position regulating portion is a coil-shaped support ring firmly attached to the lead wire, and
wherein at least a part of an outer peripheral portion of the position regulating portion is arranged so as to come close to an inner peripheral surface of the container.

30. The heat generation unit according to claim 29, wherein at least a part of the portion to which the position regulating portion in the lead wire is deformed as compared to the other portions.

31. The heat generation unit according to claim 30, wherein the position regulating portion is constructed by a metal wire rod, and the position regulating portion is firmly attached by winding a part of the position regulating portion with respect to the lead wire.

32. The heat generation unit according to claim 30, wherein the lead wire is constructed by a wire rod, the position regulating portion is firmly attached to the deformed portion of the lead wire, and the deformed portion of the lead wire is structured such that a cross sectional area which is orthogonal to a current path flowing through the portion becomes equal to or more than 80% in comparison with a cross sectional area which is orthogonal to the current path in the other portion.

33. The heat generation unit according to claim 30, wherein the lead wire is constructed by a wire rod, and a portion of the lead wire to which the position regulating portion is firmly attached is bent.

34. The heat generation unit according to claim 30, wherein the retainer receiving portion formed in the both ends of the heat generator engages with the retainer portion formed in the lead wire, whereby the heat generator is provided in a tension manner in the inner portion of the container.

35. The heat generation unit according to claim 34, wherein the retainer receiving portion of the heat generator is constructed by the through hole, a through hole is formed at a position corresponding to the retainer receiving portion in the holder holding the both ends of the heat generator, and the retainer portion engages by passing through the retainer receiving portion and the through hole of the holder.

36. The heat generation unit according to claim 35, wherein the protruding end portion passing through the through hole of the holder is plastically deformed larger than a diameter of the through hole, in the retainer portion.

37. The heat generation unit according to claim 28, wherein the heat generator has an interlayer structure formed by a material including a carbon-based substance.

38. The heat generation unit according to claim 28, wherein the container is constructed by any one of a glass tube and a ceramics tube having a heat resistance, and is sealed in the power supply portion, and an inert gas is filled in an inner portion of the container.

39. A heating apparatus comprising the heat generation unit according to claim 1.

40. An image fixing apparatus comprising:
a heating body heating a member to be recorded in which an unfixed toner image is carried; and
a pressurizing body arranged so as to be opposed to the heating body and pressurizing the heating body via the member to be recorded,
wherein the heating body is equipped with the heat generation unit according to claim 1 and comprising:
a band-like heat generator formed as a film sheet by a material including a carbon-based substance, and having a two-dimensional isotropic thermal conductivity;
a power supply portion having a holder including a first holding portion and a second holding portion arranged so as to be opposed while having a contact surface holding both ends of the heat generator and formed by a conductive material, and a lead wire electrically connected to the holder, the lead wire having a retainer portion formed in the power supply portion, and supplying power to the both opposed ends in the heat generator; and
a container internally including the heat generator and a part of the power supply portion,
wherein the end portion of the heat generator is disposed between the first holding portion and the second holding portion, and a retainer receiving portion formed in the end of the heat generator is engaged with the retainer portion together with the first holding portion and the second holding portion
having a heat generator as a heat source.

41. The image fixing apparatus according to claim 40, wherein the heat generator has an interlayer structure formed by a material including a carbon-based substance.

42. The image fixing apparatus according to claim 41, wherein the heat generator has such a positive characteristic that a value of a rate of resistance change obtained by dividing a value of a resistance at a balanced lighting state brought by energization by a value of a resistance at a non-energized state is in a range between 1.2 and 3.5, and a temperature of the heat generator and the resistance value are proportional.

43. The image fixing apparatus according to claim 42, wherein the heat generator is constructed by a thin membrane body having a thickness equal to or less than 300 μm.

44. The image fixing apparatus according to claim 42, wherein the heat generator is constructed by a light membrane body having a density equal to or less than 1.0 g/cm³.

45. The image fixing apparatus according to claim 42, wherein the heat generator is formed by a material having a coefficient of thermal conductivity equal to or more than 200 W/m·K.

46. The image fixing apparatus according to claim 42, wherein the heating body has a container storing a part of a power supply portion supplying power in both opposed ends of the heat generator together with the heat generator, and the container is structured such as to be filled with an inert gas in an inner portion and be sealed in the power supply portion.

47. The image fixing apparatus according to claim 42, wherein the heating body is provided with a reflective portion for defining a heating region by the heat generator.

48. The image fixing apparatus according to claim 42, wherein the heating body is provided with a plurality of the heat generators, and respective center axes in a longitudinal direction in the plurality of heat generators are arranged on a straight line so as to be orthogonal to a supplying direction of the member to be recorded.

49. The image fixing apparatus according to claim 42, wherein the membrane body is formed by a member absorbing an infrared ray in a surface opposed to the heat generator, in the heating body.

50. The image fixing apparatus according to claim 42, wherein a heating range of the heat generator includes a nip portion as a pressing position of the member to be recorded by the heating body and the pressurizing body, and an upstream side position in the conveying direction of the member to be recorded by the nip portion.

51. An image forming apparatus comprising the image fixing apparatus according to claim 40.
